(19) United States
(12) Patent Application Publication
(10) Pub. No.: US 2016/0289449 A1
(43) Pub. Date: Oct. 6, 2016

(54) PROTEIN-BASED BIOPLASTICS AND METHODS OF USE

(71) Applicant: University of Georgia Research Foundation, Inc., Athens, GA (US)

(72) Inventors: Suraj Sharma, Watkinsville, GA (US); Alexander Jones, Athens, GA (US); Abhyuday Mandal, Athens, GA (US)

(21) Appl. No.: 15/085,377

(22) Filed: Mar. 30, 2016

Related U.S. Application Data
(60) Provisional application No. 62/140,228, filed on Mar. 30, 2015.

(51) Int. Cl. C08L 89/00; B65D 65/38; A01N 25/10; C08L 23/06; A01N 25/34; C08K 5/053

(52) U.S. Cl. CPC C08L 89/00; A01N 25/34; C08K 5/053; A01N 25/10; C08L 23/06; B65D 65/38; C08K 2201/018; C08L 2201/06; C08L 2203/02; C08L 2207/066

(57) ABSTRACT

Provided herein are bioplastics that can include a protein and a plasticizer, methods of making the bioplastics, and uses thereof. The bioplastics can also include an anti-infective compound and/or a low-density polyethylene. The bioplastics described herein can have antimicrobial, including antibacterial, properties.

### CROSS-REFERENCE TO RELATED APPLICATIONS

This application claims the benefit of and priority to co-pending U.S. Provisional Patent Application No. 62/140,228, filed on Mar. 30, 2015, entitled “PROTEIN-BASED BIOPLASTICS WITH ANTIMICROBIAL PROPERTIES,” the contents of which is incorporated by reference herein in its entirety.

### BACKGROUND

Plastics are used in a plethora of applications and settings including the food industry and medical industry. As such, there exists a need to develop improved plastics that are suitable for use in at least these industries.

### SUMMARY

Provided herein are bioplastic compositions that can contain an amount of a protein, wherein the protein is selected from the group of soy, albumin, zein, whey, and combinations thereof and an amount of a plasticizer. The plasticizer can be selected from the group of water, glycerol, natural rubber latex, and combinations thereof. The bioplastic compositions can further contain an amount of an anti-infective compound. The anti-infective can be an antibiotic, an amebicide, an anthelmintic, an antifungal, an antimalarial, an antiviral, or any combination thereof. The bioplastic composition can further contain an amount of a low-density polyethylene. The amount of the low-density polyethylene can range from about 5% to about 80% by weight of the bioplastic composition. The amount of the anti-infective compound can range from about 5% by weight to about 15% by weight of the bioplastic composition. The bioplastic compositions can further contain an amount of a low-density polyethylene. The amount of the low-density polyethylene can range from about 5% to about 80% by weight of the bioplastic composition. The amount of the protein can range from about 5% by weight of the bioplastic composition to about 95% by weight of the bioplastic composition. The amount of the plasticizer can range from about 5% by weight of the bioplastic composition to about 95% by weight of the bioplastic composition.

Also provided herein are containers that can have a wall portion, wherein the wall portion can contain a bioplastic composition that comprises an amount of a protein and an amount of a plasticizer, wherein the protein can be selected from the group of: soy, albumin, zein, whey, and combinations thereof. The amount of the plasticizer can range from about 5% to about 95% by weight of the bioplastic composition and wherein the plasticizer can be selected from the group of water, glycerol, and natural rubber latex. The bioplastic of the container can further contain an amount of an anti-infective compound, wherein the amount of the anti-infective compound can range from about 5% to about 15% by weight of the bioplastic composition. The bioplastic of the container can further contain an amount of low-density polyethylene, wherein the amount of the low-density polyethylene can range from about 5% by weight of the bioplastic composition to about 95% by weight. The amount of protein in the bioplastic can range from about 5% to about 95% by weight of the bioplastic composition.

Also provided herein are methods of making a bioplastic that can include the steps of mixing a protein and a plasticizer to form a bioplastic mixture, wherein the protein can be included at an amount ranging from about 5% to about 95% by weight of the bioplastic and wherein the protein can be selected from the group of soy, albumin, zein, whey, and combinations thereof, wherein the plasticizer can be included at an amount ranging from about 5% to about 95% of the bioplastic composition and wherein the plasticizer can be selected from the group of water, glycerol, or natural rubber latex; and heating the bioplastic mixture to form the bioplastic. The method can further include mixing an anti-infective compound with the protein and the plasticizer, wherein the anti-infective compound can be included at amount ranging from about 5% to about 15% by weight of the bioplastic mixture. The method can further include mixing a low-density polyethylene with the protein and the plasticizer, wherein the low-density polyethylene can be included at an amount ranging from about 5% to about 95% by weight of the bioplastic mixture.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1B show graphs demonstrating thermographs of pure protein powders: (1A) TGA and (1B) DSC.

FIGS. 2A-2C show graphs demonstrating thermogravimetric analysis of protein plastic blends: (2A) albumin, (2B) soy, and (2C) whey.

FIGS. 3A-3C show graphs demonstrating differential scanning calorimetry of protein plastic blends: (3A) albumin, (3B) soy, and (3C) whey.

FIGS. 4A-4C show graphs demonstrating dynamic mechanical analysis of optimal protein plastic blends: (4A) albumin, (4B) soy, and (4C) whey.

FIGS. 5A-5D show graphs demonstrating tensile properties of protein plastic blends: (5A) stress-strain curves, (5B) elongation, (5C) modulus, and (5D) ultimate tensile strength. Gly, glycerol; NRL, natural rubber latex.

FIG. 6 shows a graph demonstrating antibacterial analysis of albumin protein plastic blends. PE, ultra-high-molecular-weight polyethylene; AW, 75/25 albumin-water; AG, 75/25 albumin-glycerol; ANR, 75/25 albumin-NRL.

FIG. 7 shows a graph demonstrating antibacterial analysis of soy protein plastic blends. PE, ultra-high-molecular-weight polyethylene; SW, 75/25 soy-water; SG, 75/25 soy-glycerol; SNR, 75/25 soy-NRL.

FIG. 8 shows a graph demonstrating antibacterial analysis of whey protein plastic blends. PE, ultra-high-molecular-weight polyethylene; VWV, 75/25 whey-water; WG, 75/25 whey-glycerol; WNR, 75/25 whey-NRL.

FIG. 9 shows a graph demonstrating a residual versus fitted plot of the original Gram (−) data.

FIG. 10 shows a graph demonstrating a normal Q-Q plot analysis of the original Gram (−) bacteria data.

FIG. 11 shows a graph demonstrating a Box-Cox plot of the original data for the Gram (−) bacteria.

FIG. 12 shows a graph demonstrating a residual versus fitted plot of Gram (−) when data was log-transformed.

FIG. 13 shows a graph demonstrating the normal Q-Q plot of Gram (−) data when log-transformed.

FIG. 14 shows a graph demonstrating a Cook's distance plot of Gram (−) data when log-transformed.

FIG. 15 shows a table demonstrating a Two-Way Analysis of Variance Corresponding to Model (1) for Gram (−) Bacteria.

FIG. 16 shows a table demonstrating Estimated Values of Regression Coefficients for Some Parameters of Model (1) for Gram (−) Bacteria.

FIG. 17 shows a table demonstrating a Two-Way Analysis of Variance Corresponding to Model (1) for Gram (+) Bacteria.

FIG. 18 shows a table demonstrating Estimated Values of Regression Coefficients for Some Parameters of Model (1) for Gram (+) Bacteria.

FIGS. 19A-19B show graphs demonstrating calibration curves of Ampicillin (19A) and Ciprofloxacin (19B).

FIGS. 20A-20B show graphs demonstrating surface antimicrobial properties of (20A) albumin plastic blends and (20B) zein plastic blends.

FIG. 21 shows a representative image demonstrating the effect of drug elution for Gram+ bacteria exposed to the following bioplastic samples: (Section A) Zein-5LDPE-Ciprofloxacin, (Section B) Albumin-5LDPE-Sodium benzoate, (Section C) Zein-Gly-Ampicillin, (Section D) Albumin-Gly-Sodium Benzoate), (Section E) LDPE Ciprofloxacin

FIG. 22 shows a representative image demonstrating the effect of drug elution for Gram+ bacteria exposed to the following bioplastic samples: (Section A) Zein-5LDPE, (Section B) Albumin-5LDPE-Sodium Nitrite, (Section C) Zein-Gly, (Section D) Albumin-Gly-Sodium Nitrite, (Section E) LDPE-Ampicillin.

FIG. 23 shows a representative image demonstrating the effect of drug elution for Gram− bacteria exposed to the following bioplastic samples: (Section A) Zein-5LDPE-Ampicillin, (Section B) LDPE-Ciprofloxacin, (Section C) Alb-Gly-Ampicillin, (Section D) Zein-Gly-Sodium Benzoate, (Section E) Alb-5LDPE-Ampicillin.

FIG. 24 shows a representative image demonstrating the effect of drug elution for Gram− bacteria exposed to the following bioplastic samples: (Section A) Zein-5LDPE-Sodium Nitrite, (Section B) Albumin-5LDPE, (Section C) Zein-Gly, (Section D) Albumin-Gly-Sodium Nitrite, (Section E) LDPE-Sodium Benzoate.

FIGS. 25A-25B show graphs demonstrating the zone of inhibition for plastics with 15% of Sodium Benzoate: (25A) Gram+ and (25B) Gram− bacteria.

FIGS. 26A-26B show graphs demonstrating the zone of inhibition for plastics with 15% of Ampicillin: (26A) Gram+ and (26B) Gram− bacteria.

FIGS. 27A-27B show graphs demonstrating the zone of inhibition for plastics with 15% of Ciprofloxacin: (27A) Gram+ and (27B) Gram− bacteria.

FIGS. 28A-28D show graphs demonstrating the zone of inhibition for plastics with Ciprofloxacin: 10% −(28A) Gram+ and (28B) Gram− bacteria; and 5% (28C) Gram+ and (28D) Gram− bacteria.

FIGS. 29A-29D show graphs demonstrating the zone of inhibition for plastics with Ampicillin: 10%−(29A) Gram+ and (29B) Gram− bacteria; and 5% (29C) Gram+ and (29D) Gram− bacteria.

FIGS. 30A-30B show graphs demonstrating the zone of inhibition for plastics with (30A) 10% and (30B) 5% of Sodium Benzoate for Gram− bacteria.

FIGS. 31A-31B show graphs demonstrating boxplots of the inhibition zones to compare drug/food preservatives.

FIG. 32 shows an ANOVA table for examining effect of LDPE addition to albumin plastics for Gram+ bacteria.

FIG. 33 shows an ANOVA table for examining effect of LDPE addition to albumin plastics for Gram− bacteria.

FIG. 34 shows an ANOVA table for examining the effect of LDPE addition to zein plastics for Gram+ bacteria.

FIG. 35 shows an ANOVA table for examining the effect of LDPE addition to zein plastics for Gram− bacteria.

FIGS. 36A-36B show graphs demonstrating drug elution rate from albumin-glycerol bioplastics: (36A) Ampicillin and (36B) Ciprofloxacin.

FIG. 37 shows an ANOVA table for examining protein, drug, and protein:drug interactions on drug elution properties of various bioplastics for Gram+ bacteria.

FIG. 38 shows an ANOVA table for examining protein, drug, and protein:drug interactions on drug elution properties of various bioplastics for Gram− bacteria.

FIG. 39 shows a table demonstrating full regression values for examining protein, drug, and protein:drug interactions on drug elution properties of various bioplastics for Gram+ bacteria.

FIG. 40 shows a table demonstrating full regression values for examining protein, drug, and protein:drug interactions on drug elution properties of various bioplastics for Gram− bacteria.

FIG. 41 shows an image showing an environmental chamber utilized for a biodegradation analysis.

FIG. 42 shows an image demonstrating a representative sample plot of soil used in a biodegradation analysis.

FIGS. 43A-43C show scanning electron microscopy images of albumin-LDPE thermoplastics including 75/25 albumin-glycerol at increasing magnifications (20×, 100×, and 500×) from 43A-43C.

FIGS. 44A-44C show scanning electron microscopy images of albumin-LDPE thermoplastics including 95/5 albumin-LDPE at increasing magnifications (20×, 100×, and 500×) from 44A-44C.

FIGS. 45A-45C show scanning electron microscopy images of albumin-LDPE thermoplastics including 90/10 albumin-LDPE at increasing magnifications (20×, 100×, and 500×) from 45A-45C.

FIGS. 46A-46C show scanning electron microscopy images of albumin-LDPE thermoplastics including 80/20 albumin-LDPE at increasing magnifications (20×, 100×, and 500×) from 46A-46C.

FIGS. 47A-47C show scanning electron microscopy images of albumin-LDPE thermoplastics including 65/35 albumin-LDPE at increasing magnifications (20×, 100×, and 500×) from 47A-47C.

FIGS. 48A-48C show scanning electron microscopy images of albumin-LDPE thermoplastics including 50/50 albumin-LDPE at increasing magnifications (20×, 100×, and 500×) from 48A-48C.

FIGS. 49A-49C show scanning electron microscopy images of albumin-LDPE thermoplastics including 35/65 albumin-LDPE at increasing magnifications (20×, 100×, and 500×) from 49A-49C.

FIGS. 50A-50C show scanning electron microscopy images of albumin-LDPE thermoplastics including 20/80 albumin-LDPE at increasing magnifications (20×, 100×, and 500×) from 50A-50C.

FIGS. 51A-51C show scanning electron microscopy images of zein-LDPE thermoplastics including 75/25 zein-glycerol at increasing magnifications (20×, 100×, and 500×) from 51A-15C.

FIGS. 52A-52C show scanning electron microscopy images of zein-LDPE thermoplastics including 95/5 albumin-LDPE at increasing magnifications (20×, 100×, and 500×) from 52A-52C.

FIGS. 53A-53C show scanning electron microscopy images of zein-LDPE thermoplastics including 90/10 zein-LDPE at increasing magnifications (20×, 100×, and 500×) from 53A-53C.

FIGS. 54A-54C show scanning electron microscopy images of zein-LDPE thermoplastics including 80/20 zein-LDPE at increasing magnifications (20×, 100×, and 500×) from 54A-54C.

FIGS. 55A-55C show scanning electron microscopy images of zein-LDPE thermoplastics including 65/35 zein-LDPE at increasing magnifications (20×, 100×, and 500×) from 55A-55C.

FIGS. 56A-56C show scanning electron microscopy images of zein-LDPE thermoplastics including 50/50 zein-LDPE at increasing magnifications (20×, 100×, and 500×) from 56A-56C.

FIGS. 57A-57C show scanning electron microscopy images of zein-LDPE thermoplastics including 35/65 zein-LDPE at increasing magnifications (20×, 100×, and 500×) from 57A-57C.

FIGS. 58A-58C show scanning electron microscopy images of zein-LDPE thermoplastics including 20/80 zein-LDPE at increasing magnifications (20×, 100×, and 500×) from 58A-58C.

FIGS. 59A-59C show scanning electron microscopy images of LDPE plastics at 20× (59A), 100× (59B), and 500× (59C).

FIGS. 60A-60B show graphs demonstrating water absorption (60A) and soluble mass change (60B) of albumin plastic blends and zein plastic blends.

FIGS. 61A-61M shows images demonstrating plastics that have been subjected to biodegradation susceptibility analysis: (61A) Albumin-Glycerol (30 Days); (61B) and (61C) Albumin-Glycerol-5 LDPE (30 and 60 Days); (61D) and (61E) Albumin-Glycerol-50 LDPE (30 and 60 days); (61F) and (61G) Zein-Glycerol (30 and 60 days); (61H) and (61I) Zein-Glycerol-5 LDPE (30 and 60 Days); (61J) and (61K) Zein-Glycerol-50 LDPE (30 and 60 days); (61L) and (61M) LDPE (30 and 60 days).

FIG. 62 shows a graph demonstrating the mass change of samples analyzed for susceptibility of biodegradation through microbial attack.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of molecular biology, microbiology, nanotechnology, organic chemistry, biochemistry, botany and the like, which are within the skill of the art. Such techniques are explained fully in the literature.

### DEFINITIONS

As used herein, “about,” “approximately,” and the like, when used in connection with a numerical variable, generally refers to the value of the variable and to all values of the variable that are within the experimental error (e.g., within the 95% confidence interval for the mean) or within +/−10% of the indicated value, whichever is greater.

As used herein, “anti-infective” refers to compounds or molecules that can either kill an infectious agent or inhibit it from spreading. Anti-infectives include, but are not limited to, antibiotics, antibacterials, antifungals, antivirals, and antiprotozoans.

As used herein, “control” is an alternative subject or sample used in an experiment for comparison purpose and included to minimize or distinguish the effect of variables other than an independent variable.

As used herein, “positive control” refers to a “control” that is designed to produce the desired result, provided that all reagents are functioning properly and that the experiment is properly conducted.

As used herein, “negative control” refers to a “control” that is designed to produce no effect or result, provided that all reagents are functioning properly and that the experiment is properly conducted. Other terms that are interchangeable with “negative control” include “sham,” “placebo,” and “mock.”

As used herein, the term “effective ratio” refers to the ratio of at least two ingredients in the bioplastic (e.g. protein, plasticizer, LDPE, anti-infective compound, preservative, and any combination thereof) that is effective for reducing, eliminating, and or delaying a microbe population or growth thereof on the bioplastic.

As used herein, the term “effective amount” refers to the amount of one or more ingredients of the bioplastic that is effective for reducing, eliminating, and or delaying a microbe population or growth thereof on the bioplastic.

Discussion

The cost of contamination through conventional plastics in numerous applications has been examined for the material being wasted, as well as the physical harm done to individuals. For instance, in 2002, 4.5 out of every 100 hospital admissions resulted in a hospital-acquired infection in the United States, with over 99,000 deaths being the end result. There is also a fiscal cost to hospital-acquired infections, as a sustained illness will require additional hospital visit. In a study by Gould, an outbreak of methicillin-resistant Staphylococcus aureus (MRSA) would result in a doubling of the cost of a hospital visit, with an overall cost between 1.5 and 4.5 billion dollars in the United States on a yearly basis. Based on the findings by Neely and Maley, both MRSA and vancomycin-resistant enterococci (VRE) were able to survive at least 1 day when inoculated onto the surface of materials commonly used in healthcare applications, with some microorganisms being able to survive for more than 90 days. It is because of these issues that materials that could provide antimicrobial properties are being examined for bio-medical applications, as that would help in containing or reducing the hospital-acquired infections.

Another area in which contamination is a notable risk is the food packaging, where the material is in contact with food that will be consumed. There are five different aspects in which traditional plastics will contaminate food: the gradual degradation of the plastic that contains the food, volatiles such as benzene that are incorporated in the molecular structure of the plastic; contamination caused by the environment; contamination due to the processing agents used to produce the plastics; and other contaminants that are specific to the type of monomer utilized.

Food contamination by traditional plastics is caused by the use of a polymer that was not incorporated in the food product itself, leading to the migration into the food. There are three interrelated stages that occur when food becomes contaminated by the plastic packaging: diffusion that occurs within the polymer, solvation of the migrant at the food-polymer interface, and the dispersion of the migrant into the bulk of the food product.

Insofar as traditional plastics have microbial contamination issue, there exists a need for improved plastics that have improved anti-microbial properties. With that said, described herein are bioplastics that can include a protein and a plasticizer. The bioplastics can have antimicrobial properties. The bioplastics can be used to make containers and other apparatuses and devices suitable for use in the food and medical industries. Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

Bioplastics

Described herein are bioplastics that can include a protein and a plasticizer. The bioplastics can have anti-microbial properties, meaning that they can reduce, delay, and/or eliminate the amount and/or growth of a microbe (e.g. bacteria, fungus, yeast, or other single celled organism) on the surface of the bioplastic. In embodiments, the bioplastics can reduce, delay, and/or eliminate the growth of Gram+ and/or Gram− bacteria. In some embodiments, the bacteria can be E. coli and/or B. subtillus. The bioplastics can be biodegradable. The protein can be soy, albumin, zein, whey, or any combination thereof. The plasticizer can be water, glycerol, natural rubber latex, or any permissible combination thereof. The protein can be included in the bioplastic at an amount ranging from about 5% to about 95% by weight of the bioplastic composition. The plasticizer can be included in the bioplastic at an amount ranging from about 5% to about 95% by weight of the bioplastic composition. In some embodiments, the protein can be included at about 5%, 10%, 15%, 20%, 25%, 35%, or 50% by weight and the plasticizer can be present at about 95%, 90%, 85%, 80%, 75%, 65% or 50% by weight, respectively. In some embodiments, the protein can be albumin and the plasticizer can be glycerol. In other embodiments, the protein can be zein and the plasticizer can be glycerol. The ratio of the protein to the plasticizer can be an effective ratio. The amount of the protein can be an effective amount. The amount of the plasticizer can be an effective amount.

The bioplastic can further include an optional anti-infective compound. Suitable anti-infective compounds include, but are not limited to, Suitable anti-infectives include, but are not limited to, amebicides (e.g. nitazoxanide, paromomycin, metronidazole, tinidazole, chloroquine, miltefosine, amphotericin b, and iodoquinol), aminoglycosides (e.g. paromomycin, tobramycin, gentamicin, amikacin, kanamycin, and neomycin), anthelmintics (e.g. pyrantel, mebendazole, ivermectin, praziquantel, abendazole, thiabendazole, oxamniquine), antifungals (e.g. azole, itraconazole, fluconazole, posaconazole, ketoconazole, clotrimazole, miconazole, and voriconazole), echinocandins (e.g. caspofungin, anidulafungin, and micafungin), griseofulvin, terbinafine, flucytosine, and polyenes (e.g. nystatin, and amphotericin b), antimalarial agents (e.g. pyrimethamine/sulfadoxine, artemether/lumefantrine, atovaquone/proquanil, quinine, hydroxychloroquine, mefloquine, chloroquine, doxycycline, pyrimethamine, and halofantrine), antituberculosis agents (e.g. aminosalicylates (e.g. aminosalicylic acid), isoniazid/rifampin, isoniazid/pyrazinamide/rifampin, bedaquiline, isoniazid, ethambutol, rifampin, rifabutin, rifapentine, capreomycin, and cycloserine), antivirals (e.g. amantadine, rimantadine, abacavir/lamivudine, emtricitabine/tenofovir, cobicistat/elvitegravi r/emtricitabine/tenofovi r, efavirenz/emtricitabine/tenofovir, avacavir/lamivudine/zidovudine, lamivudine/zidovudine, emtricitabine/tenofovir, emtricitabine/opinavir/ritonavir/tenofovir, interferon alfa-2v/ribavirin, peginterferon alfa-2b, maraviroc, raltegravir, dolutegravir, enfuvirtide, foscarnet, fomivirsen, oseltamivir, zanamivir, nevirapine, efavirenz, etravirine, rilpivirine, delaviridine, nevirapine, entecavir, lamivudine, adefovir, sofosbuvir, didanosine, tenofovir, avacivr, zidovudine, stavudine, emtricitabine, xalcitabine, telbivudine, simeprevir, boceprevir, telaprevir, lopinavir/ritonavir, fosamprenvir, dranuavir, ritonavir, tipranavir, atazanavir, nelfinavir, amprenavir, indinavir, sawuinavir, ribavirin, valcyclovir, acyclovir, famciclovir, ganciclovir, and valganciclovir), carbapenems (e.g. doripenem, meropenem, ertapenem, and cilastatin/imipenem), cephalosporins (e.g. cefadroxil, cephradine, cefazolin, cephalexin, cefepime, ceflaroline, loracarbef, cefotetan, cefuroxime, cefprozil, loracarbef, cefoxitin, cefaclor, ceftibuten, ceftriaxone, cefotaxime, cefpodoxime, cefdinir, cefixime, cefditoren, cefizoxime, and ceftazidime), glycopeptide antibiotics (e.g. vancomycin, dalbavancin, oritavancin, and telvancin), glycylcyclines (e.g. tigecycline), leprostatics (e.g. clofazimine and thalidomide), lincomycin and derivatives thereof (e.g. clindamycin and lincomycin), macrolides and derivatives thereof (e.g. telithromycin, fidaxomicin, erthromycin, azithromycin, clarithromycin, dirithromycin, and troleandomycin), linezolid, sulfamethoxazole/trimethoprim, rifaximin, chloramphenicol, fosfomycin, metronidazole, aztreonam, bacitracin, penicillins (amoxicillin, ampicillin, bacampicillin, carbenicillin, piperacillin, ticarcillin, amoxicillin/clavulanate, ampicillin/sulbactam, piperacillin/tazobactam, clavulanate/ticarcillin, penicillin, procaine penicillin, oxaxillin, dicloxacillin, and nafcillin), quinolones (e.g. lomefloxacin, norfloxacin, ofloxacin, qatifloxacin, moxifloxacin, ciprofloxacin, levofloxacin, gemifloxacin, moxifloxacin, cinoxacin, nalidixic acid, enoxacin, grepafloxacin, gatifloxacin, trovafloxacin, and sparfloxacin), sulfonamides (e.g. sulfamethoxazole/trimethoprim, sulfasalazine, and sulfasoxazole), tetracyclines (e.g. doxycycline, demeclocycline, minocycline, doxycycline/salicyclic acid, doxycycline/omega-3 polyunsaturated fatty acids, and tetracycline), and urinary anti-infectives (e.g. nitrofurantoin, methenamine, fosfomycin, cinoxacin, nalidixic acid, trimethoprim, and methylene blue).

The anti-infective compound can be included in the compound at an amount ranging from about 5% to about 15% by weight of the bioplastic. In some embodiments the anti-infective compound can be ampicillin. In further embodiments, the anti-infective compound can be ciprofloxacin. The amount of the anti-infective compound can be an effective amount. The ratio of the anti-infective compound to one or more of the other components of the bioplastic (e.g. the protein and/or plasticizer, and/or any other component) can be an effective ratio.

The bioplastic can further include an optional preservative. Suitable preservatives include, but are not limited to sodium benzoate and sodium nitrite. The preservative can be included at an amount ranging from about 5% to about 15% by weight of the bioplastic. The amount of the preservative can be an effective amount. The ratio of the preservative compound to one or more of the other components of the bioplastic (e.g. the protein and/or plasticizer, and/or any other component) can be an effective ratio.

The bioplastic can further optionally include a low-density polyethylene. Low-density polyethylene (LDPE), as used herein, can refer to a thermoplastic material that is made from the monomer polyethylene and can have a density ranging from about 0.910 to about 0.940 g/cm³. LDPE can optionally be included in the bioplastic at an amount ranging from about 5% to about 80% by weight of the bioplastic. The amount of the LDPE can be an effective amount. The ratio of LDPE to one or more of the other components of the bioplastic (e.g. the protein and/or plasticizer, and/or any other component) can be an effective ratio.

Methods of Making and Using the Bioplastics

The bioplastics described herein can be made by mixing a protein and a plasticizer to form a bioplastic mixture. The method can further include the step of mixing one or more optional components, including, but not limited to an anti-infective compound, preservatives, and/or LDPE. The protein can be included at an amount ranging from about 5% to about 95% by weight of the bioplastic mixture. The plasticizer can be included at an amount ranging from about 5% to about 95% by weight of the bioplastic mixture. The anti-infective compound can be included at an amount ranging from about 5% to about 15% by weight of the bioplastic mixture. The preservative can be included at an amount ranging from about 5% to about 15% of the bioplastic mixture. The LDPE can be included at an amount ranging from about 5% to about 80% of the bioplastic mixture.

The bioplastic mixture can be heated to form (or mold) the bioplastic mixture into a bioplastic. The exact temperature that the bioplastic mixture can be heated to depends on the protein, plasticizer and any other components present in the bioplastic mixture. In embodiments, the bioplastic mixture can be heated to a temperature ranging from about 120° C. to about 140° C. The step of heating the mixture can be followed by the step of cooling the formed bioplastic. Any or all of the steps can be performed under pressure. In some embodiments the pressure can be at least 40 MPa. The method can further include the step of conditioned. This can take place a temperature of about 20-22° C. Conditioning can further take place at about 65% relative humidity.

The bioplastics can be molded into any desired shape or form. Further, the bioplastics can be formed into any desired thickness. In some embodiments, the bioplastics can be formed into containers having any desired shape or size. The containers can include a wall portion that is made of any of the bioplastics described herein. The containers can be used to hold and/or store food. The containers can have antimicrobial properties. The bioplastics can also be used to form portions or entire containers, devices, apparatuses and the like that can be used in the medical, research, veterinary, and/or clinical setting. Other uses for the bioplastics described herein will be appreciated by those of skill in the art and are within the scope of this disclosure.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

### Introduction

The cost of contamination through conventional plastics in numerous applications has been examined for the material being wasted, as well as the physical harm done to individuals.

For instance, in 2002, 4.5 out of every 100 hospital admissions resulted in a hospital-acquired infection in the United States, with over 99,000 deaths being the end result. There is also a fiscal cost to hospital-acquired infections, as a sustained illness will require additional hospital visit. In a study by Gould, an outbreak of methicillin-resistant Staphylococcus aureus (MRSA) would result in a doubling of the cost of a hospital visit, with an overall cost between 1.5 and 4.5 billion dollars in the United States on a yearly basis. Based on the findings by Neely and Maley, both MRSA and vancomycin-resistant enterococci (VRE) were able to survive at least 1 day when inoculated onto the surface of materials commonly used in healthcare applications, with some microorganisms being able to survive for more than 90 days. It is because of these issues that materials that could provide antimicrobial properties are being examined for bio-medical applications, as that would help in containing or reducing the hospital-acquired infections.

Another area in which contamination is a notable risk is the food packaging, where the material is in contact with food that will be consumed. According to a review study by Lau and Wang, there are five different aspects in which traditional plastics will contaminate food: the gradual degradation of the plastic that contains the food, volatiles such as benzene that are incorporated in the molecular structure of the plastic; contamination caused by the environment; contamination due to the processing agents used to produce the plastics; and other contaminants that are specific to the type of monomer utilized.

Food contamination by traditional plastics is caused by the use of a polymer that was not incorporated in the food product itself, leading to the migration into the food. There are three interrelated stages that occur when food becomes contaminated by the plastic packaging: diffusion that occurs within the polymer, solvation of the migrant at the food-polymer interface, and the dispersion of the migrant into the bulk of the food product.

To determine alternative materials such as proteins to be used in plastics, thermal and viscoelastic analysis can be conducted to determine their suitability for the given application. In a study by Sharma et al., the protein albumin from egg white denatures at a temperature of 136.5±3° C., ensuring protein's ability of orient and form a bioplastic. This alteration of the protein orientation was due to the breaking of hydrophobic interactions and hydrogen bonds of the protein itself, allowing the bioplastic to form. Moreover, bioplastics undergoing cyclic loading multiple times did not cause failure, a phenomenon typically associated with conventional plastics. 5 Another protein that has been used extensively in the production of bioplastics is soy protein isolate (˜90-95% protein). In a study by Paetau et al., the optimal temperature of soy plastic thermomechanical molding was between about 120 and about 140° C., as higher temperature led to thermal degradation and affected properties during molding. 6

The tensile and viscoelastic properties of the resulting bioplastics were highly dependent on the moisture content of the soy protein and the molding temperature. For instance, soy protein with a lower moisture content possessed greater tensile properties when molded at about 120° C., whereas soy protein with a higher moisture content exhibited higher tensile properties when molded at about 140° C. Whey protein, byproduct of cheese production, would also be a suitable choice for bioplastic production, as it has been used extensively in the area of edible film. For whey proteins, the minimum temperature of molding into a film was about 104° C., with degradation starting above 140° C.

It is because of the contamination issue with traditional plastics in applications where contamination is possible that biopolymers made from proteins are being examined for their potential use in medical applications. In a review conducted by Qiu et al., it was found that biopolymers could promote antimicrobial activity in three ways: the creation of an antiadhesive surface, the disruption of cell-cell communication through antibacterial agents, or lysing the cell membrane to kill the bacteria. Albumin protein (not in bioplastic film) has been studied for its antimicrobial in clinical research and treatment. Albumin can exhibit antimicrobial properties through its enzyme, lysozyme that utilizes a lysis reaction to kill cells. Another protein that could be utilized in applications that require anti-microbial properties is whey. Whey has been found to contain immunoglobulins and glycomacropeptides, constituents that bind toxins and help prevent bacterial infection. It is also possible to promote the antimicrobial activity of protein-based bioplastics through the use of additives, which possess antimicrobial activities. For instance, when additives such as grape seed extract and nisin were added to the soy protein during plastic production, the plastic inhibited microbial growth.

In another study, wheat gluten and egg white bioplastics loaded with bioactive agents, formic acid, and oregano essential oil demonstrated antimicrobial activity. Also of note are the areas of antifouling and antiadhesive properties of plastic surfaces to prevent microbial adhesion to the surface. This Example demonstrates the thermal and viscoelastic properties of albumin, soy, and whey bioplastics through the use of water, glycerol, and natural rubber latex (NRL) plasticizers, and to evaluate the antibacterial properties of bioplastics.

Materials and Methods

Albumin (purity˜99%) and ultra-high-molecular-weight polyethylene powder (particle sizes of 53-75 mm) were obtained from Sigma-Aldrich Corporation (St. Louis, Mo.); the soy protein edible (protein content˜72%) was acquired from MP (Solon, Ohio); and the biPro whey protein (purity˜99%) was obtained from Davisco Foods Int'l (Le Sueur, Minn.). Plasticizers were purchased through various sources: deionized water was supplied by a water filtering system in the lab; glycerol was obtained from Sigma-Aldrich with a purity˜99%. A 70% solid, 30% water mixture of NRL (pH 5 10.8) was acquired from the Chemionics Corporation (Tallmadge, Ohio). In a study by Tarachiwin et al. on natural rubber from Hevea brasiliensis, the small rubber particles showed mean diameter <250 nm whereas larger rubber particles showed mean diameter >250 nm. 15 For antibacterial analysis, various materials were purchased for testing: bacto tryptic soy agar and broth from Bectin, Dickinson and Company (Sparks, Md.); Dey-Engley neutralizing broth from Remel (Thermo Scientific, Suwanee, Ga.); agar-agar solution that consisted of granulated agar-agar from EMD (Gibbstown, N.J.); sodium chloride from Baker (Phillipsburg, N.J.); and phosphate-buffered saline solution from HiMedia (Mumbai, India). The bacterial species of Bacillus subtilis [Gram (+)] and Escherichia coli [Gram (−)] were provided through Dr. Jennifer Walker and the Department of Microbiology at the University of Georgia.

Thermal Analysis of Raw Material:

Thermal gravimetric analysis (TGA) was performed using a Mettler Toledo TGA/SDTA851e, with material examined from 25 to 500° C. under a N2 atmosphere with a heating rate of about 10° C./min. Differential scanning calorimetry (DSC) was performed using a Mettler Toledo DSC821e, with materials examined from 250 to 250° C. under a N2 atmosphere with a heating rate of 10° C./min. For all sample testing, the weight of each sample was set between about 2.0 and 4.0 mg to ensure consistent results and determine optimum plastic molding conditions.

Preparation of Compression Molded Samples:

The molding of bioplastic blends was performed on a 24-ton bench-top press (Carver Model 3850, Wabash, Ind.) with electrically heated and water-cooled platens. Stainless steel molds were used to form dog bone-shaped bioplastics for antibacterial plastic analysis. To form the plastics, protein and plasticizers were mixed manually in predetermined w/w ratios to be placed into the molds (as indicated throughout the article). The mixture of protein and plasticizers was prepared in small batches of varying masses based on density of materials for dog bone plastics (≦6 g for albumin and soy, ≦5 g for whey, and ≦4 g for polyethylene), while the DMA flexbars were made of 2 g of plasticized proteins. Subsequently, the mixture was filled into the flexbar and dog bone cavity of the stainless steel molds, with plungers placed on top of the molds to prevent the mixture from leaking. After covering with a plunger, the molds were then compressed for a 5-min molding time at about 12° C., followed by a 10-min cooling period for the protein plastics. For the polyethylene plastics, a 20-min compression molding time at about 150° C. followed by a 10-min cooling period was used. Both the bioplastic and polyethylene samples were prepared under a pressure of at least 40 MPa, as a certain minimum amount of pressure must be applied in order to be able to mold a plastic.

After the samples were cooled for 10 min under pressure, the pressure was released and the samples were removed. The plastic samples were conditioned at about 21.1° C. and about 65% relative humidity for about 24 h before characterization through dynamic mechanical analysis (DMA) and antibacterial testing.

Dynamic Mechanical Analysis:

The mechanical properties of the conditioned plastics were measured by using the Instron testing system (Model 3343) interfaced with the Blue Hill software. The test was performed according to the standard test method for tensile properties of plastics (ASTM D 638-10, Type I) with a 5 mm/min crosshead speed, a static load cell of 1000 N, and a gauge length of 4 cm. Samples were run in quintuplicate (n=5) for each blend type in order to ensure precise measurement.

Antibacterial Testing of Plastics:

The antibacterial properties of the conditioned plastics were measured using the ASTM E 2180-01 standard test method, in which the aqueous-based bacterial inoculum remains in close, uniform contact in a “pseudo-biofilm” state with the bioplastic. For each blend type, the Gram (+) specie B. subtilis and the Gram (−) specie E. coli were used as challenge bacterial cells to determine the efficacy of bacterial growth on the plastic surfaces. After equilibration of standardized culture banks of 1-5×10⁸ cells/mL through the use of dynamic light scattering analysis, 1 mL of the culture was applied to 100 mL of agar slurry for inoculation. Once inoculated, the slurry was then applied to a 9-cm² area of the bioplastics that had been swabbed with phosphate-buffered saline to promote adhesion by reducing sur-face tension. After the appropriate time of application of agar (within 1 h for 0-h samples and at least 24 h for 24-h samples after incubation), the agar was removed through the use of neutralizing broth, followed by sonicating and vortexing each for 1 min. The neutralizing broth containing the agar was diluted five times in a 10²¹ dilution set, and then the dilutions were applied to tryptic soy agar plates, which were incubated for 24 h at about 37° C. After incubation, the culture plates were counted for microbial growth and averaged to determine colony-forming units (CFU)/mL. Samples were run in triplicate (n=3) for each protein-plasticizer combination (as well as the polyethylene plastic control sample) in order to ensure accurate measurement.

Statistical Analysis:

Statistical analyses were performed by fitting a regression model. For each plastic-plasticizer blend tested, bacterial growth for 0- and 24-h samples was analyzed by fitting two-way ANOVA using the statistical software of SAS and R. Box-Cox transformations were used to determine the appropriate transformations needed to satisfy the normality assumptions of the experimental errors. As the dataset has several very big and small values, Cook's distances were examined to ensure that no individual observation is an outlier that influences the conclusions.

Results

Material Analysis:

Thermal Properties of Proteins and Bioplastics.

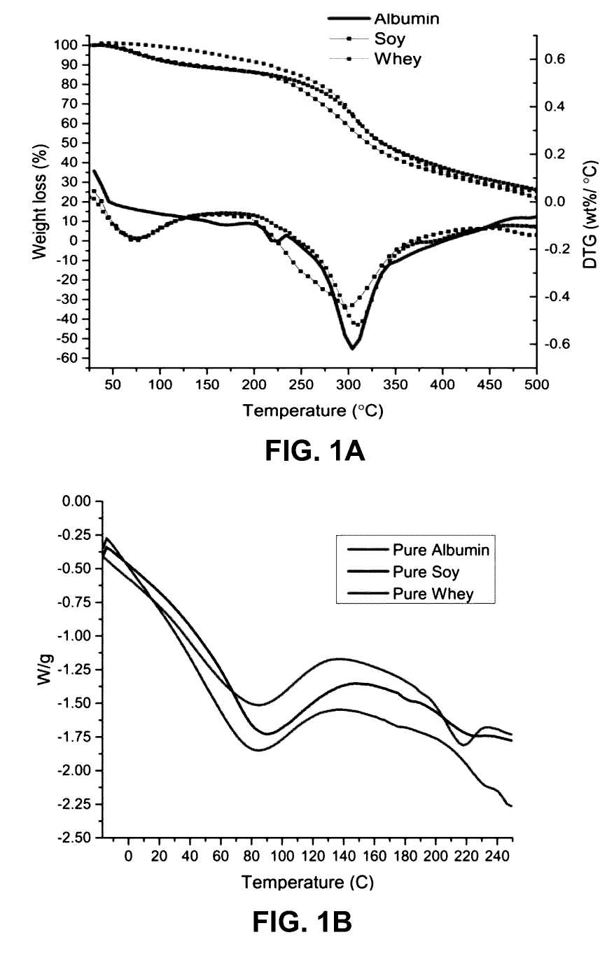

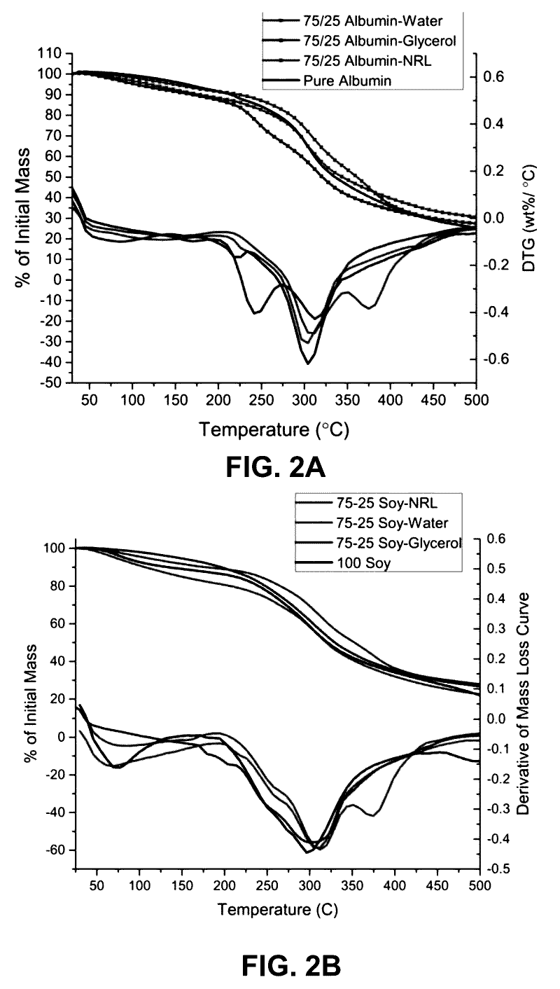

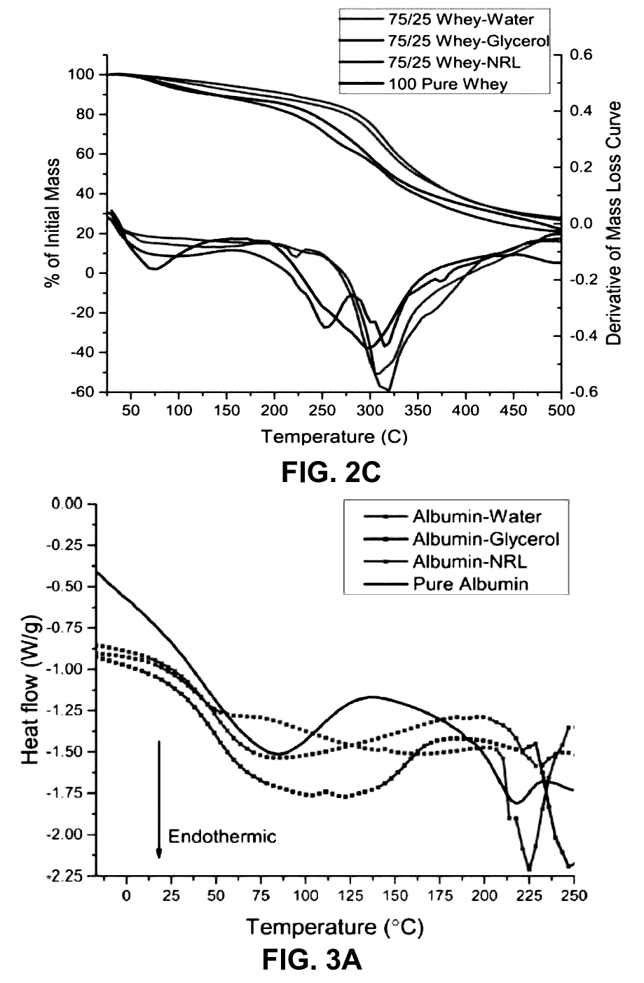

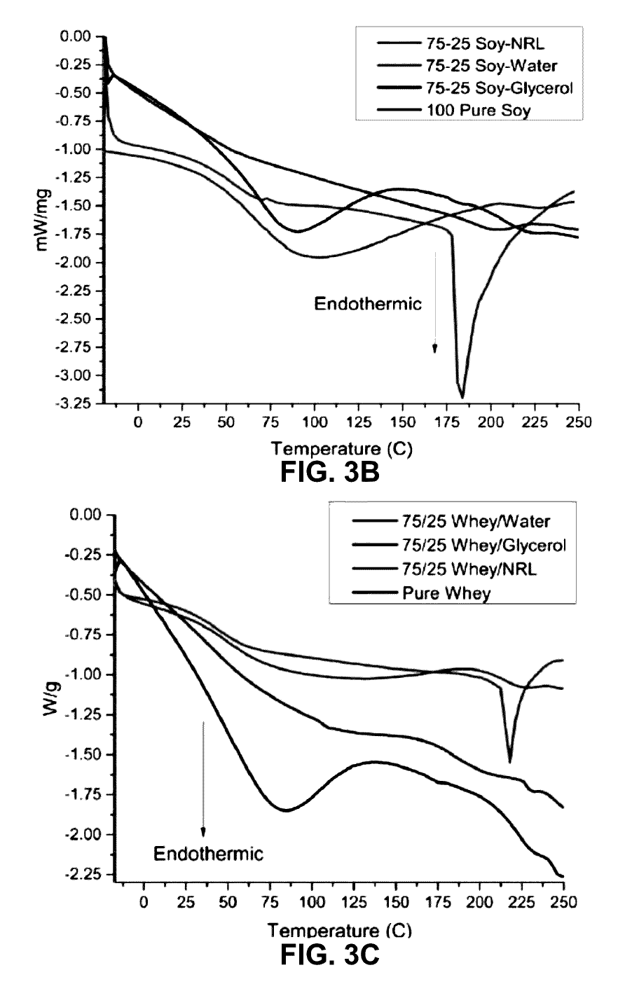

An initial degradation peak (FIGS. 1A-1B) was observed for both soy and whey between 70 and 80° C., indicative of bound moisture loss, while for albumin it was between 220 and 230° C. Much larger degradation peaks started at different temperatures for each of the proteins: 245-250° C. for the albumin powder, 190-200° C. for soy protein, and 200-210° C. for the whey protein. At the end of the TGA run, 75% of the protein powders degraded, as the proteins were similar in the overall level of degradation due to the burning of the proteins (FIGS. 1A-1B). When compared to an optimum blends (FIGS. 2A-2C) of bioplastics, degradation peaks depended upon the plasticizer used, as plastics blended with water possessed similar thermal degradation peaks in comparison to plastics that did not contain any plasticizer. However, bimodal degradation peaks were witnessed in plastics prepared with glycerol and NRL, as the glycerol-based albumin and whey bioplastics possessed degradation peaks between 240 and 250° C. (below protein degradation peaks between 300 and 315° C.) while the NRL in albumin and soy bioplastics would degrade at temperatures higher than the proteins (˜375° C.). Without being bound by theory, this can occur due to the glycerol and natural latex that are bound within the plastics to begin degrading at temperatures that differ to glycerol or NRL that is not bound within a plastic. For the DSC data, endothermic dips occurred at varying temperatures: a small peak beginning at about 75° C., with a broad peak at 120-125° C. for album; a narrow peak beginning at 35° C., with a broad peak at 80-85° C. for whey protein. Without being bound by theory, these peaks suggest that the material had fully denatured at lower temperatures for soy and whey (about 80-90° C.) due to higher bound moisture levels, whereas albumin denatured at a higher temperature between 120 and 125° C. An endothermic decomposition or pyrolysis peak occurred at 250° C. for all the proteins, which exhibited the onset of degradation, as amino acids degrade at temperatures in this region. Therefore, the protein-based bioplastics were molded at about 120° C. to minimize thermal degradation while ensuring full denaturation leading to bioplastics. When these results are compared to bioplastics that have been blended with plasticizers (FIGS. 3A-3C), the curves are similar in shape and peak areas unless water was utilized as a plasticizer. In this case, endothermic peaks in albumin and whey bioplastics occurred between 220 and 225° C., while in soy plastics the endothermic peaks occurred between about 180 and 185° C. Without being bound to theory, one potential reason for this lowering of the glass transition and degradation temperatures is the addition of water in the plastic increased polymer-water interactions to the detriment of polymer-polymer interactions 3 As it has been postulated that the effectiveness of plasticizers for bioplastics is highly dependent upon how they affect hydrogen bonding or hydro-phobic interactions, that may be why this property is witnessed only in water-plasticized bioplastics.

Dynamic Mechanical Analysis.

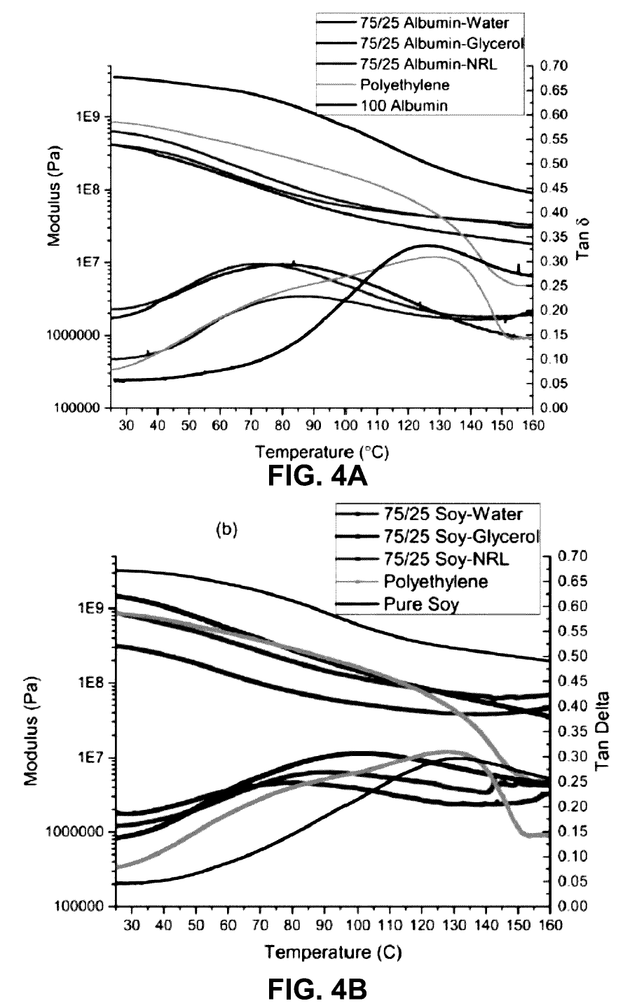

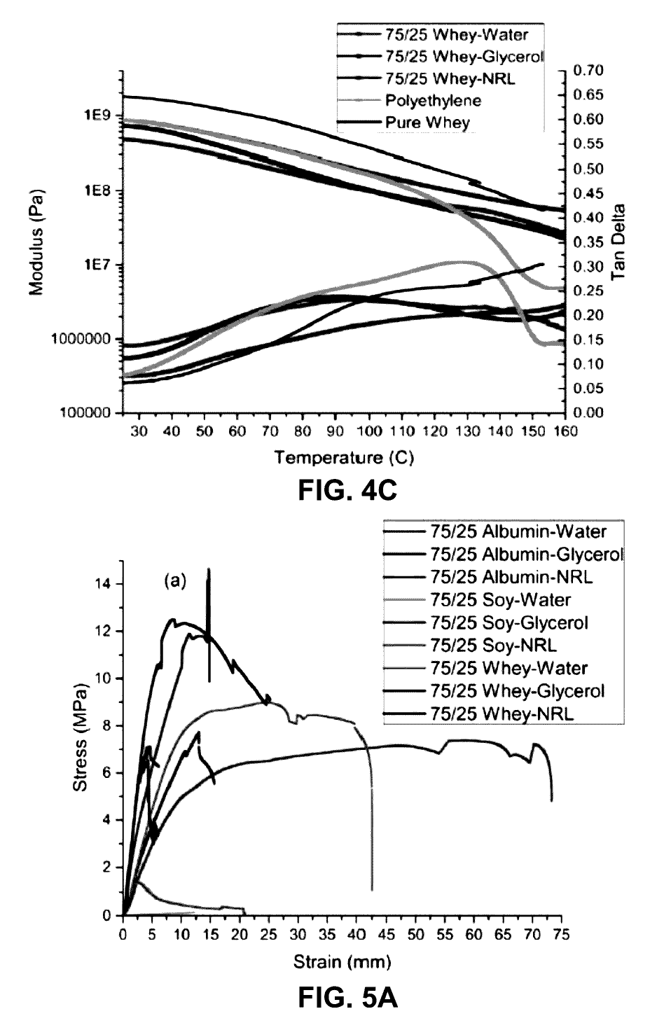

In the albumin and whey plastics, it was observed that the plastics made with the plasticizers of water and glycerol had similar properties, as each had tan d peaks occurring at lower temperatures in comparison with plastics plasticized with NRL (FIGS. 4A and 4C). While the albumin and whey bioplastics plasticized with water and glycerol possessed similar viscoelastic properties, the bioplastics plasticized with natural rubber possessed a lower initial tan δ, with the tan δ peak occurring at higher temperatures, as well as a higher initial modulus. These results point to higher levels of protein-glycerol or protein-water interactions and less protein-protein interactions in the thermoplastic hydrophilic polymers (albumin or whey), thereby shifting the tan δ peaks (glass transition) to lower temperature with higher initial tan δ values as well as dropping the elastic modulus (E′) than plastics that do not possess any plasticizer. Moreover, the bioplastics produced in the absence of plasticizers were stiff as evident from the higher elastic or storage modulus throughout the temperature of DMA testing. Without being bound by theory, this phenomenon can explain the breaking of protein-protein interactions and favoring the protein-plasticizer interaction, thereby producing flexibility in the resulting bioplastics. However, NRL seems less effective plasticizer for albumin or whey proteins as the resulting bioplastics were observed to behave more or less like stiff material with higher elastic modulus and lower tan δ values.

The soy-glycerol and soy-water plasticized plastics displayed the highest modulus and lowest initial tan δ, as well as the highest tan d peak temperatures when compared to their counterpart proteins, albumin, and whey. Soy proteins can possess strong intra-molecular and intermolecular interactions, such as hydrogen bonding, dipole-dipole, charge-charge, and hydrophobic inter-actions, that promote stiffness or brittleness of soy plastics. Without being bound by theory, glycerol and water may be unable to break up intermolecular bonds to the same level as in whey- and albumin-based plastics. However, the opposite was found for the soy-NRL plastics, as they possessed the highest initial tan δ values and lowest initial modulus, differing from the albumin-NRL and whey-NRL plastics (FIG. 4B). The possible explanation is that NRL-plasticized soy plastics had less dispersed rubber particles (or probably bigger phases of rubber particles), leading to a ductile material compared to NRL-plasticized whey and albumin plastics. These phenomena were also corroborated in the tensile performance as presented elsewhere herein.

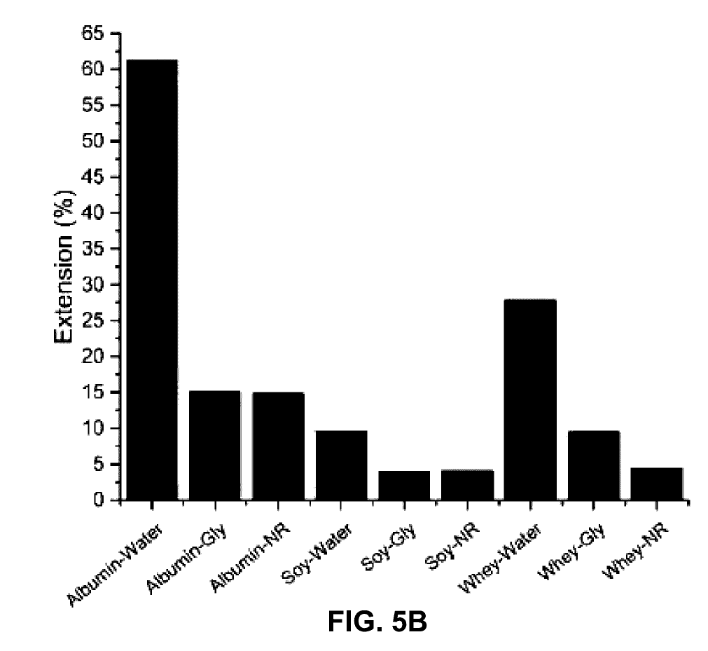

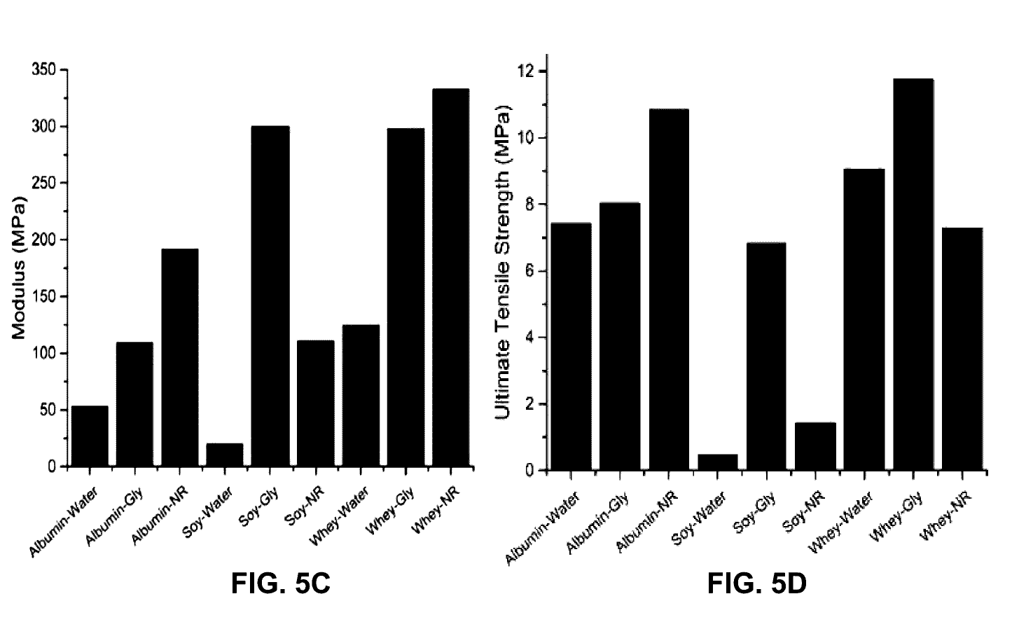

Tensile Testing. In terms of the amount of strain placed on the plastics, the albumin/water bioplastics were able to withstand the most strain, extending over 70% on average before a ductile break (FIGS. 5A-5D). When the plastics are compared based on protein content, the NRL-plasticized albumin bioplastics failed at the stress levels over 14 MPa, while the water- or glycerol-plasticized bioplastics failed near 8 MPa. Without being bound by theory, these findings could have been due to increased hydrogen bonding that occurs during plasticization when plasticized with water or glycerol, while the NRL (because of more protein-plasticizer interaction) could serve as an additional load-bearing constituent in the plastic.

For soy plastics, the plastic that was able to withstand the greatest amount of load (soy/glycerol) was 7.5 MPa with brittle fracture. Without being bound by theory, these observed characteristics of the soy plastics may be due to the soy protein lacking the ability to form a structure that possesses long-range orientation when plasticizers are utilized. As for the whey plastics, the whey plastics that have been plasticized with water performed similarly to the albumin/water plastics. The whey/water plastics were able to withstand about 27.5% of strain before breaking, but able to withstand over 8 MPa of stress. For whey protein, it was found that when glycerol is used as a plasticizer, the plastic was able to withstand 12.5 MPa of stress and about 9.8% of extension before failure. Without being bound by theory, when plasticized with NRL, the whey plastics possessed minimal tensile properties, as the protein may not be able to form a suitable structure during plasticization.

When the plastics are compared to each other based on elongation and modulus, we determined that the albumin plastics pre-pared with water possessed higher levels of elongation compared to any other plastic, but whey blended with NRL plastics possessed the highest modulus values [FIG. 5B). In comparison, the soy plastics possessed few tensile properties that would be comparable to the other proteins, as the modulus in the soy/glycerol plastics was the only tensile property that was similarly seen in other protein plastics.

Antibacterial Testing:

Influence of Bioplastic Formulations.

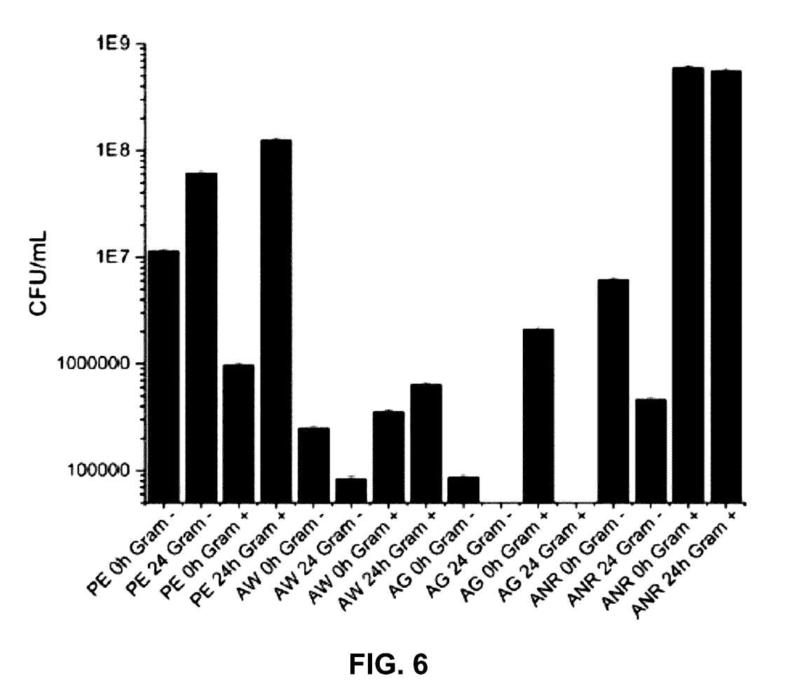

The above mentioned bioplastics produced using optimal level of various plasticizers were then evaluated for their antibacterial performance in comparison to a polyethylene (PE) control sample. For the polyethylene control samples a moderate level of growth (about 15.37%) by the Gram (−) and Gram (+) species was observed with a resulting CFU/mL value of 6.13 3 107 after 24 h (FIGS. 6-8). However, the result was statistically irrelevant at the 95% level, as neither the Gram (−) nor the Gram (+) contacted plastic samples possessed an a value <0.05. The promotion/inhibition of bacterial growth was marginal likely due to polyethylene not possessing any inherent properties to modify bacterial growth settings.

In the albumin bioplastics, we found that the plastics made with plasticizers, water, and NRL showed similar properties, as each was able to reduce the amount of bacterial growth by both Gram (−) and Gram (+) bacteria (FIG. 6). However, only the albumin plasticized by water was statistically significant in limiting Gram (−) bacterial growth at the 95% confidence level (a 5 0.013), as the albumin-water bioplastic decreased the CFU/mL level to 8.36×10⁴ after 24 h of contact. The albumin-glycerol bioplastics in contrast possessed a strong inhibitive effect in antibacterial growth, as no growth occurred after about 24 h [Gram (−) α=0.002, Gram (+) α=0.004]. This may be attributed to bioactive property of albumin due to lysozyme enzyme plus the gradual leaching of glycerol from the plastic, as this creates an aqueous environment, preventing microbial adhesion and growth on the bioplastic. However, the glycerol leaching from the plastic may only be bacteriostatic in nature, as concentrations of at least 28% of glycerol would be required for bacteriocidial properties.

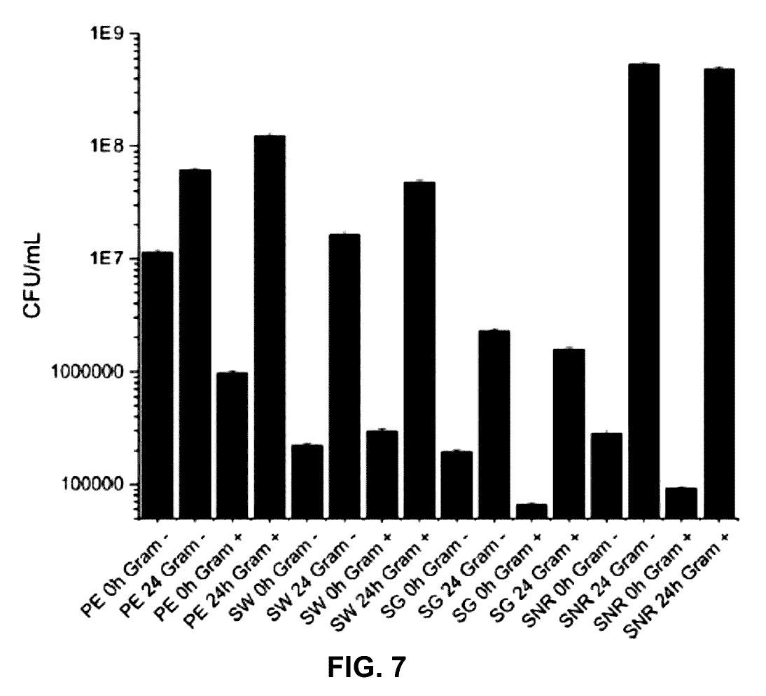

In the soy bioplastics, it was observed that none of the plastics were able to reduce the amount of bacterial growth by both Gram (−) and Gram (+) bacteria, as bacteria increased in growth after 24 h on the soy bioplastics (FIG. 7). The soy plasticized by water was even statistically significant, as it promoted Gram (+) bacterial growth at the 99% confidence level (α=0.008), increasing the CFU/mL to 4.76×10⁷. Of note is the soy bio-plastics plasticized with glycerol, as overall lower rates of bacterial growth occurred in comparison to the soy plastics plasticized by water and NRL.

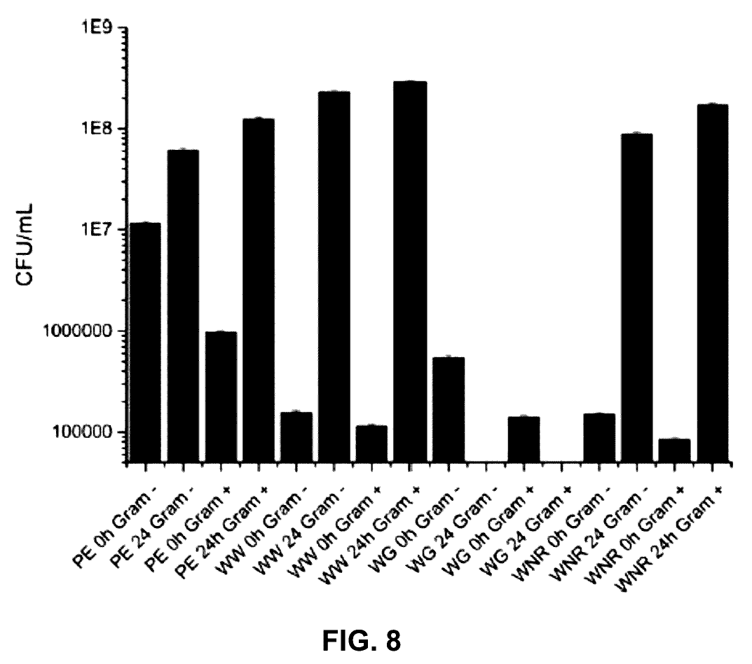

In the whey bioplastics, results were similar in relation to the soy bioplastics, as the plastics made with plasticizers, water, and natural rubber were unable to reduce the amount of bacterial growth by both Gram (−) and Gram (+) bacteria (FIG. 8). Statistically the results were even more drastic, as the whey plastics promoted Gram (−) and Gram (+) bacterial growth at the 99% confidence level (a<0.001 for water plasticized whey plastics, α<0.002 for natural rubber-plasticized whey plastics). However, the whey bioplastics were similar to the albumin bioplastics when plasticized with glycerol, as they were observed to possess a strong inhibitive effect in antibacterial growth, as no growth occurred after 24 h [Gram (−) α=0.002, Gram (+) α=0.019]. Without being bound by theory, this antibacterial activity can be attributed to certain peptides that are contained in the structure of whey protein, as the three peptides of secretory leukocyte protease inhibitor, trappin-2, and elafin have been found to possess antimicrobial activity. Like in the albumin-glycerol bioplastic, this also may be due to the gradual leaching of glycerol from the plastic in the creation of an aqueous environment.

Statistical Analysis of Antibacterial Property of Bioplastics.

For the statistical analysis, response was the proportional change in count after 24 h as determined by Equation 1:

$$y = \frac{Count at 24 h - Count at 0 h}{Count at 0 h} = \frac{Count at 24 h}{Count at 0 h} - 1 \qquad Equation 1$$

Mathematically, it was the same as considering

$$y = \frac{Count at 24 h}{Count a t 0 h} .$$

A linear regression model was fit, separately for Gram (−) and Gram (+) bacteria, for the two-way layout given by

yᵢⱼₖ=η+αᵢ+βⱼ+ωᵢⱼ+εᵢⱼₖ (Equation 2)

for i=1 (albumin), 2 (soy), 3 (whey); j=1 (water), 2 (glycerol), 3 (NRL) and k=1, 2, 3 were the three samples taken. Here, yᵢⱼₖ was the response corresponding to the kth sample with the ith level of protein and the jth level of plasticizer. Note that in the model presented here, the 1+3+3+9=16 parameters (η, α₁, α₂, α₃, β₁, etc.). Here, αᵢ and βⱼ were the main effects of protein and plasticizer, respectively, and ωᵢⱼ was the protein-plasticizer two-factor interaction effect. The term “main effect of protein”, as used herein, can refer to the effect of the individual protein (albumin, soy, or whey) irrespective of the effect of plasticizer. Similar interpretation is given for “main effect of plasticizer,” which, as used herein, can refer to the effect of the individual plasticizer (water, glycerol, or NRL) irrespective of the effect of the protein. Moreover, ωᵢⱼ term denotes the individual protein-plasticizer effects. For example, ω₁₁ represents the albumin-water interaction, and ω₁₂ represents albumin-glycerol interaction. However, this model is over paramatized, so not all parameter values can be estimated uniquely. In order to overcome this problem, standard baseline constraints have been used (Wu, C. F. J.; Hamada, M. S. Experiments: Planning, Analysis, and Optimization, 2nd ed.; Wiley: Hoboken, N.J., 2009). In particular, α₁=0 and β₁=0 were taken so that albumin and water can be considered as baselines for comparison. The errors ξᵢⱼₖ were assumed to be normal (Gaussian), identically and independently distributed with zero mean and some constant variance σ².

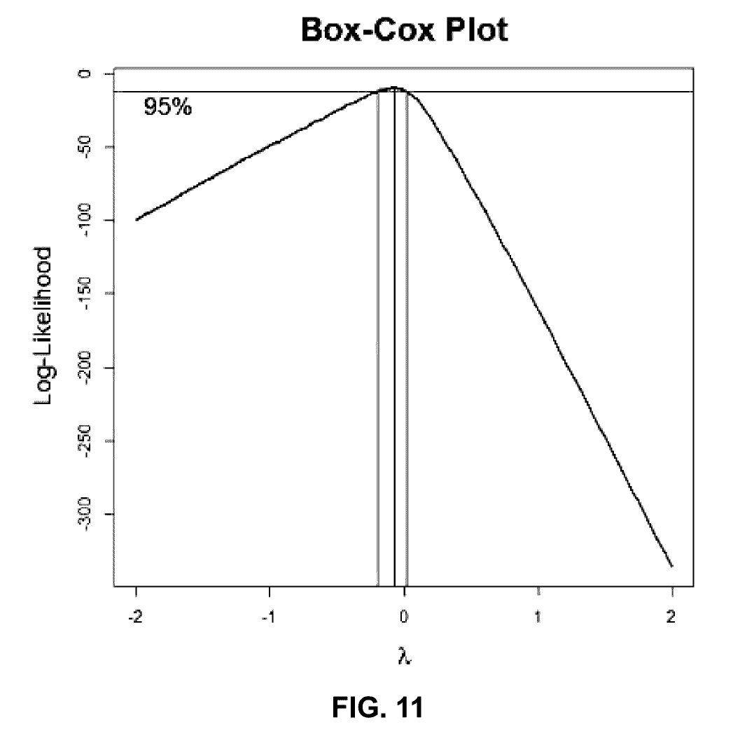

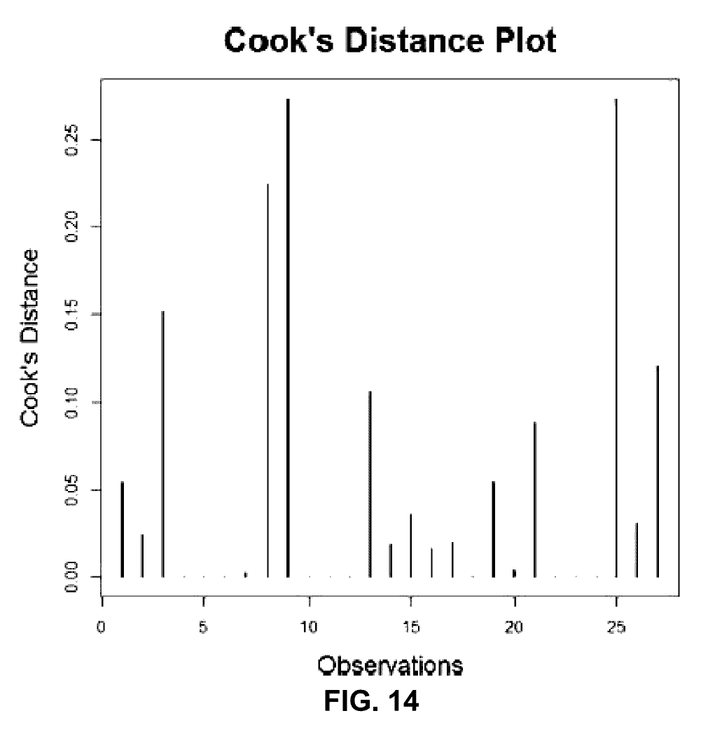

For both Gram (+) and Gram (−) datasets, after the model was fit, the residual versus fitted plot showed a clear “fanning out” pattern and the normal probability plot indicated a departure from a normality of errors. The Box-Cox transformation was considered and the corresponding plots (see FIG. 11) indicated that the likelihood is maximized around λ=0 suggesting the log transformation. Here the response was considered as y+10⁻⁴, that small positive term was added to make all the responses positive. After taking the log transformation, the improvements of the residual versus fitted plot and the normal probability plot were very apparent. Also the Cook's distances for the log-transformed data indicated that there were no influential points (see FIG. 14), and the assumptions of linear regression could be considered to be satisfactorily met.

Gram-Negative Bacteria.

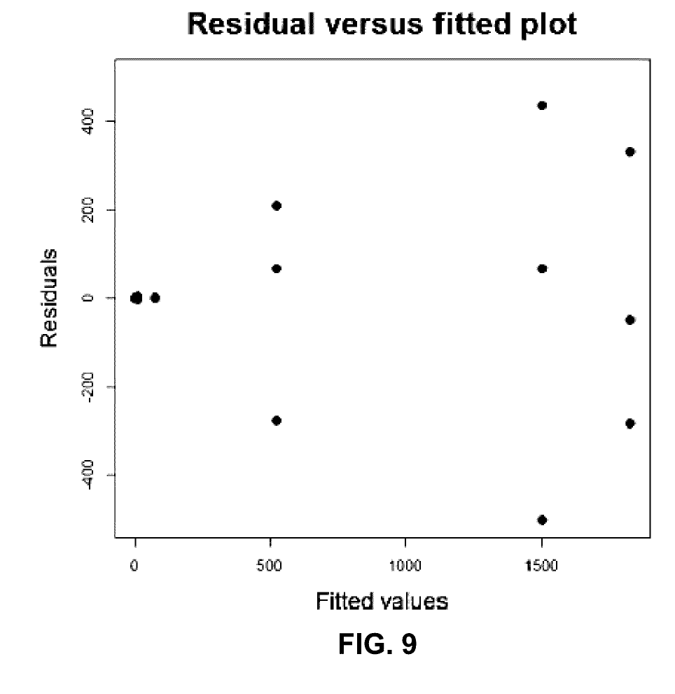

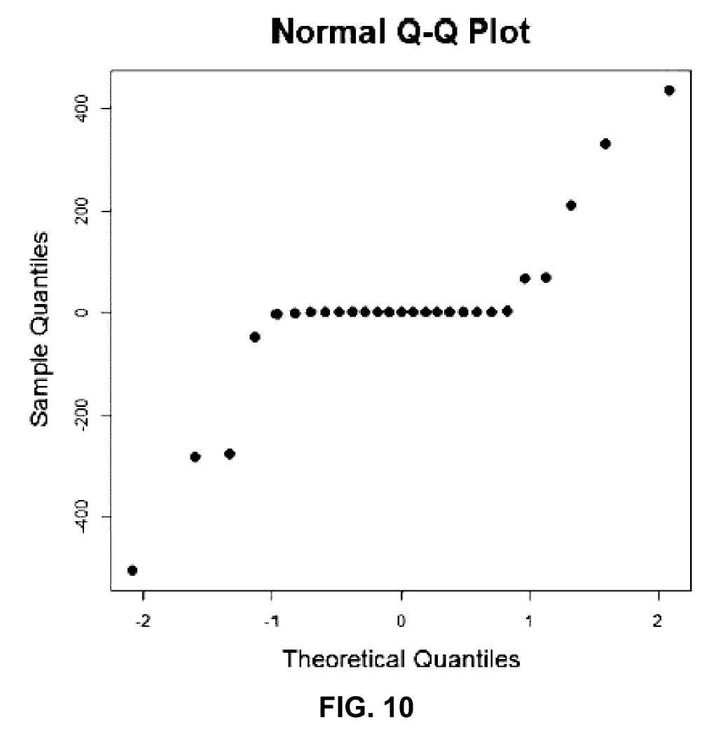

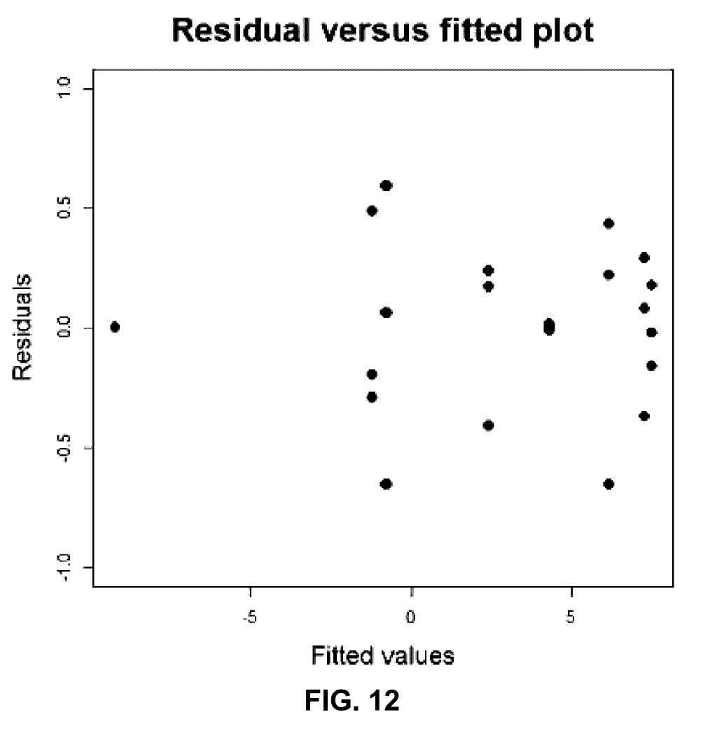

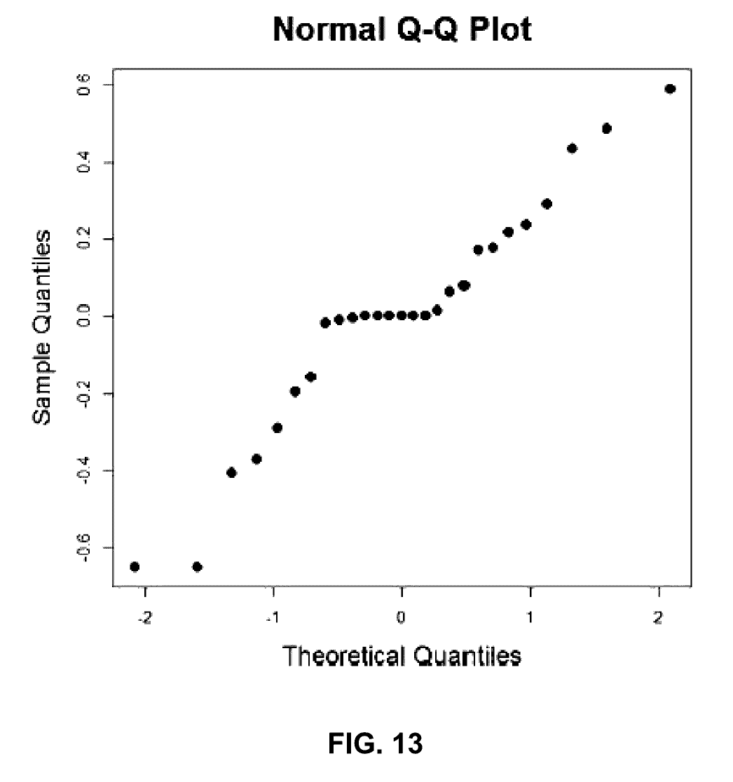

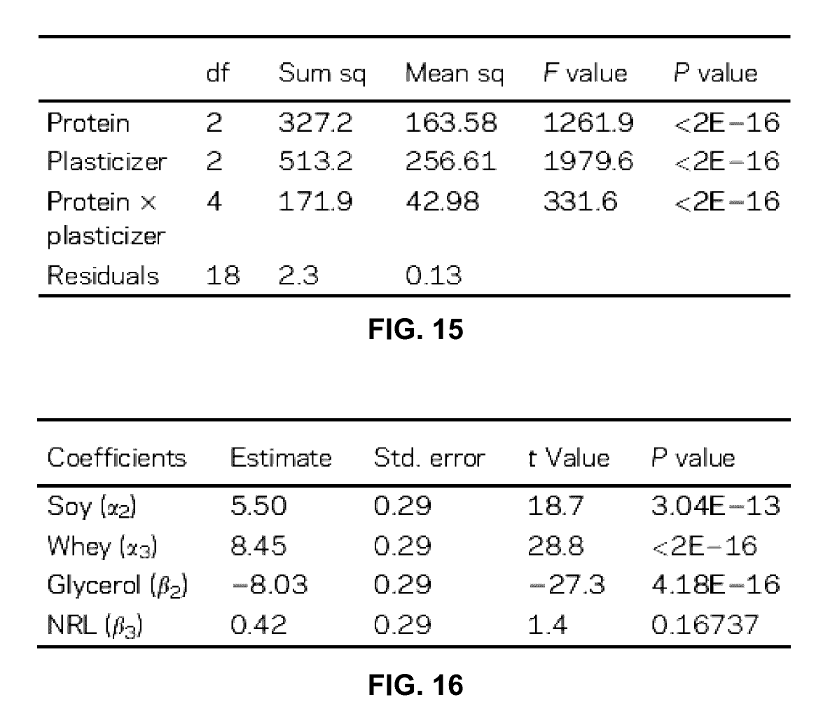

A residual versus fitted plot of original Gram (−) bacteria data is shown in FIG. 9. A normal Q-Q plot analysis of the original Gram (−) bacteria data is shown in FIG. 10. A residual versus fitted plot of Gram (−) bacteria when data was log-transformed is shown in FIG. 12. A normal Q-Q plot of Gram (−) bacteria data when log-transformed is shown in FIG. 13. The ANOVA table (given in FIG. 15) illustrated that all the main effects of protein, plasticizer, and protein-plasticizer two-factor interactions were strongly significant. The multiple R² for this model was about 99.77%, indicating a good fit. In the regression fit, it is customary to consider baseline constraints which assumes the coefficients corresponding to Water and Albumin to be 0 (in other words, α₁=0 and β₁=0). With respect to that, the coefficients of others (along with their P-values) are given in FIG. 16. First, it is noted that the P-values of all the regression coefficients mentioned in FIG. 16 (except rubber) were very small and statistically significant. The estimate of the coefficients for soy (β₂) and whey (β₃) were 5.5 and 8.5, respectively, indicating albumin bioplastics showed fewer numbers of colonies as the coefficient of albumin (α₁) is set to 0, and that is smaller than both 5.5 and 8.5. Similarly, the estimate of coefficient of glycerol (β₂) is negative, which confirms that it prevents the growth of colonies significantly.

Gram-Positive Bacteria.

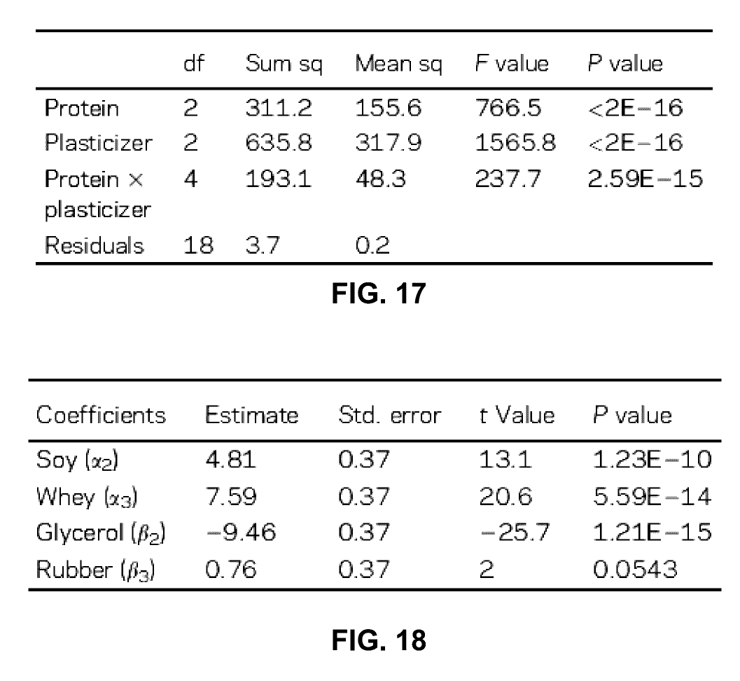

The ANOVA table (FIG. 17) illustrated that all the main effects of protein and plasticizer, as well as the protein-plasticizer two-factor interactions were strongly significant. The multiple R² for this model was 99.68%, indicating a good fit. The other results for Gram (+) bacteria were similar to those of Gram (−) bacteria (see also FIG. 18).

Conclusions

When comparing the thermal properties of the protein compositions, it was observed that the proteins had similar degradation rates, with soy and whey occurring at temperatures between 50 and 60° C. lower than albumin. In terms of the viscoelastic properties, the albumin and whey exhibited similar properties based on the plasticizer used, while soy plastics exhibited a greater range of properties based on the plasticizer. As for antibacterial properties, it was observed that plasticizing either albumin or whey with glycerol produced the bioplastic with the strongest antibacterial properties. In terms of the statistical analysis, we found that the key determinant of antibacterial properties of a given bioplastic is the protein and plasticizer.

### Example 2

### Introduction

In medical and food packaging applications, there are many drawbacks to the continued use of conventional plastic materials, such as polyethylene (PE), polypropylene (PP), and polyethylene terephthalate (PET). These petroleum-based plastics lack inherent property of preventing the growth of bacteria when contaminated, causing potential harm to individuals. For instance, numerous strains of bacteria such as Acinetobacter baumannii and methicillin-resistant Staphylococcus aureus have been found to be viable on the surface of plastics for over a month's time¹. In the hospital, this can lead to the contamination of other surfaces, leading to potential cross-contamination². In the application of food packaging, foods may potentially spoil more rapidly when packaged with traditional plastics in comparison to food products packaged in a more sterile environment. For example, in one study, the cultures of Lactobacillius species and Brocothrix thermosphacta, bacteria were found to be associated with the spoilage of refrigerated beef and pork, that had been previously sterilized and placed in a vacuum-sealed plastic package after 30 days of refrigeration at 4° C. Another issue with the usage of conventional plastic materials in both medical applications and food packaging is the gradual leeching of chemicals from the plastic into the material contained within the plastic. In health care settings materials such as Bisphenol A and phthalates are able to leech into the body through transfusion or dialysis⁴, while in food packaging it has been found that milk in bottles made from low density polyethylene (LDPE) is contaminated with naphthalene (utilized as a dispersant during plastic production) that gradually leeches from the plastic itself⁵.

Multiple approaches have been studied to address the issue of bacterial contamination and growth in medical and food packaging plastics. One approach is the incorporation of additives in the conventional plastics that will lend antibacterial properties to the resulting plastic. For instance, in medical plastics, compounds such as sodium ampicillin⁶ and ciprofloxacin⁷ can be incorporated into the polymer substrate of utilized raw materials. However, for food packaging, it is possible to incorporate common food preservatives, such as sodium benzoate and sodium nitrite,⁸ into the plastic that will gradually leech into the food being contained. Surface treatments can also be utilized in the production of antimicrobial plastics, since research has shown that coated plastics with antibacterial compounds such as nisin⁹ or a combination of lysozyme and silver nanoparticles¹⁰ that could result in a plastic that possesses antibacterial properties. Another approach includes the modification of the plastic surface that will come into contact with the bacteria. In medical applications, the plastic surface can be lubricated to prevent the adhesion of bacteria when in contact¹¹, as well as nanotexturing of films with tetrahyrdofuran to generate a more hydrophobic surface when the film is treated with ethanol or methano¹² to prevent bacterial adhesion. Hydrophobic surfaces can also be imparted onto food packaging films through the use of shrink-inducing to make a super-hydrophobic substrate, preventing bacteria from adhering to the surface¹³.

To address the lack of antimicrobial properties in current conventional plastics, the use of alternative raw materials such as proteins in the production of plastics has been examined in this study. In particular of note are the proteins of albumin from the hen egg white and the zein protein from corn. With the use of plasticizers, it may be possible to utilize both of these proteins in the production of plastics that could be utilized in the areas of food packaging and medical applications¹⁴. One possible advantage of these alternative materials is their antimicrobial potential. For instance, albumin-based bioplastics, plasticized with glycerol, did not promote the growth of bacteria (E. coli and B. subtilis) on the surface of the plastic¹⁵. As for zein plastic films that have been designed for food packaging, when zein is blended with antibacterial compounds such as lysozyme and a chelating agent disodium EDTA, there is a decrease in bacterial growth as well as antioxidant activity¹⁶. When albumin and zein proteins are loaded with compounds such as ciprofloxacin hydrochloride, the proteins are able to possess the same elution properties that are present in conventional plastics, making medical application usage a potential¹⁷. Described in this Example are at least albumin-glycerol and zein-glycerol bioplastics and thermoplastic blends that can be antibacterial and can be used in medical and/or food packaging applications.

Materials and Methods.

Materials.

Albumin (purity ≧99%) was obtained from Sigma-Aldrich Corporation (St. Louis, Mo., USA); the zein purified protein was acquired from Acros Organics (New Jersey, USA); and the low density polyethylene (LDPE) powder (M_{w}˜25,000) (500 micron) was obtained from Alfa Aesar (Ward Hill, Mass., USA). The glycerol used as a plasticizer was obtained from Sigma-Aldrich with a purity ≧99%. For antibacterial and drug elution analysis, various materials were purchased for testing: Bacto tryptic soy agar, tryptic soy broth, and Mueller-Hinton agar from Bectin, Dickinson and Company (Sparks, Md., USA); Dey-Engley neutralizing broth from Remel (Thermo Scientific, Suwanee, Ga., USA); agar-agar solution that consisted of granulated Agar-Agar from EMD (Gibbstown, N.J., USA) and sodium chloride from Baker (Phillipsburg, N.J., USA); and phosphate buffered saline solution from HiMedia (Mumbai, India). The materials to be examined for elution study were the following: sodium benzoate and sodium nitrite obtained from Carolina Biological Supply Company (Burlington, N.C., USA); ampicillin (sodium salt) obtained from IBI Scientific (Peosta, Iowa, USA); and ciprofloxacin obtained from TCI (Tokyo, Japan). The bacterial species of Bacillus subtilis (Gram (+)) and Escherichia coli (Gram (−)) were graciously provided Dr. Jennifer Walker at the Department of Microbiology at the University of Georgia.

Preparation of Compression Molded Samples.

The molding of thermoplastic blends was performed on a 24-ton bench-top press (Carver Model 3850, Wabash, Ind., USA) with electrically-heated and water-cooled platens. Stainless steel molds were used to form dog bone-shaped thermoplastic blends for antibacterial analysis of plastic surface. To form the plastics, protein, and plasticizer were mixed manually in predetermined w/w ratios to be placed into the molds described in Table 1. Table 1 shows the Composition of Albumin or Zein Bioplastics/Thermoplastic Blends (Tests Performed—1—Surface Antimicrobial, 2—Drug/Food Preservative Elution, 3—Elution Kinetics). The mixture of protein, polymer, and plasticizer was prepared in small batches of varying masses based on density of materials for dog bone plastics (≦6 g for albumin/albumin-LDPE blends, and ≦4 g for zein, zein-LDPE blends, and LDPE since zein and LDPE is less dense compared to albumin), while the DMA flexbars (prepared with spacers) were made of 2 g of albumin, zein, LDPE, albumin-LDPE, and zein-LDPE plastics.

TABLE 1

| Name of | | Plasticizer | Polymer | |
|---|---|---|---|---|
| thermoplastic | | (Glycerol - | (LDPE - | |
| blend | Protein (%) | %) | %) | Tests |
| LDPE | 0% | 0% | 100% | 1, 2 |
| Alb-Gly | 75% Albumin | 25% | 0% | 1-3 |
| Alb-5LDPE | 71.25% Albumin | 23.75% | 5% | 1, 2 |
| Alb-10LDPE | 67.5% Albumin | 22.5% | 10% | 1 |
| Alb-20LDPE | 60% Albumin | 20% | 20% | 1 |
| Zein-Gly | 80% Zein | 20% | 0% | 1, 2 |
| Zein-5LDPE | 76% Zein | 19% | 5% | 1, 2 |
| Zein-10LDPE | 72% Zein | 18% | 10% | 1 |
| Zein-20LDPE | 64% Zein | 16% | 20% | 1 |

Subsequently, the mixture was filled into the flexbar or dog bone cavity of the stainless steel molds, with plungers placed on top of the molds to prevent the mixture from leaking. After covering with a plunger, the molds were then compressed for a 5-minute molding time at 120° C., followed by a 10-minute cooling period for the protein plastics. Samples were prepared under a pressure of at least 40 MPa, as a certain minimum amount of pressure must be applied in order to be able to mold a plastic¹⁸. After the samples were cooled for 10 minutes under pressure, the pressure was released and the samples were removed. To prepare the films for drug elution analysis, the samples were molded using the same process that was used to make DMA flexbars, except in this process it is necessary to not use spacers in order to make a thinner sample. In preparation of the films, it was necessary to blend the protein and drug/food preservative powders in order to ensure a consistent blend throughout the plastic. After the blending of protein and drug/food preservative, the plasticizer was added. When plastic molding was completed, the plastic samples were conditioned at 21.1° C. and 65% relative humidity for 24 hours before characterization for antibacterial, drug elution, and elution kinetics testing.

Antibacterial Testing of Plastic's Surface.

The antibacterial properties of the conditioned plastics were measured using the ASTM E 2180-01 standard test method, in which the aqueous based bacterial inoculum remains in close, uniform contact in a “pseudo-biofilm” state with the plastic blends. For each blend type, the Gram (+) specie Bacillius subtilis and the Gram (−) specie Escherichia coli were utilized as bacterial cells to determine the efficacy of bacterial growth on the plastic surfaces. After equilibration of standardized culture banks of 1-5×10⁸ cells/mL determined through the use of dynamic light scattering analysis, 1 mL of the culture was applied to 100 mL of agar slurry for inoculation. Once inoculation for one minute the slurry was then immediately applied to a 9 cm² area of the plastic blends that had been swabbed with phosphate-buffered saline to promote adhesion by reducing surface tension. After the appropriate time of application of cultured agar (within one hour for 0-h samples and at least 24 h for 24-h samples after incubation at 37° C.), the agar was removed from the plastic surface through both sonication (1 min) and vortexing (1 min) the plastics in 30 mL of Dey-Engley neutralizing broth. The neutralizing broth containing the agar was diluted five times in a 10⁻¹ dilution set, and then the dilutions were applied to tryptic soy agar plates, which were incubated for 24 h at 37° C. After incubation for 24 hours, the culture plates were counted for microbial growth and averaged to determine colony forming units (CFU)/mL. Samples were run in triplicate (n=3) for each protein-plasticizer combination (as well as the polyethylene plastic control sample) in order to ensure precision.

Drug Elution and Zone of Inhibition Study.

The potential of the plastics to elute antibiotics and food-preservatives to generate zones of bacterial inhibition was determined through the use of the performance standards for antimicrobial disk susceptibility tests; approved standard—eleventh edition (M02-A11) that has been developed by the Clinical and Laboratory Standards Institute in Wayne, Pa.¹⁹. The plastic blends were prepared with four levels of drug or food preservative (0, 5, 10, and 15%) using the sample procedure listed in Section 2.3, with dry drug added to the plastic blend before compression molding. After preparation, the samples were then cut into disk-sized plastics that were applied to the surface of Mueller-Hinton agar dishes that had been already inoculated with either Gram (+) specie Bacillius subtilis or the Gram (−) specie Escherichia coli at a concentration of 1-5×10⁸ cells/mL. After application, the plates were then incubated for five days 30° C., during which the zones of inhibition were measured every 24 hours to determine the change of diameter of the inhibition zone size over time. Samples were run in triplicate (n=3) for each plastic type-additive combination (as well as the LDPE plastic control samples) in order to ensure precision.

Drug Elution Kinetics.

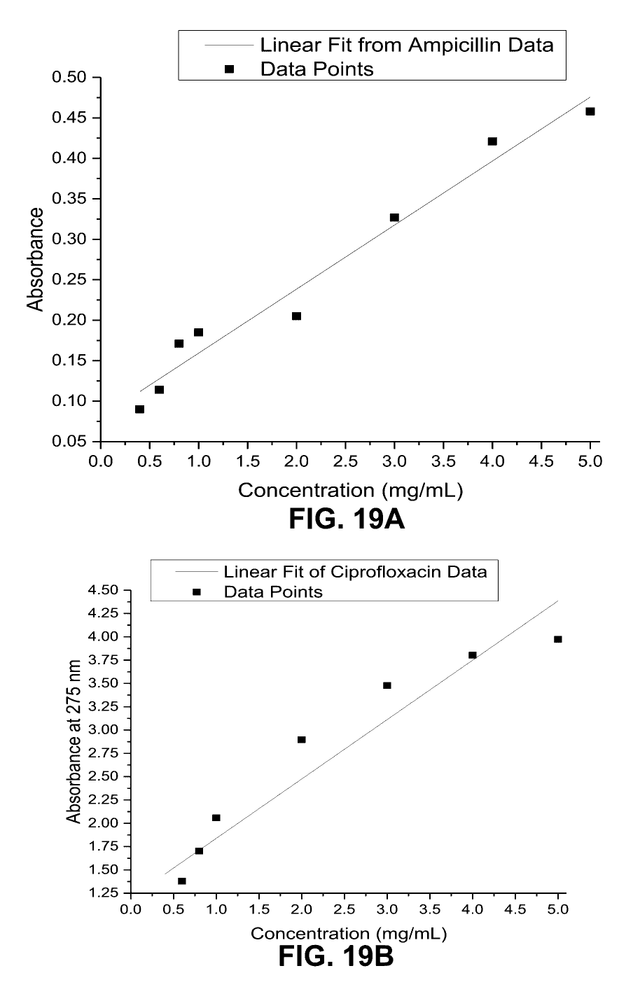

The in vitro release of ampicillin and ciprofloxacin from the albumin bioplastics blended with varying levels of drug or food preservative (0, 5, 10, and 15%) into phosphate-buffered saline (PBS) was determined by the immersion of the thermoplastic blends into 25 ml of PBS in centrifuge tubes. The centrifuge tubes were then placed in a 37° C. shaking bath at shaking speed of 50 rpm for five days. At 24 hour intervals, the absorption of both ampicillin and ciprofloxacin was determined by a UV-VIS spectrophotometer (Shimadzu UV-2401 PC UV-VIS Recording Spectrophotometer) at the absorbance peaks of 230 nm⁶ for ampicillin and 275 nm for ciprofloxacin^{17,20}. In order to determine concentrations of solutions, linear calibration curves were obtained by measuring the absorption of solutions with concentrations of ampicillin and ciprofloxacin, as shown in FIGS. 19A-19B. For ampicillin, the equation derived from the linear fit is y=0.07912x+0.08022; while for ciprofloxacin it is y=0.63685x+1.20162, where x is equivalent to the absorption measured at the specific wavelength, and y is equal to the concentration of drug in solution.

Statistical Analysis of Drug Elution Testing.

To compare the ability of plastics to elute drug and to determine the effect of the addition of LDPE into plastics, statistical analyses were performed by fitting a regression model. For plastic-drug/food preservative blends that contained 15% of the elution material, inhibition zones after five days were analyzed by fitting a two-way ANOVA using the statistical software of SAS and R. Box-Cox transformations were used to determine the appropriate transformations needed to satisfy the normality assumptions of the experimental errors.

Results

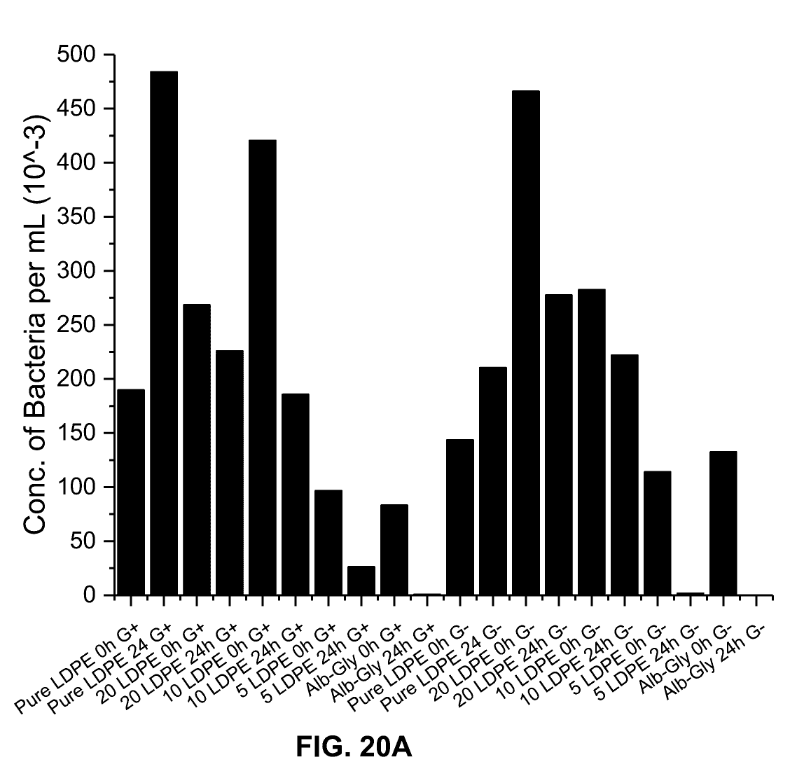

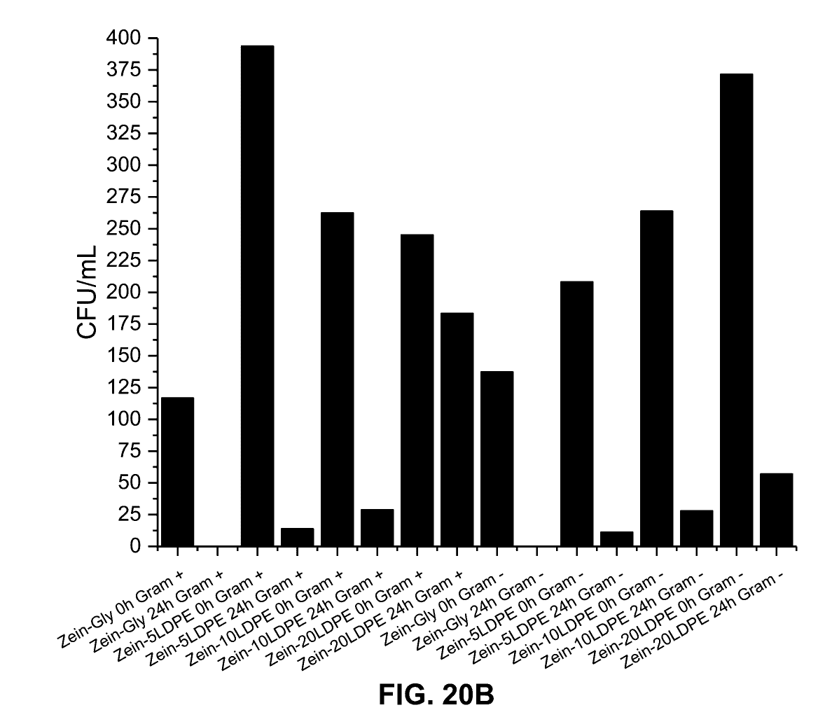

Surface Antibacterial Testing. In order to determine if albumin or zein-based plastics have efficacy to prevent bacterial spread, it is necessary to conduct surface antibacterial testing. FIGS. 20A-20B shows that, after the application of inoculated agar to the surface of both albumin-based and zein-based plastics, as the amount of LDPE in the thermoplastic blend increases, there is a decrease in the inhibitive effect of the plastic on surface bacteria growth. For instance, in the plastics that contained 20% LDPE there remained at least 150 CFUs/mL after the application of Gram+ bacteria, while with 5% of LDPE there are less than 25 CFUs/mL recovered. Albumin-glycerol and zein-glycerol bioplastics are able to prevent the growth of bacteria on its surface after 24 hours of application for both Gram+ and Gram− bacteria, due to potential glycerol leeching and antibacterial properties of the albumin and zein proteins itself^{15,21}. However, when we increase the LDPE (no antimicrobial efficacy) content to the thermoplastic blend, complete surface bacterial growth prevention on the resulting thermoplastic blend is not present. For instance, in the albumin plastics that contain 20% LDPE there is a 15.88% decrease in Gram+ bacterial colonies, and for zein that contains the same amount of LPDE there is a 25.23% decrease. However, when there is only 5% of LDPE in the plastics, there is a 72.79% decrease in Gram+ bacterial colonies for albumin plastics, while for zein plastics there is a 96.45% decrease. Zein/LDPE of 90/10 blend still shows ˜90% reduction in bacterial count after 24 hours. This may be due to inherent hydrophobic and antimicrobial properties of zein protein. Our results corroborate with results found in past research on this subject, as plastics that have been incorporated with antibacterial additives such as nisin in PE-PEO films (84.6% inhibition after 3 days)²² and chitosan-PEO films (3 log₁₀ reduction after 24 hours)²³ as complete resistance to bacterial growth on plastic surfaces of thermoplastic blends is not possible without the use of additives specifically designed to prevent bacterial growth⁸.

Drug Elution Properties of Albumin and Zein Plastic Blends.

In order for use in medical and food packaging applications, additional antimicrobial properties can be included in these plastics. To enhance antimicrobial properties, two common medical drugs (ampicillin and ciprofloxacin) were utilized and two food preservatives (sodium benzoate and sodium nitrite) in the preparation of drug eluting plastics. With the ability of drug elution, it can be possible to prevent bacteria growth in a given area, as opposed to the prevention of surface bacterial adhesion.

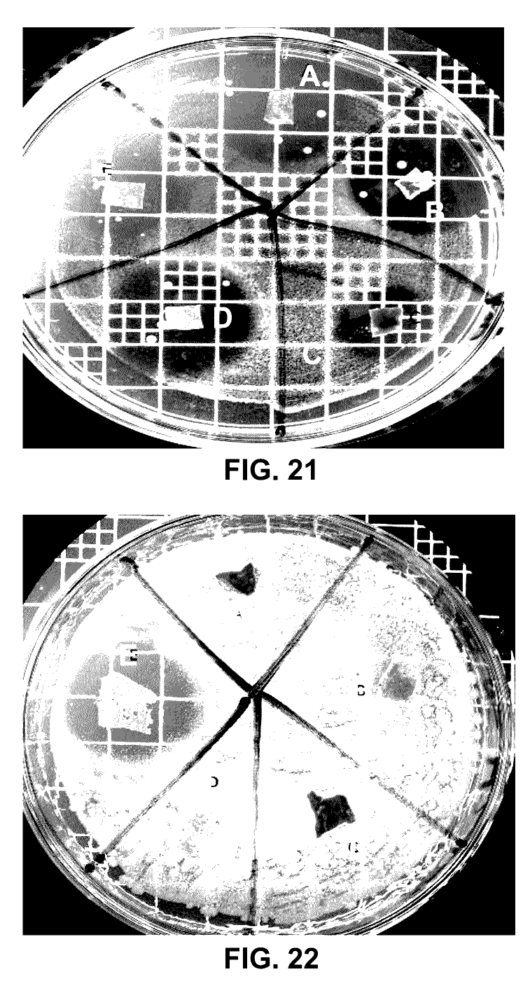

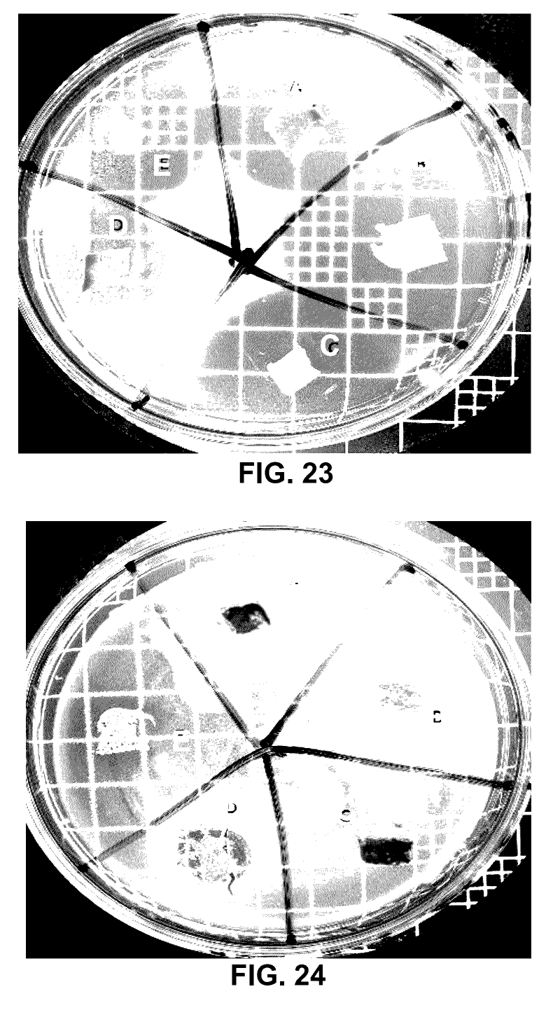

After imparting additional antibacterial properties into the thermoplastic blend through the elution of additives, it was observed that sodium nitrite is an ineffective additive to utilize, as the plastics in which it is imbedded did not generate any zones of inhibition on inoculated petri dishes, as shown in FIGS. 21-24. The lack of effective antibacterial elution properties of sodium nitrite could be due to a lack of oxygen intake in the Petri dishes that allows anaerobic species to continue growth as the bacterial organisms is unable to absorb the sodium nitrite in an environment with low level of oxygen²⁴. This lack of the inhibition zone may also be due to the potential lack of elution during the allotted time period. When we utilize sodium benzoate, we do find a gradual increase in the zone of inhibition of the plastics over time, a sign of the release of benzoic acid into the agar. Benzoic acid will be generated by the dissociation of the sodium benzoate by the bacteria, releasing sodium hydroxide as well²⁵. During the dissociation of sodium benzoate, the release of benzoic acid will reduce the pH of intracellular water by over 1 pH unit²⁶, inhibiting cell growth.

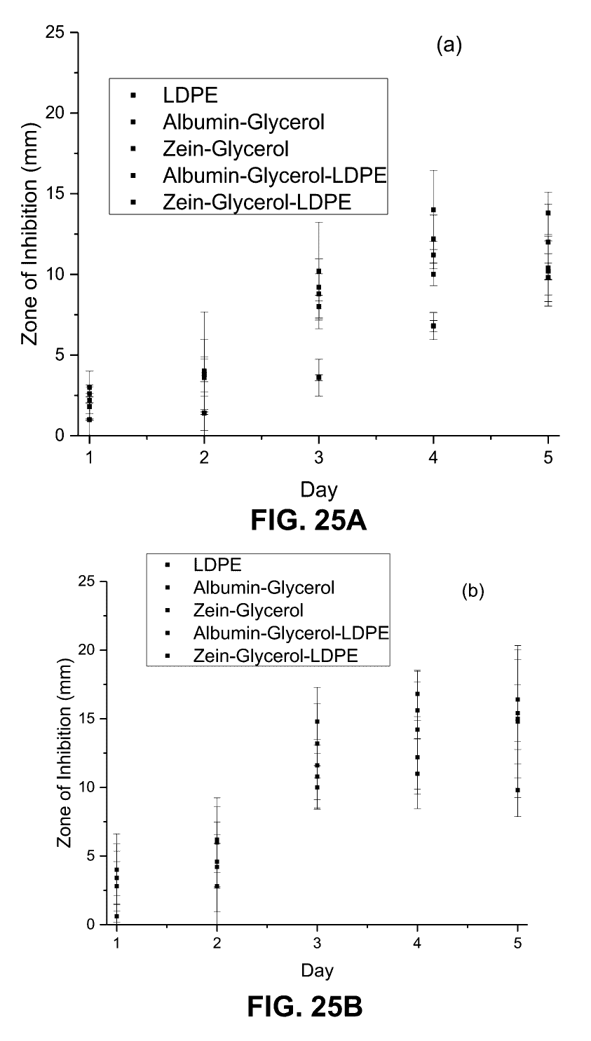

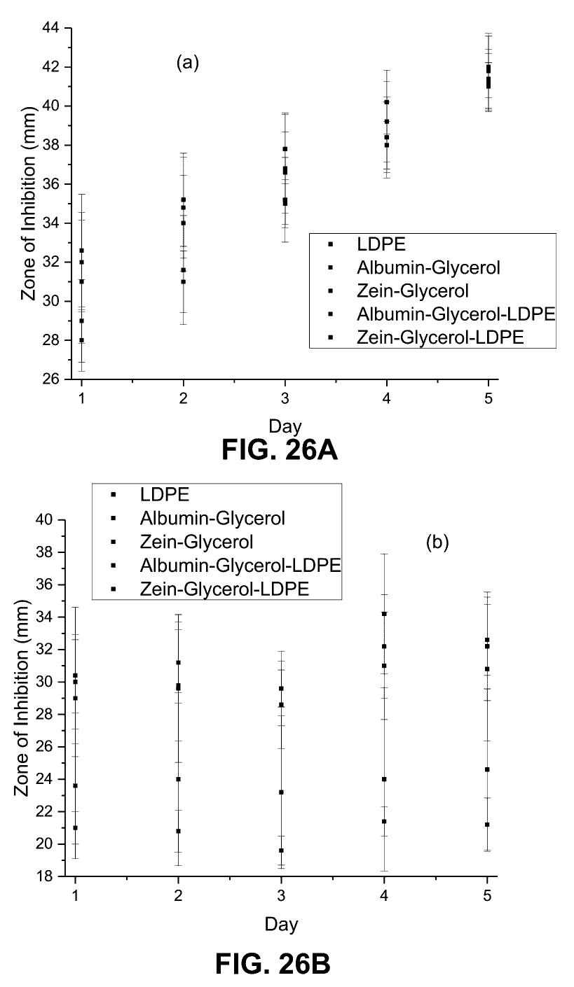

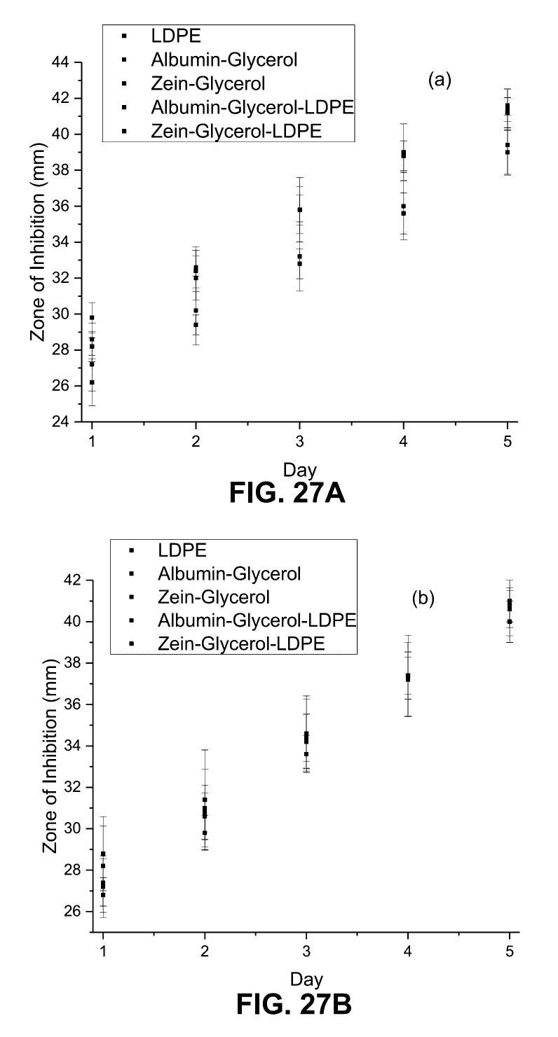

With the utilization of antibiotics such as ampicillin and ciprofloxacin, as shown in FIGS. 26A-27B, we find that both are much more effective in terms of inhibition zones after 5 days created for both Gram+(43.4-39.2 mm for ampicillin, 42.1-37.7 mm for ciprofloxacin) and Gram− bacteria (35.2-19.4 mm for ampicillin, 38.5-41.7 mm for ciprofloxacin) when compared to sodium benzoate (15.2-8.1 mm for Gram+, 20.1-7.4 mm for Gram−) as shown in FIGS. 25A-25B and sodium nitrite (0 mm of inhibition for both bacteria; not shown). Both of the antibiotics exhibit inhibition zones of increasing size as time passes, with the plastics that contain ciprofloxacin possessing a linear trend in zone of inhibition growth after five days. Ciprofloxacin possesses this advantage due to its ability to inhibit both Gram+ and Gram− growth, as it has been designed to be effective against a wide range of bacterial organisms, as well as its ability to elute from a material easily²⁷. While ampicillin possesses an ability to consistently inhibit Gram+ bacteria growth, for Gram− bacteria we find that the zone of inhibition stays a consistent size (37.2-18.3 mm) after 5 days. Ampicillin lacks the same antibacterial effectiveness against E. coli when compared to ciprofloxacin because the bacteria are potentially gaining a resistance to the ampicillin²⁸.

Effect of Drug Concentration on Zone of Inhibition.

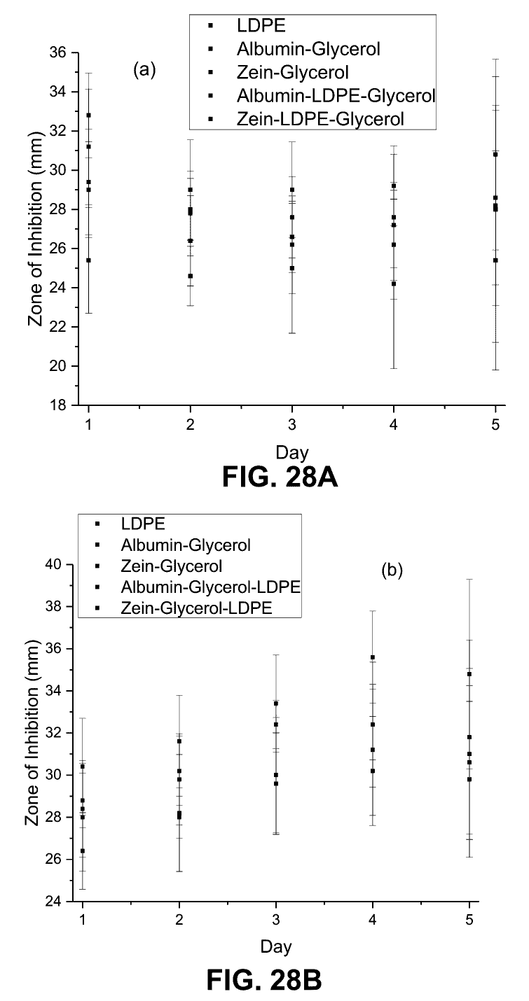

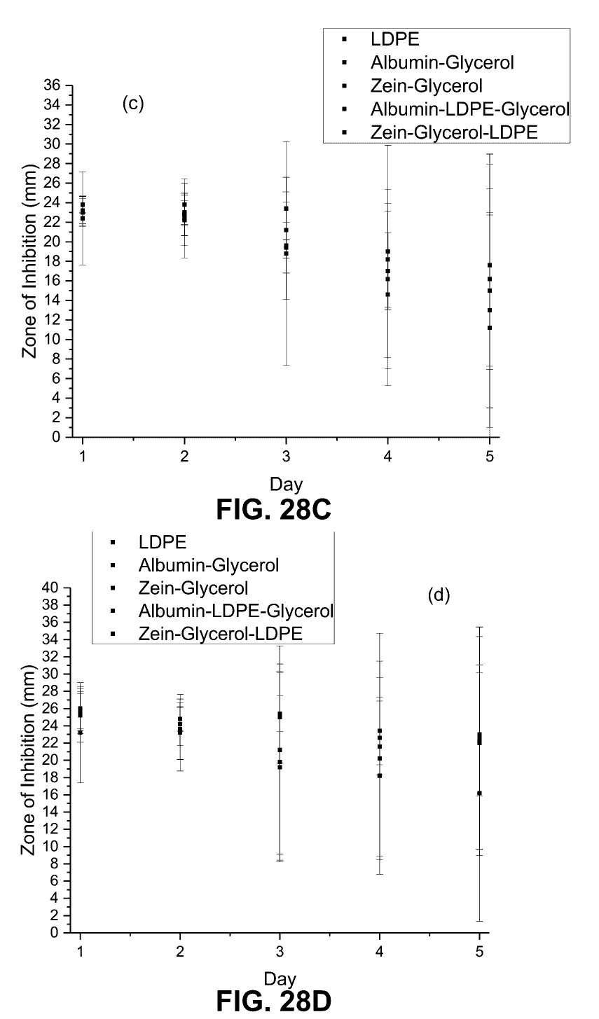

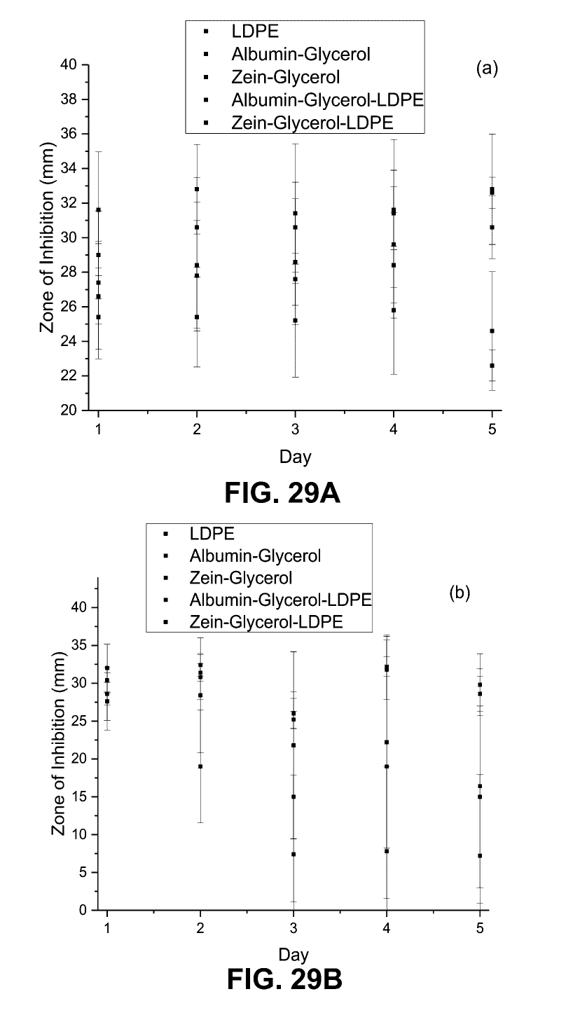

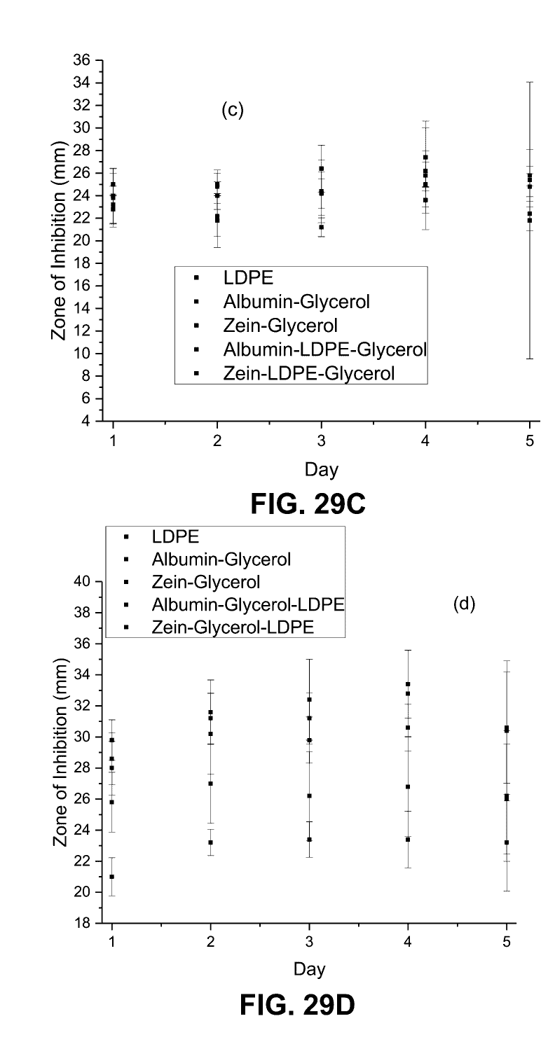

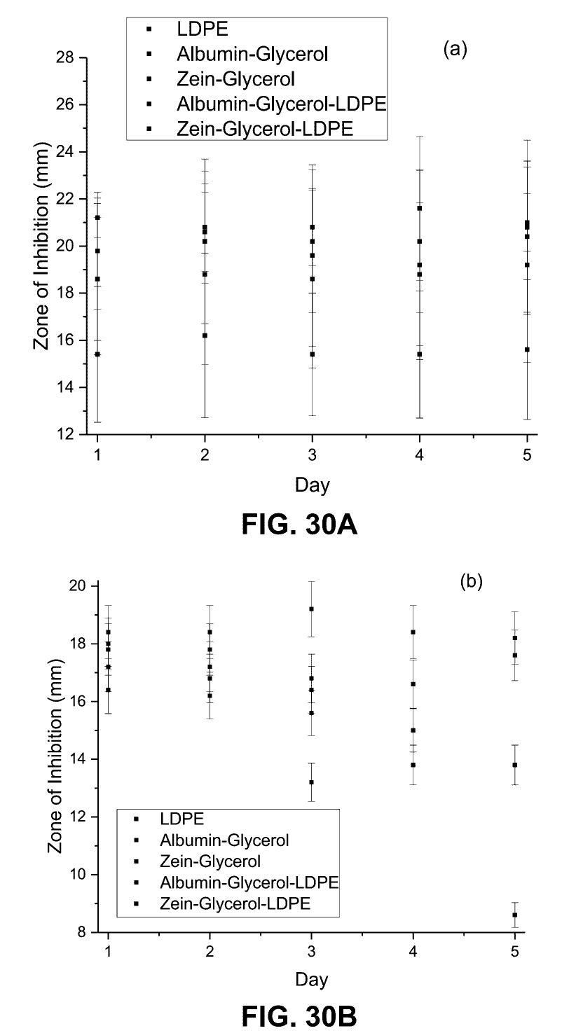

To determine the effect of drug/food preservative levels on the inhibition zones generated by plastics, 5% and 10% additives were loaded into the plastics. The results are compiled in FIGS. 28A-30B. When the plastics were modified to contain lesser amounts of the antibiotics, we find the overall size of the inhibition zones will decrease, as well as an increase of the variability of inhibition zone size. The decrease in inhibition zone size was observed to be caused by lower amounts of antibiotic released from the plastic, with the potential formation of drug resistance by the bacteria if the dose of antibiotic in the environment is too low. It was also observed the results of plastics containing 10% and 5% of loaded drug possess a higher degree of variability when compared to plastics containing 15% of loaded drug. Since there is less antibiotic in the plastic, there is an increase in probability that the drug release from the plastics will not be as uniform, which increases variability²⁹. Another finding, the albumin-based plastics will result in relatively higher zones of inhibition when compared to the pure LDPE and the zein plastics, with increased levels of drug elution possible. The albumin plastics possess higher zones of inhibition, because of their increased ability to elute drugs and food preservatives in comparison to zein and LDPE plastics, as albumin is more permeable in areas that contain higher moisture such as bacterial colonies³⁰.

As for the sodium benzoate plastics, when the amount of food preservative in the plastic was decreased, the plastics were observed to be unable to produce a zone of inhibition when encountered with a Gram+ bacteria. This lack of effectiveness against Gram+ such as B. subtilis may be due to sodium benzoate's inability to generate enough benzoic acid in solution to eliminate Gram+ colonies at lower concentrations³¹. It was also observed that much like the plastics that have been loaded with antibiotics, the sodium benzoate containing plastics will have a much higher level of variability in the zone of inhibition generated when encountering Gram− species, which could due to the lack of even dispersion in the plastic.

Statistical Analysis of Drug Elution on Zone Inhibition.

Inhibition Zone Analysis for Albumin Bioplastics and Zein Bioplastics.

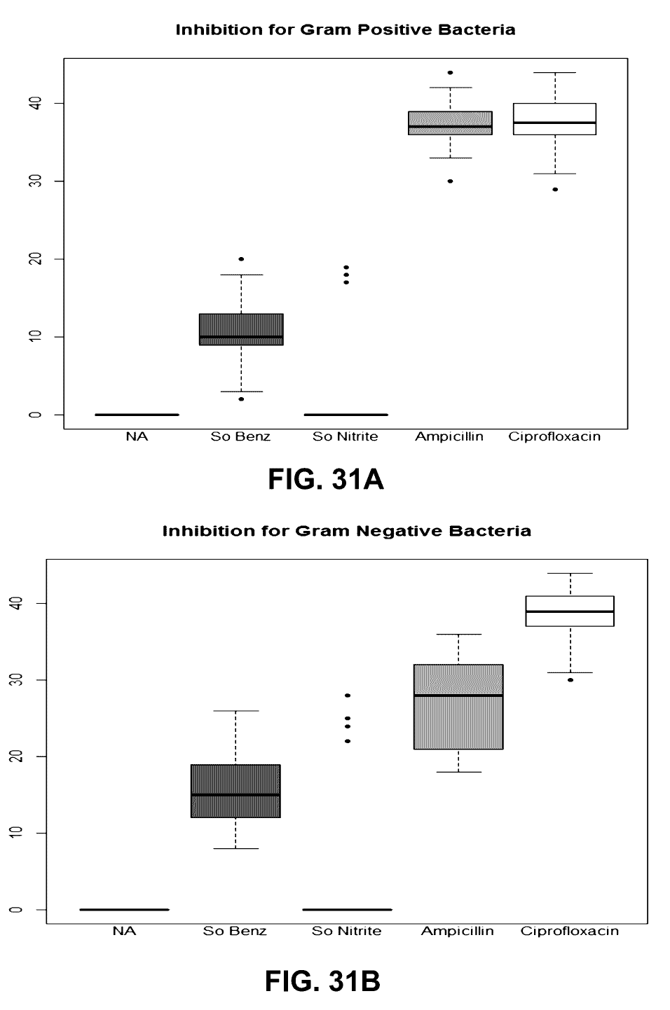

With the statistical analysis of the drug elution experimental raw data, certain inferences can be made. We fit a regression model with the diameter of the inhibition zone as the response and different types of proteins and drugs or preservatives as explanatory variables. One standard assumption for fitting a regression model is that the errors are identically and independently distributed Normal random variables with zero mean and some constant variance. However, this assumption will not be valid since there is (almost) no inhibition for the control (no drug) and preservative, Sodium Nitrite. As seen in FIGS. 31A-31B, from the boxplots that compare the resulting inhibition for different drugs and food preservatives, we conclude that we should concentrate on Sodium Benzoate, Ampicillin and Ciprofloxacin only.

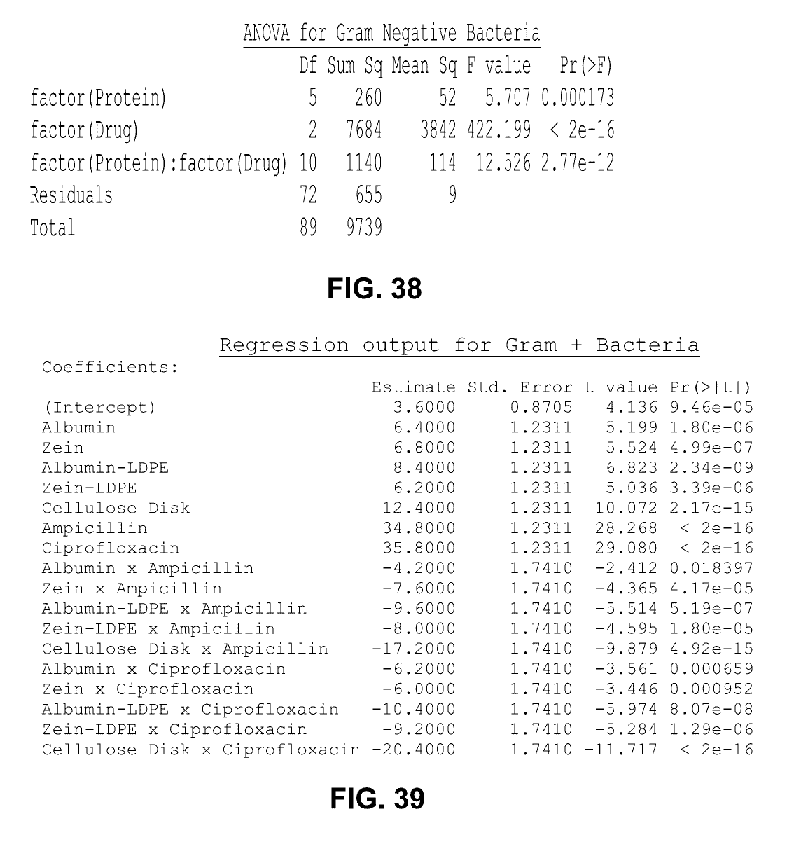

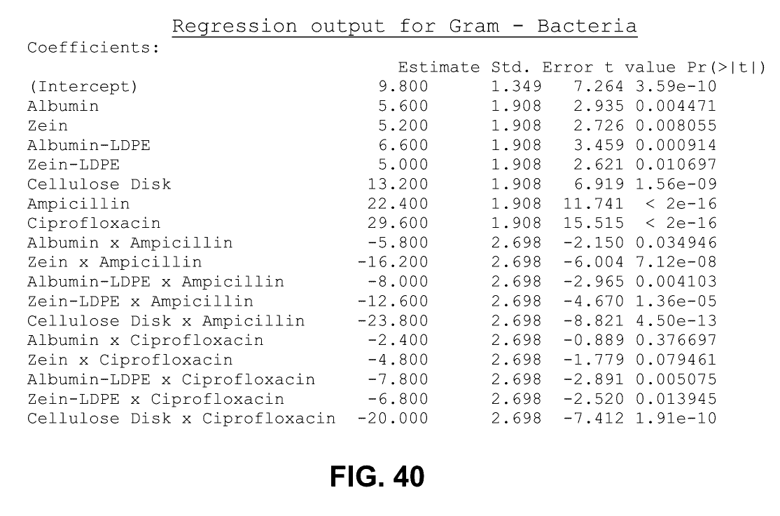

After the elimination of Sodium Nitrite as a potential additive, it is now possible to fit a regression model with the diameter of the inhibition zone as the response and different types of proteins and three drugs/food preservatives (Sodium Benzoate, Ampicillin and Ciprofloxacin). We entertain both main effects of proteins and drugs as well as the interactions between proteins and drugs in our model, and fit two separate models for Gram+ and Gram− bacteria. As shown in FIGS. 37-40 for both regression models, it was determined that the factors of proteins and drugs/food preservatives are both statistically significant, as well as the interaction between the proteins and drugs/food preservatives, for both Gram+ and Gram− bacteria. When comparing the influences of the drugs and proteins on expected results, the sum of squares corresponding to the factor of drugs is 14652 out of a total of 15729, while the factor Gram− bacteria it is 7684 out of the total of 9739, indicating the weight of these factors in the amount of variation that can be seen in the data. Clearly the type of drug/preservative use can explain most of the variation in data, so we determine that the use of protein has the greatest influence for both Gram+ and Gram− bacteria.

With the examination of the regression coefficients for both Gram+ and Gram− negative data, many inferences can be made. For the Gram+ bacteria, we find that the combination of Albumin and Ampicillin results in the maximum amount of predicted inhibition (3.6+34.8+6.4−4.2=40.6 mm), followed by Zein and Ciprofloxacin (3.6+35.8+6.8−6.0=40.2 mm). Albumin and LDPE samples that contain ciprofloxacin are also good, with predicted inhibition being 39.6 and 39.4, respectively. As for the Gram− bacteria, we find that the combination of Albumin and Ciprofloxacin would result in the maximum amount of predicted inhibition (9.8+29.6+5.6−2.4=42.6 mm), then followed by Zein and Ciprofloxacin (9.8+29.6+5.6−4.8=40.2 mm) and LDPE and Ciprofloxacin (9.8+29.6=39.4 mm).

When the individual types of protein/polymer and the type of additive utilized was compared, several findings were determined. Through the use of the regression model described herein, it was observed that the additive of Ciprofloxacin is best for the prevention of Gram− bacteria growth, as it can generate the largest inhibition zones when compared to the other three drugs/food preservatives. As for the type of plastic sample, zone of inhibitions will be greatest when albumin is utilized as the material, with zein in a close second, and LDPE with the lowest inhibition zones. When the same type of regression analysis for the Gram+ results was conducted, it was observed that both the additives of Ampicillin and Ciprofloxacin are highly effective in the prevention of bacterial growth. The regression model suggests that the combination of albumin with Ampicillin as an additive will lead to the largest zone of inhibition, with any of the plastic types (albumin, zein, or LDPE) being effective in bacterial growth prevention when blended with Ciprofloxacin.

Inhibition Zone Analysis for Albumin and Zein Thermoplastic Blends.

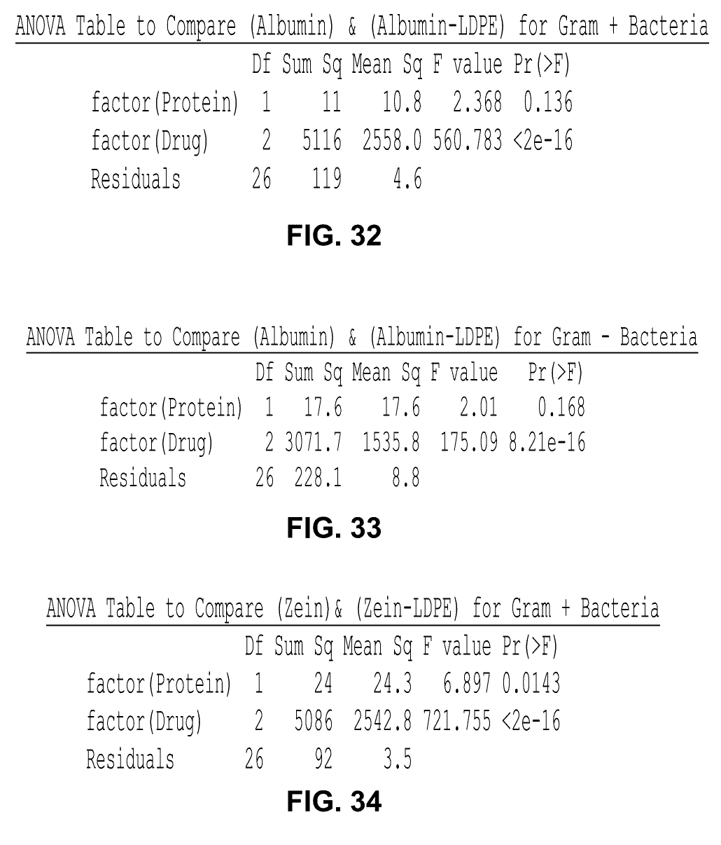

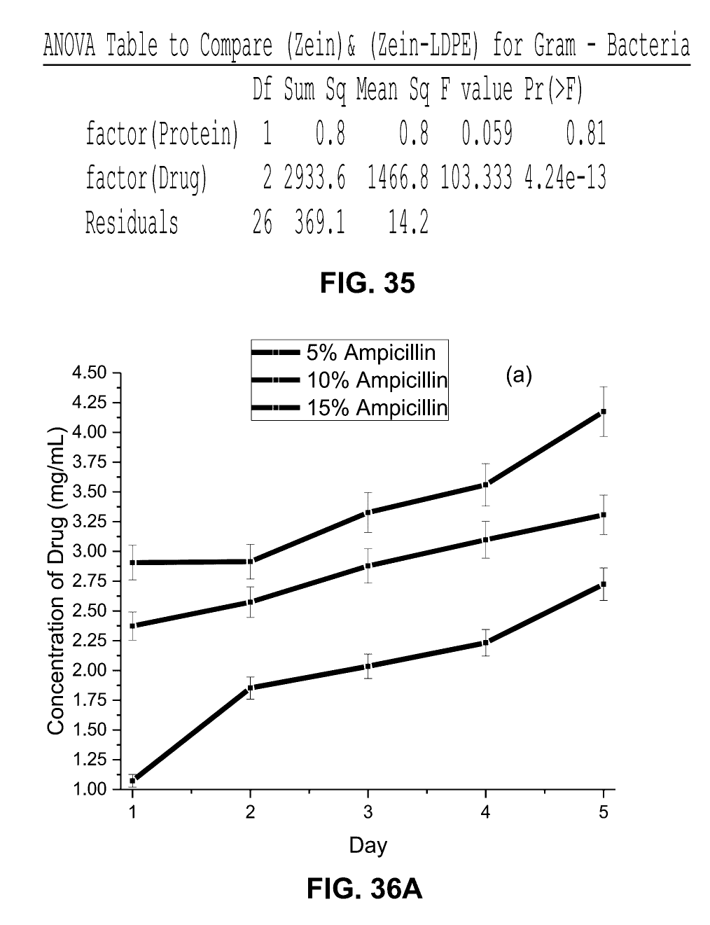

The effect of the addition of LDPE into the plastic blends on the level of drug elution was examined. As the interaction is considered significant, it is be appropriate to consider each protein separately. However, when both albumin with albumin blended with LDPE and zein and zein blended with LDPE are considered, it is appropriate to consider models without interaction and fit the model to the data points pertaining to either albumin and albumin-LDPE or zein and zein-LDPE. In the comparison between albumin and albumin-LDPE, no significant difference was observed between the two proteins for both Gram+ and Gram− bacteria, as the p-values in the ANOVA tables shown in FIGS. 37-40 are sufficiently big. For the zein and zein-LDPE comparison, the same inferences can be made for both Gram+ and Gram−, as shown in the ANOVA tables in FIGS. 32-35. However, the p-value corresponding to the proteins is not too big for Gram+ bacteria, but even there we can conclude that adding LDPE does not make any different al 10% level of significance. These conclusions are based on a model with drugs Sodium Benzoate, Ampicillin and Ciprofloxacin, but the conclusions will essentially not change even if the control (no drugs) and Sodium Nitrates were included in the model.

Elution Kinetics of Albumin Bioplastics.

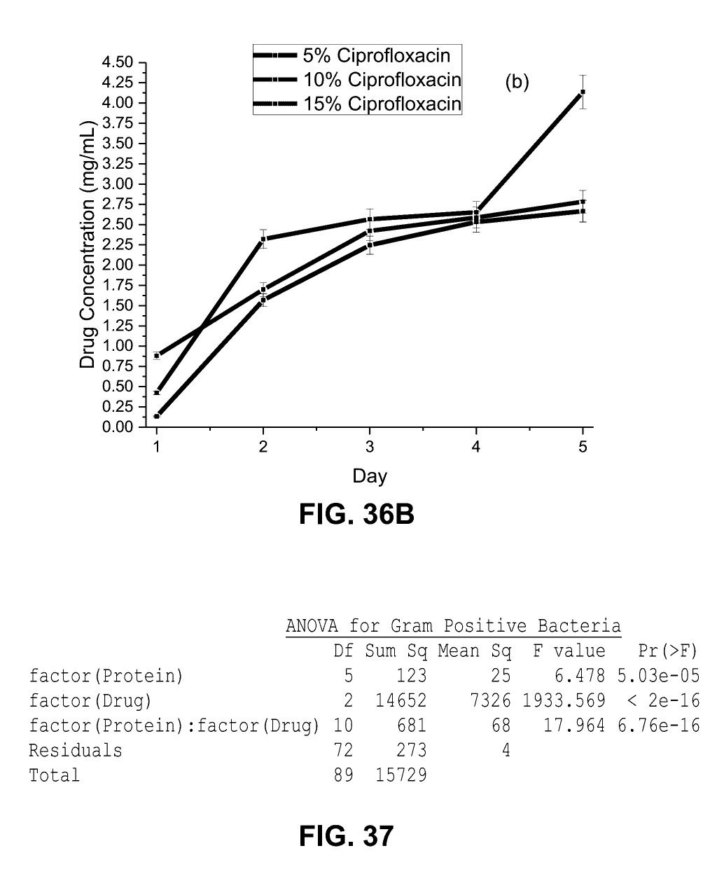

As the albumin-based bioplastics that contained ampicillin and ciprofloxacin possess the greatest ability to generate inhibition zones, we examine further the elution kinetics of these samples. The kinetics of drug elution for albumin-glycerol bioplastics containing ampicillin and ciprofloxacin at 5, 10, and 15% concentrations were analyzed using the formulations we have previously utilized. When analyzing the albumin bioplastics that contain either drug, it was observed that the amount of drug loaded into the plastic is crucial to the amount of antibiotic that will be released over a given period of time. With the albumin that contains 15% of ampicillin, we find that it will elute more ampicillin in solution in one day than what will be eluted from the 5% ampicillin-containing samples in five days, as well as the amount to be eluted from the 10% ampicillin-containing samples after three days. Albumin bioplastics that contain 15% of ampicillin can elute more drug due to the fact that they contain more drug, as this allows more ampicillin to be released over time after its initial release.³². For the albumin bioplastics containing ciprofloxacin, the release of drug from the plastic is more gradual, as the plastic that contains 15% ciprofloxacin can release a considerably higher amount of antibiotic after five days in solution when compared to albumin plastics containing 10% and 5% of ciprofloxacin. Based on the time required to release ciprofloxacin from albumin bioplastics (there was little difference in all of the drug levels before 5 days of analysis), ciprofloxacin may be bound to the albumin-glycerol material in a way that inhibits an immediate release when compared to other drugs³³. The elution rate of drugs from albumin-glycerol bioplastics is shown in FIGS. 36A-36B.

Conclusions

When the surface antimicrobial properties of the protein-thermoplastic blends was compared it was observed that adding more LDPE into the thermoplastic blend can diminish the antimicrobial properties that are witnessed in pure-protein bioplastics. The addition of food preservatives and drugs into the thermoplastic blend can have varying degrees of antimicrobial properties due to elution, as it was demonstrated that pure albumin-glycerol bioplastics loaded with the antibiotics of ampicillin or ciprofloxacin provide the best drug elution properties of all of the thermoplastic blends analyzed. In comparison, the use of no drugs or food preservatives were less effective in the prevention of bacterial growth on Petri dishes. These materials can be tested under methods such as ASTM F2097—10: Standard Guide for Design and Evaluation of Primary Flexible Packaging for Medical Products, or ASTM F813—07(2012): Standard Practice for Direct Contact Cell Culture Evaluation of Materials for Medical Devices.

### REFERENCES FOR EXAMPLE 2

1. Hota, B., Contamination, Disinfection, and Cross-Colonization: Are Hospital Surfaces Reservoirs for Nosocomial Infection? Clinical Infectious Diseases 2004, 39 (8), 1182-1189.
2. Schultz, M., Gill, J., Zubairi, S., Huber, R., Gordin, F., Bacterial Contamination of Computer Keyboards in a Teaching Hospital. Infection Control and Hospital Epidemiology 2003, 24 (4), 302-303.
3. Borch, E., Kant-Muermans, M-L., Blixt, Y., Bacterial Spoilage of Meat and Cured Meat Products. International Journal of Food Microbiology 1996, 33 (1), 103-120.
4. Halden, R. U., Plastics and Health Risks. Annual Reviews of Public Health 2010, 31, 179-194.
5. Lau, O.-W., Wong, S-K., Naphthalene Contamination of Sterilized Milk Drinks Contained in Low-density Polyethylene Bottles: Part 1. Analyst 1994, 119 (5), 1037-1042.
6. Queiroz, A. C., Santos, J. D., Monteiro, F. J., Gibson, I. R., Knowles, J. C., Adsorption and release studies of sodium ampicillin from hydroxyapatite and glass-reinforced hydroxyapatite composites. Biomaterials 2001, 22 (11), 1393-1400.
7. Dimalo, F., O'Halloran, J. J., Quale, J. M., In vitro elution of ciprofloxacin from polymethylmethacrylate cement beads. Journal of Orthopaedic Research 1994, 12 (1), 79-82.
8. Vartiainen, J., Skytta, E., Enqvist, J., Ahvenainen, R., Properties of Antimicrobial Plastics Containing Traditional Food Preservatives. Packaging Technology and Science 2003, 16 (6), 223-229.
9. Neetoo, H., Ye, M., Chen, H., Joerger, R. D., Hicks, D. T., Hoover, D. G., Use of nisin-coated plastic films to control Listeria monocytogenes on vacuum-packaged cold-smoked salmon. International Journal of Food Microbiology 2008, 122 (1-2), 8-15.
10. Eby, D. M., Luckarift, H. R., Johnson, G. R., Hybrid Antimicrobial Enzyme and Silver Nanoparticle Coatings for Medical Instruments. ACS Applied Materials and Interfaces 2009, 1 (7), 1553-1560.
11. MacCallum, N., Howell, C., Kim, P., Sun, D., Friedlander, R., Ranisau, J., Ahanotu, O., Lin, J. J., Vena, A., Hatton, B., Wong, T-S., Aizenberg, J., Liquid-Infused Silicone As a Biofouling-Free Medical Material. ACS Biomaterials Science and Engineering 2015, 1 (1), 43-51.
12. Loo, C.-Y., Young, P. M., Lee, W-H., Cavaliere, R., Whitchurch, C. B., Rohanizadeh, R., Superhydrophobic, nanotextured polyvinyl chloride films for delaying Pseudomonas aeruginosa attachment to intubation tubes and medical plastics. Acta Biomaterialia 2012, 8 (5), 1881-1890.
13. Freschauf, L. R., McLane, J., Sharma, H., Khine, M., Shrink-Induced Superhydrophobic and Antibacterial Surfaces in Consumer Plastics. PLOS One 2012, 7 (8), 1-7.
14. (a) Jones, A., Zeller, M A, Sharma, S, Thermal, mechanical, and moisture absorption properties of egg white protein bioplastics with natural rubber and glycerol. Progress in Biomaterials 2013, 2 (12); (b) Gillgren, T., Stading, M., Mechanical and Barrier Properties of Avenin, Kafirin, and Zein Films. Food Biophysics 2008, 3 (3), 287-294.
15. Jones, A., Mandal, A., Sharma, S., Protein-based bioplastics and their antibacterial potential. Journal of Applied Polymer Science 2015, 132 (18).
16. Güçbilmez, ç. M., Yemenicioglu, A., Arslanoglu, A., Antimicrobial and antioxidant activity of edible zein films incorporated with lysozyme, albumin proteins and disodium EDTA. Food Research International 2007, 40, 80-91.
17. Jain, D., Banerjee, R., Comparison of ciprofloxacin hydrochloride-loaded protein, lipid, and chitosan nanoparticles for drug delivery. Journal of Biomedical Materials Research Part B: Applied Biomaterials 2008, 868 (1), 105-112.
18. Sue, H. J., Wang, S, Lane, J L, Morphology and mechanical behaviour of engineering soy plastics. Polymer 1997, 38 (20), 5035-5040.
19. Institute, C. a. L. S., M02-A11 In Performance Standards for Antimicrobial Disk Susceptibility Tests; Approved Standard—Eleventh Edition Clinical and Laboratory Standards Institute Wayne, Pa., 2012; Vol. M02-A11
20. Cazedey, E. C. L., Salgado, H. R. N, Spectrophotometric Determination of Ciprofloxacin Hydrochloride in Ophthalmic Solution. Advances in Analytical Chemistry 2012, 2 (6), 74-79.
21. Torres-Giner, S., Ocio, M. J., Lagaron, J. M., Novel antimicrobial ultrathin structures of zein/chitosan blends obtained by electrospinning. Carbohydrate Polymers 2009, 77 (2), 261-266.
22. Cutter, C. N., Willett, J. L., Siragusa, G. R., Improved antimicrobial activity of nisin-incorporated polymer films by formulation change and addition of food grade chelator. Letters in Applied Microbiology 2001, 33 (4), 325-328.
23. (a) Zivanovic, S., Li, J., Davidson, P. M., Kit, K., Physical, Mechanical, and Antibacterial Properties of Chitosan/PEO Blend Films. ACS Biomacromolecules 2007, 8 (5), 1505-1510; (b) Coma, V., Martial-Gros, A., Garreau, S., Copinet, A., Salin, F., Deschamps, A., Edible Antimicrobial Films Based on Chitosan Matrix. Journal of Food Science 2006, 67 (3), 1162-1169.
24. Fang, C.-S., Post, L. S., Solberg, M., Antimicrobial Effect and Disappearance of Sodium Nitrite in Staphylococcus aureus Cultures. Journal of Food Science 1985, 50 (5), 1412-1416.
25. WHO CONCISE INTERNATIONAL CHEMICAL ASSESSMENT DOCUMENT NO. 26: BENZOIC ACID AND SODIUM BENZOATE; World Health Organization—INTERNATIONAL PROGRAMME ON CHEMICAL SAFETY: Geneva, 2000.
26. Krebs, H. A., Wiggins, D., Stubbs, M., Studies on the mechanism of the antifungal action of benzoate. Biochemical Journal 1983, 214 (3), 657-663.
27. Unnithan, A. R., Barakat, N. A. M., Pichiah, P. B. T., Gnanasekaran, G., Nirmala, R., Cha, Y., Jung, C., El-Newehy, M., Kim, H. K., Wound-dressing materials with antibacterial activity from electrospun polyurethane-dextran nanofiber mats containing ciprofloxacin HCl. Carbohydrate Polymers 2012, 90 (4), 1786-1793.
28. Reinthaler, F. F., Posch, J., Feierl, G., Wüist, G., Haas, D., Ruckenbauer, G., Mascher, F., Marth, E., Antibiotic Resistance of E. coli in sewage and sludge. Water Research 2003, 37 (8), 1685-1690.
29. Reza, S., Quadir, M. A., Haider, S. S., Comparative evaluation of plastic, hydrophobic and hydrophilic polymers as matrices for controlled-release drug delivery. Journal of Pharmacy and Pharmaceutical Sciences 2003, 6 (2), 282-291.
30. Gennadios, A., Weller, C. L., Hanna, M. A., Froning, G. W., Mechanical and Barrier Properties of Egg Albumen Films. Journal of Food Science 1996, 61 (3), 585-589.
31. EI-Shenawy, M. A., Marth, E. H., Sodium Benzoate Inhibits Growth of or Inactivates Listeria monocytogenes. Journal of Food Protection 1988, 51 (7), 525-530.
32. Liu, H., Leonas, K. K., Zhao, Y., Antimicrobial Properties and Release Profile of Ampicillin from Electrospun Poly(ε-caprolactone) Nanofiber Yarns. Journal of Engineered Fibers and Fabrics 2010, 5 (4), 10-19.
33. Anguita-Alonso, P., Rouse, M. S., Piper, K. E., Jacofsky, D. J., Osmon, D. R., Patel, R., Comparative Study of Antimicrobial Release Kinetics from Polymethylmethacrylate. Clinical Orthopaedics and Related Research 2006, 445, 239-244.

### Example 3

### Introduction

The use of conventional petroleum-based plastics such as polyethylene (PE), polypropylene (PP), and polyethylene terephthalate (PET) in medical and food packaging applications poses the major drawback of negative environmental impact. One of the problems with the use of conventional plastics is that they may not be recycled when used in medical and food packaging applications. In medical settings, the recycling of plastics used for medical procedures and laboratories are not widely practiced, as the recycling of biomedical waste will pose a health hazard due to the ease of contamination¹. While it is possible to recycle food packaging, consumer participation is a major issue, and plastics such as LDPE, polystyrene, and polypropylene, have been found to have poor recycling recovery rates².

To address the lack of biodegradability and antimicrobial properties in current conventional plastics, the use of alternative raw materials such as biodegradable polymers, starches, and proteins in the production of plastics has been examined³. In one study, materials used to develop bioplastic such as polylactic acid and poultry feather fiber, have been found to biodegrade more readily in soil when higher amounts of poultry feather and urea are utilized in the production of the pots⁴. This use of biodegradable materials will result in a material that will have a lower impact on the environment when compared to traditional plastics, as there are lower levels of CO₂ released into the environment through biodegradation than when plastics are incinerated⁵. However, the positive environmental impact of the use of biodegradable plastics is often overstated, as the use of some raw materials in biodegradable plastic production will have a greater negative impact when compared to petroleum-based plastics⁶. Another factor in the use of biodegradable material is the rate at which a bioplastic material will degrade. This factor can be highly dependent on both the conditions in which the bioplastic is placed in, as well as what the bioplastic is made of, with certain materials that claim to be biodegradable not possessing that property in certain conditions⁷. It is because of these potential benefits and pitfalls of biodegradable plastic use that additional research must be conducted to determine the full impact of biodegradable plastic production and use.

This Example examines albumin, which can be obtained hen egg white, and zein, which can be found in corn, and their usage in applications where biodegradation would be beneficial. With the use of plasticizers, both of these proteins can be utilized in the production of plastics that can be used in the areas of food packaging and medical applications⁸. This Example evaluates the water absorption and soil biodegradation properties of albumin-glycerol and zein-glycerol bioplastics and thermoplastic blends for use in medical or food packaging applications.

Materials and Methods Materials. Albumin (purity≧99%) was obtained from Sigma-Aldrich Corporation (St. Louis, Mo., USA); the zein purified protein was acquired from Acros Organics (New Jersey, USA); and the low density polyethylene (LDPE) powder (M_{w}˜25,000) (500 micron) was obtained from Alfa Aesar (Ward Hill, Mass., USA). The glycerol used as a plasticizer was obtained from Sigma-Aldrich with a purity ≧99%.

Preparation of Compression Molded Samples.

The molding of thermoplastic blends was performed on a 24-ton bench-top press (Carver Model 3850, Wabash, Ind., USA) with electrically-heated and water-cooled platens. Stainless steel molds were used to form dog bone-shaped thermoplastic blends for analysis of the plastic surface. In order to form the plastics, protein and plasticizer were mixed manually in predetermined w/w ratios to be placed into the molds described in Table 2. Table 2 shows the Composition of albumin or zein bioplastics/thermoplastic blends. The mixture of protein, polymer, and plasticizer was prepared in small batches of varying masses based on density of materials for dog bone plastics (≦6 g for albumin/albumin-LDPE blends, and ≦4 g for zein, zein-LDPE blends, and LDPE since zein and LDPE is less dense compared to albumin), while the DMA flexbars (prepared with spacers) were made of 2 g of albumin, zein, LDPE, albumin-LDPE, and zein-LDPE plastics.

TABLE 2

| Name of | | Plasticizer | Polymer |
|---|---|---|---|
| thermoplastic | | (Glycerol - | (LDPE - |
| blend | Protein (%) | %) | %) |
| LDPE | 0% | 0% | 100% |
| Alb-Gly | 75 Albumin% | 25% | 0% |
| Alb-5LDPE | 71.25% Albumin | 23.75% | 5% |
| Alb-10LDPE | 67.5% Albumin | 22.5% | 10% |
| Alb-20LDPE | 60% Albumin | 20% | 20% |
| Alb-35LDPE | 48.75% Albumin | 16.25% | 35% |
| Alb-50LDPE | 37.5% Albumin | 12.5% | 50% |
| Alb-65LDPE | 26.25% Albumin | 8.75% | 65% |
| Alb-80LDPE | 15% Albumin | 5% | 80% |
| Zein-Gly | 80% Zein | 20% | 0% |
| Zein-5LDPE | 76% Zein | 19% | 5% |
| Zein-10LDPE | 72% Zein | 18% | 10% |
| Zein-20LDPE | 64% Zein | 16% | 20% |
| Zein-35LDPE | 52% Zein | 13% | 35% |
| Zein-50LDPE | 40% Zein | 10% | 50% |
| Zein-65LDPE | 28% Zein | 7% | 65% |
| Zein-80LDPE | 16% Zein | 4% | 80% |

Subsequently, the mixture was filled into the flexbar or dog bone cavity of the stainless steel molds, with plungers placed on top of the molds to prevent the mixture from leaking. After covering with a plunger, the molds were then compressed for a 5-minute molding time at 120° C., followed by a 10-minute cooling period for the protein plastics. Samples were prepared under a pressure of at least 40 MPa, as a certain minimum amount of pressure can be applied in order to be able to mold a plastic⁹. After the samples were cooled for 10 minutes under pressure, the pressure was released and the samples were removed. When plastic molding was completed, the plastic samples were conditioned at 21.1° C. and 65% relative humidity for 24 hours before characterization through water stability and biodegradation analysis.

SEM Analysis of the Thermoplastic Samples.

Albumin and zein thermoplastic blend samples (n=2 for each protein-LDPE blend type) for SEM characterization were prepared from cryofracture of DMA flex bar after being placed in a conditioning chamber (21.1° C. and 65% relative humidity) for at least 24 hours. DMA flex bars were submerged in liquid nitrogen for 20 seconds followed by immediate breaking. The samples for SEM testing were then sputter coated for 60 seconds with an Au/Pt mix. SEM images were recorded on a Zeiss 1450EP variable pressure scanning electron microscope. Coated samples were analyzed at 20×, 100×, and 500× for each blend type.

Water Absorption Testing of Albumin-Based and Zein-Based Plastics.

The water absorption properties of the conditioned plastics were measured by performing the standard test method for water absorption for plastics (ASTM D 570-98 (2010) e1). After conditioning for 24 hours, the samples were dried in an oven set at 50±3° C. for 24 hours, cooled in a desiccator for one hour, then immediately weighed to the nearest 0.001 g. The materials were then tested for long-term immersion, in which the samples were placed in water set to a temperature of 23±1° C. for five days, with samples being removed and blotted every 24 hours prior to weight measurement and placement back into the water bath. Samples were run in quintuplicate (n=5) for each blend type in order to ensure precision.

Susceptibility of Plastics to Microbial Degradation.

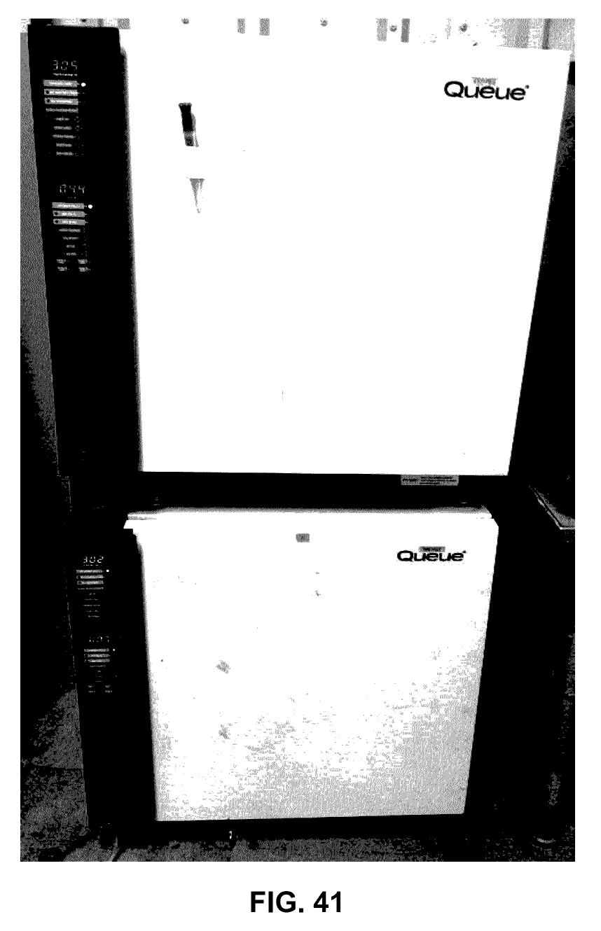

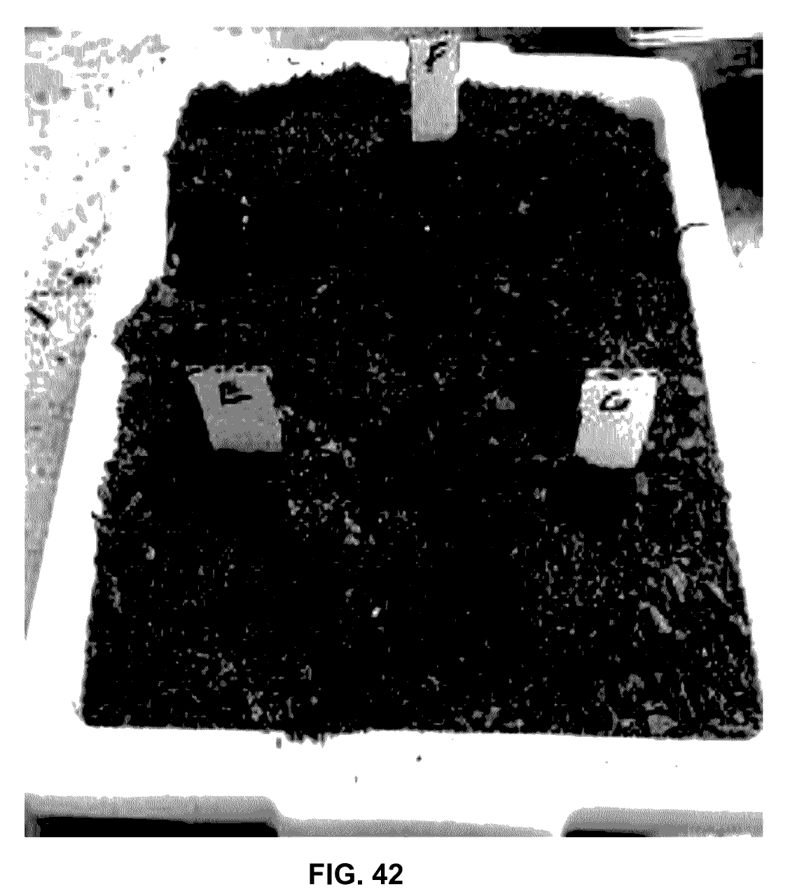

The susceptibility of the conditioned plastics to be degraded by microbial attack was measured by performing the standard practice for evaluating microbial susceptibility of nonmetallic materials by the laboratory soil burial test (ASTM G 160-12). After conditioning, the dog bone and flexbar samples were placed in plastic containers that contained a soil that was composed of equal amounts of fertile topsoil, cow manure, and coarse sand (10 to 40 mesh). The containers were then placed in an environmental chamber (see FIGS. 41 and 42) where the temperature would remain at 30±2° C., with a relative humidity of 85 to 95%. The materials were then tested for thirty- and sixty-day exposure periods, after which the samples were then cleaned to remove soil collecting on the surface, documented by photography, and weighed to the nearest 0.001 g to compare to samples that have not been subjected to testing. Samples were run in quintuplicate (n=5) for each blend type in order to ensure precision.

Results

Surface Analysis of Albumin and Zein Plastic Blends.

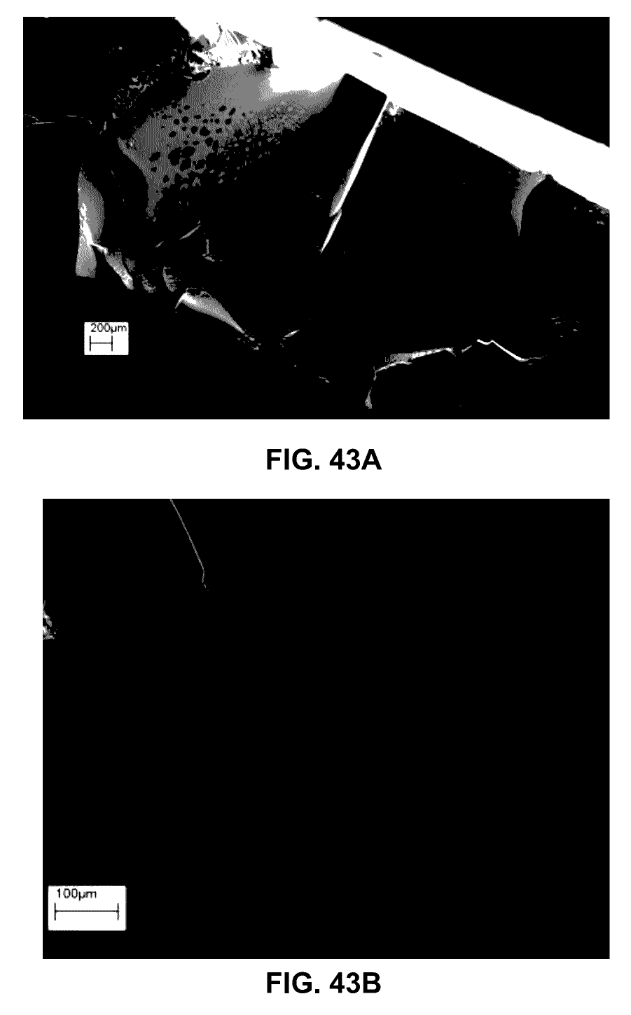

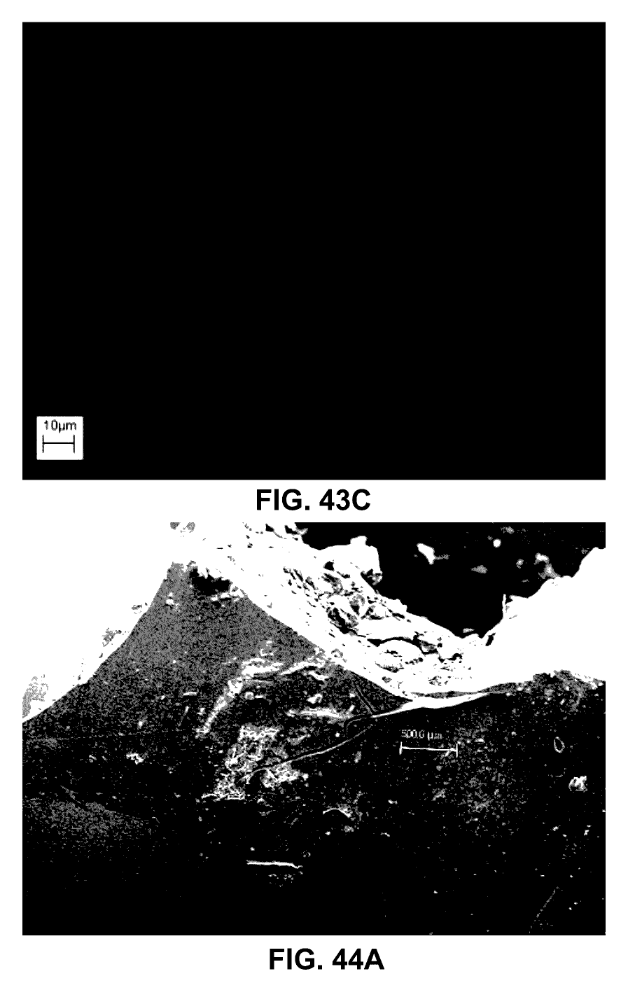

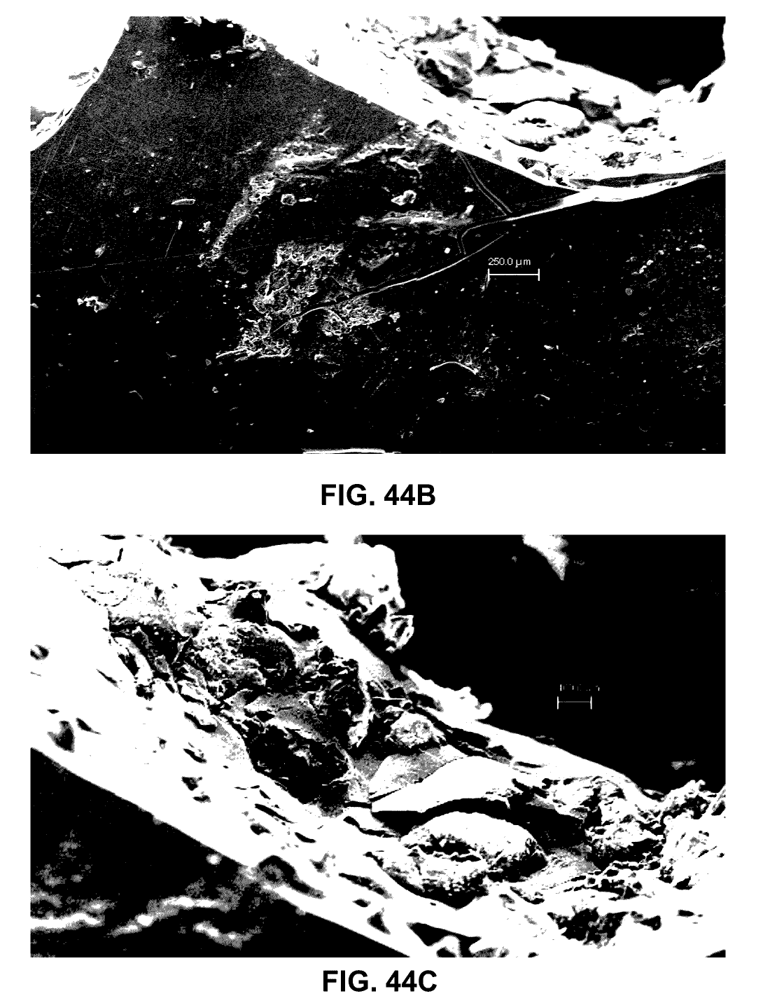

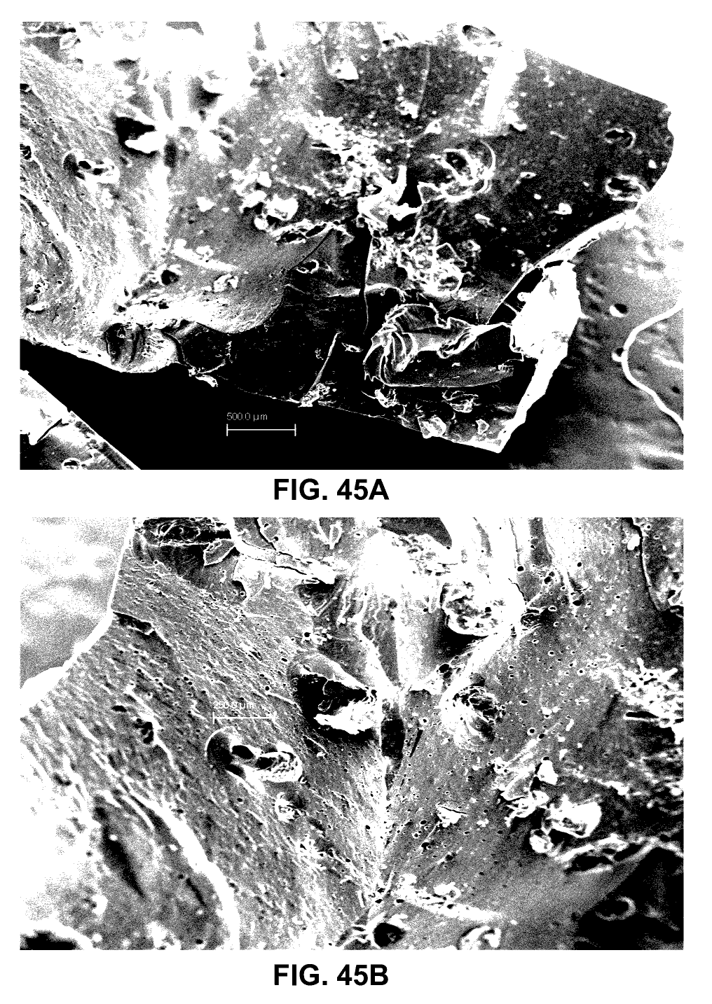

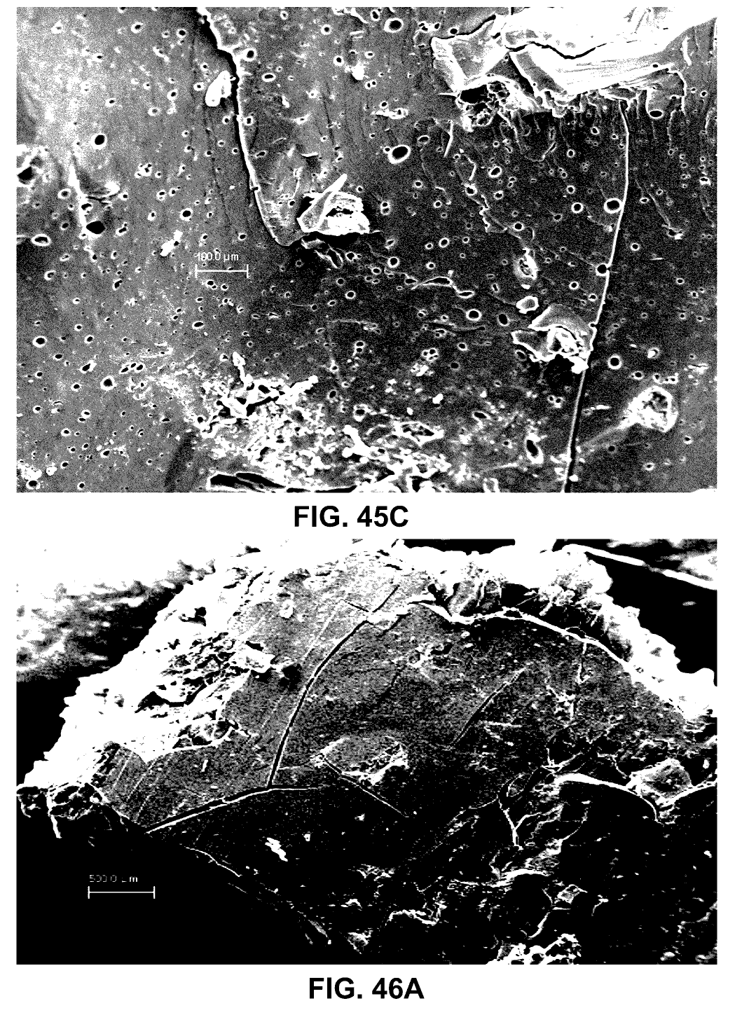

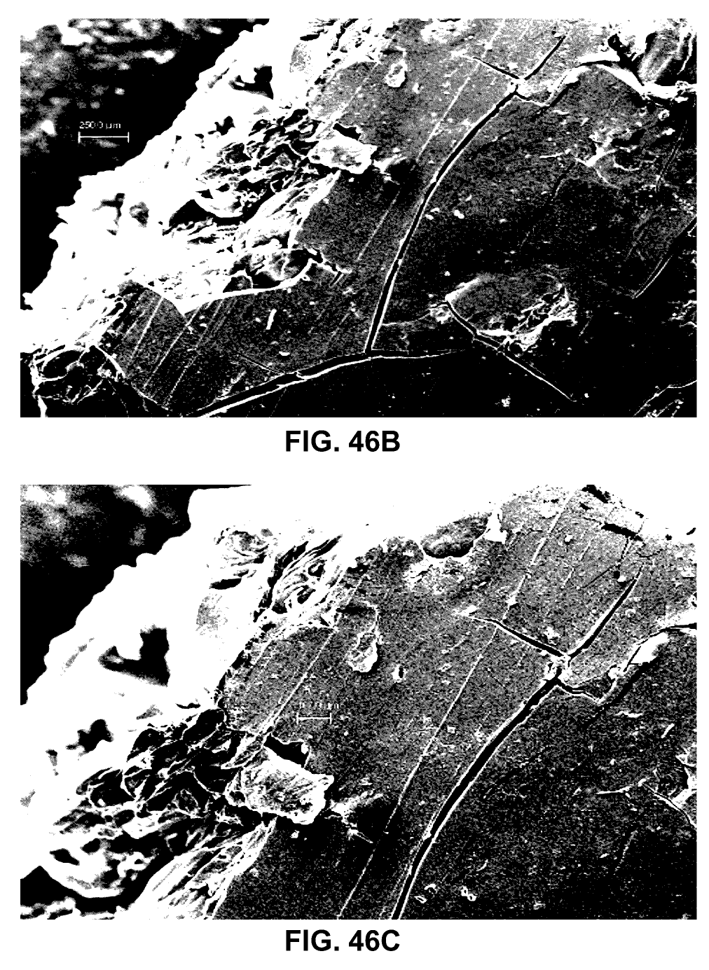

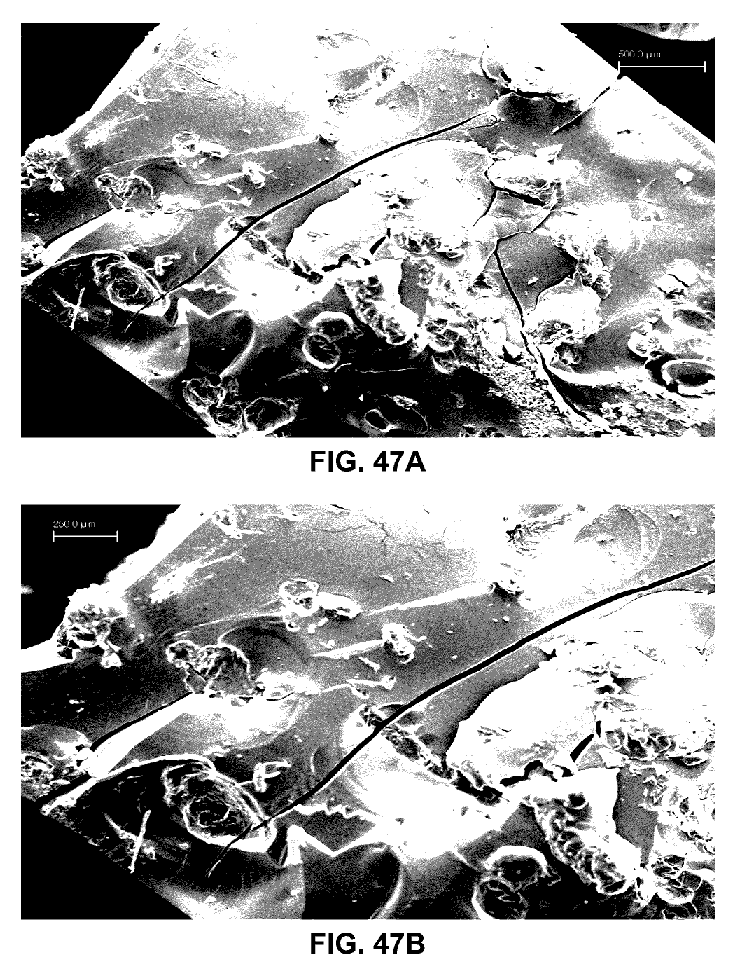

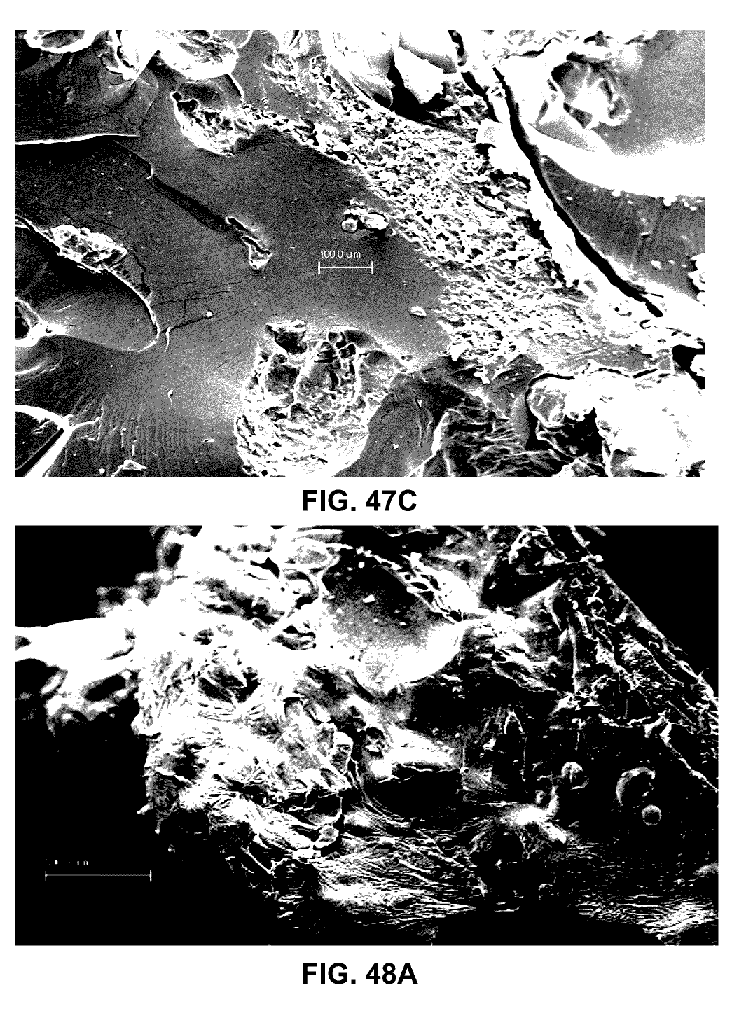

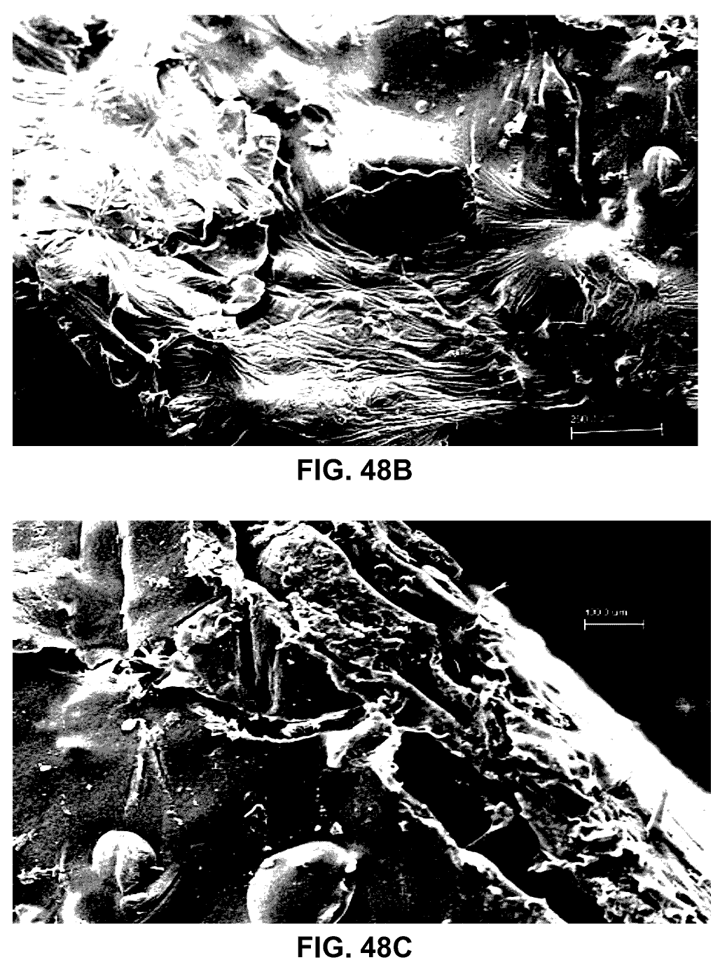

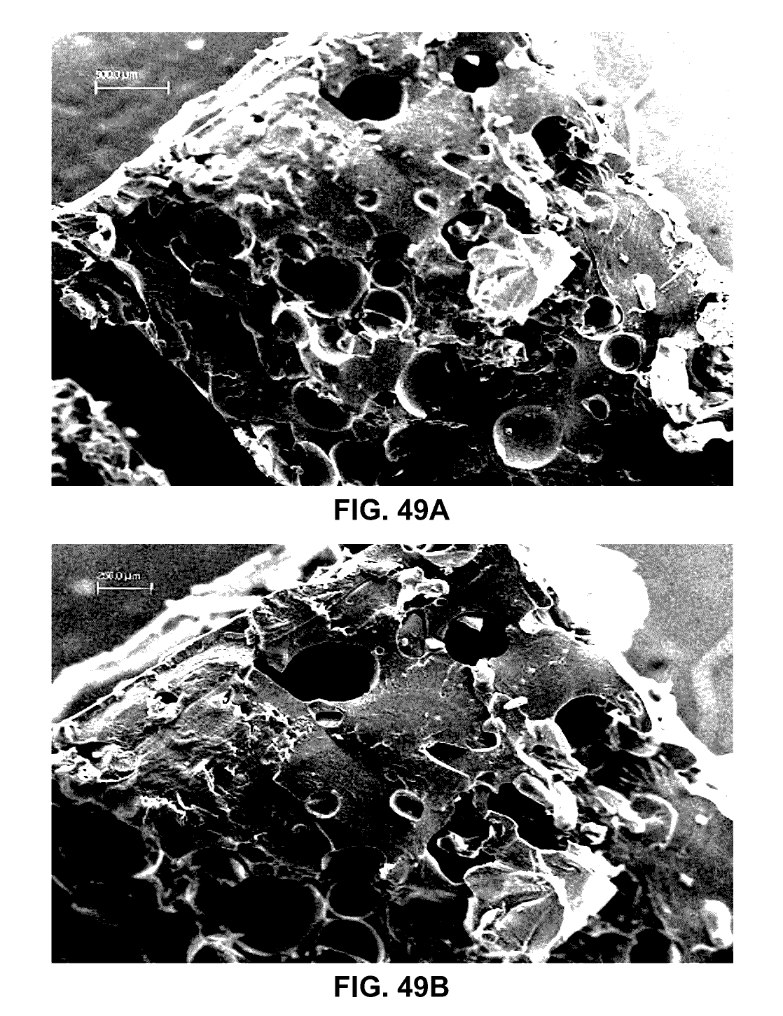

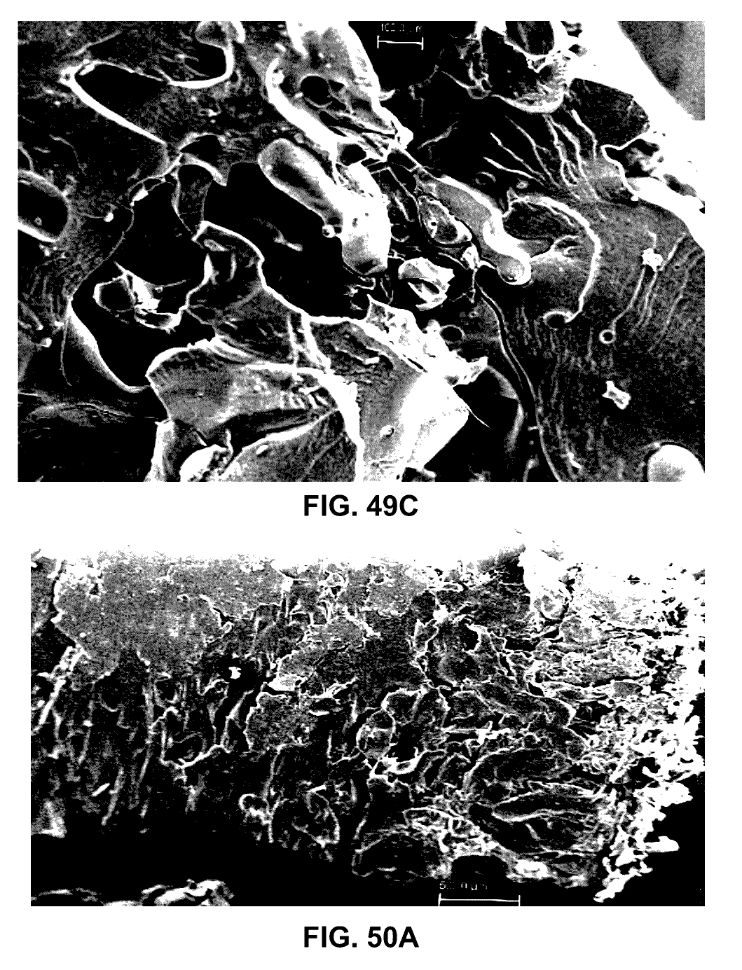

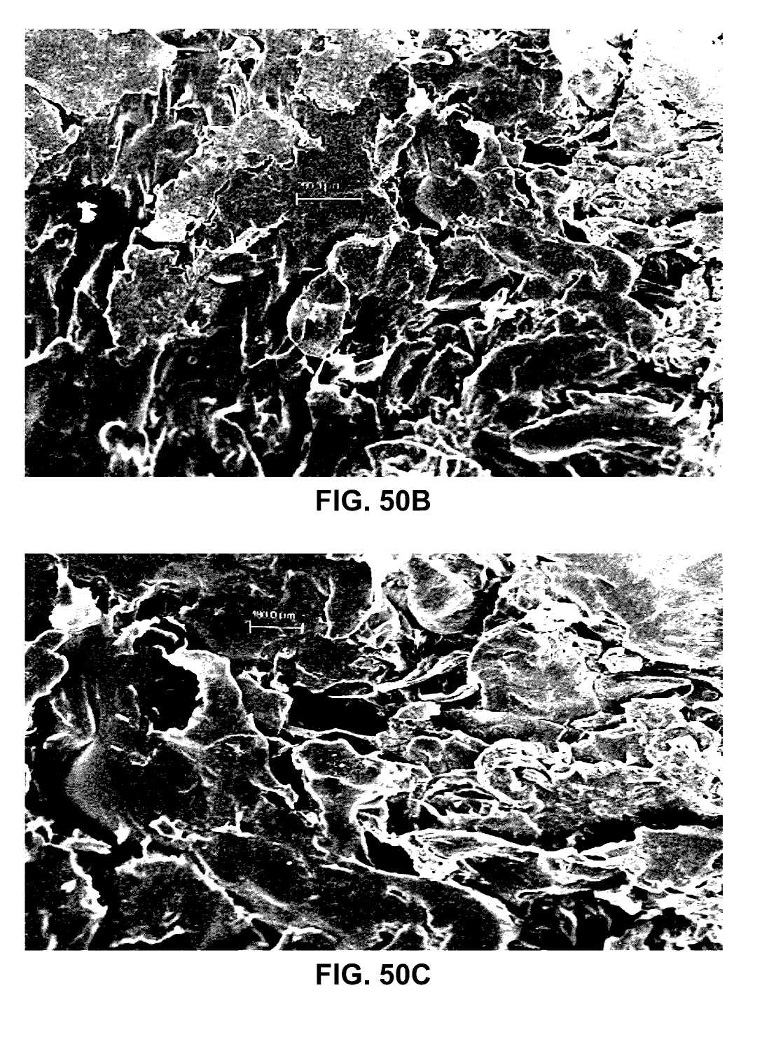

To corroborate the findings that were made during the mechanical analysis, the utilization of scanning electron microscopy is beneficial. For the albumin bioplastic and thermoplastic blends, we find that as more LDPE is added into the blend, clear phase separation of protein and polymer phases can be witnessed in FIGS. 43A-50C. This finding supports the results gathered during biodegradation analysis, as the increase separation of phases will result in a material that will become more susceptible to attack by microbial organisms.

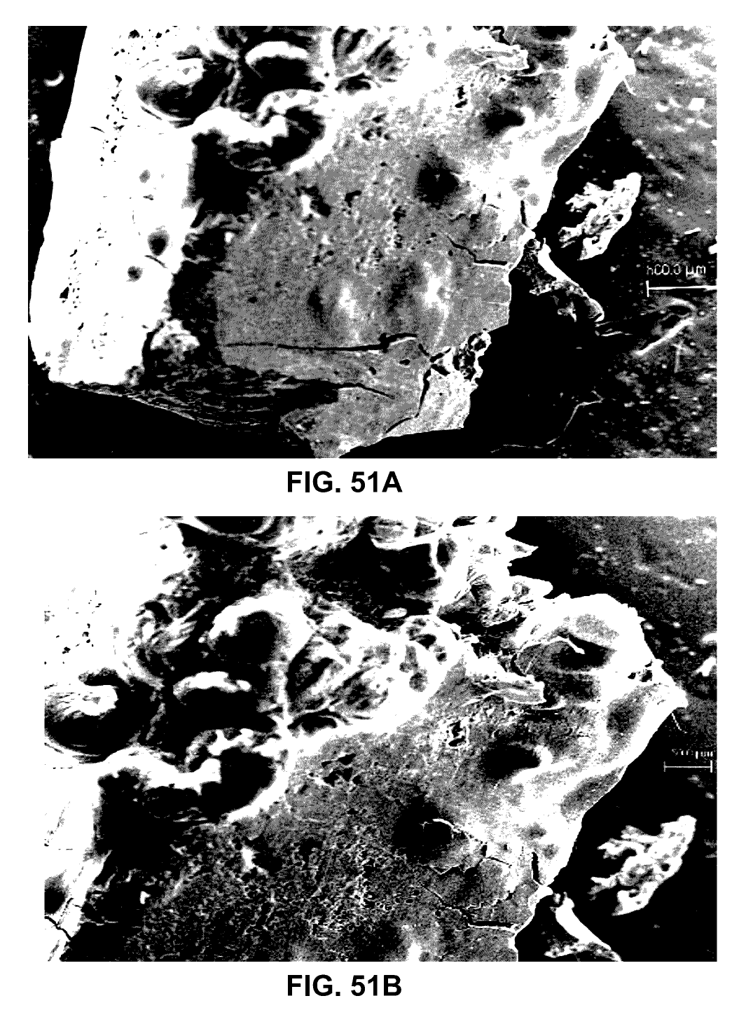

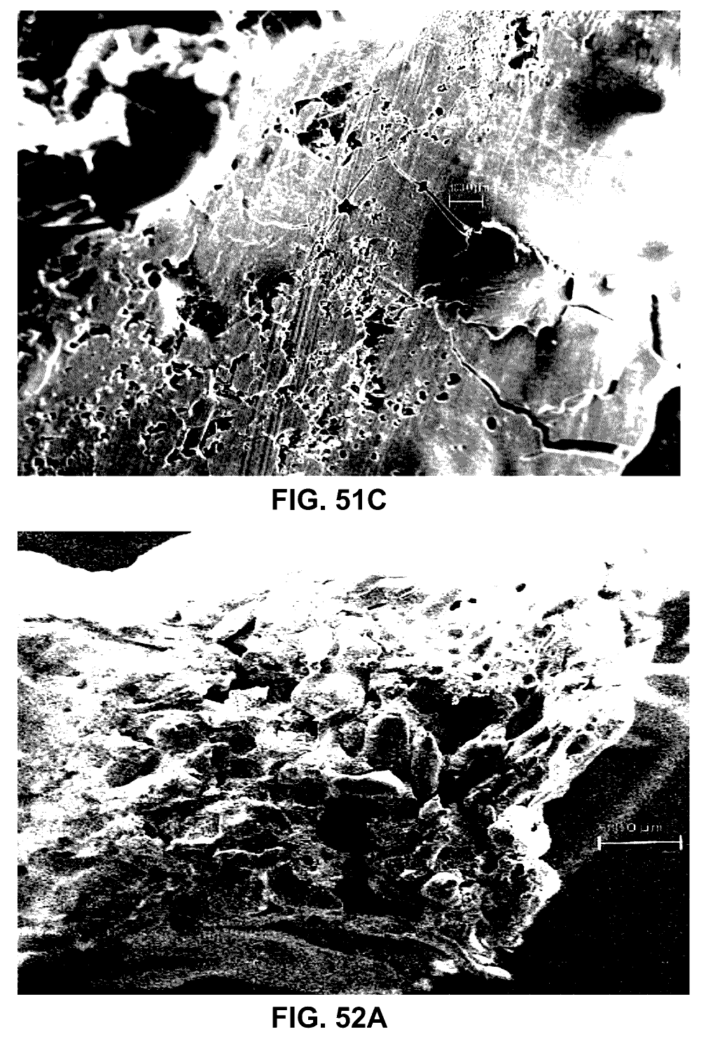

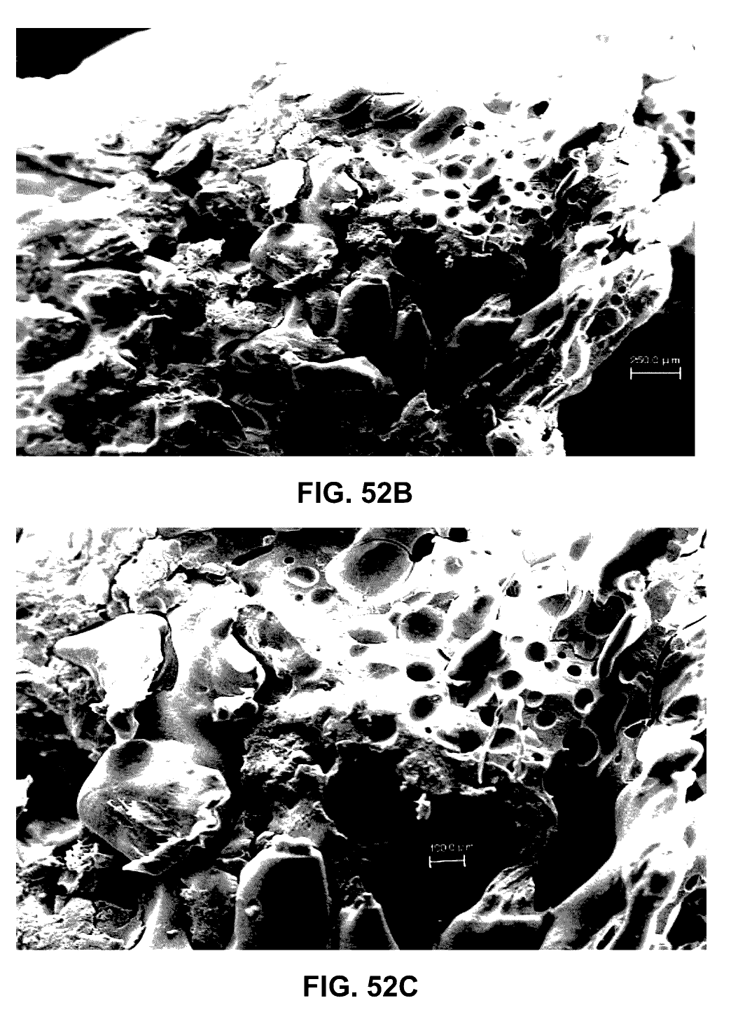

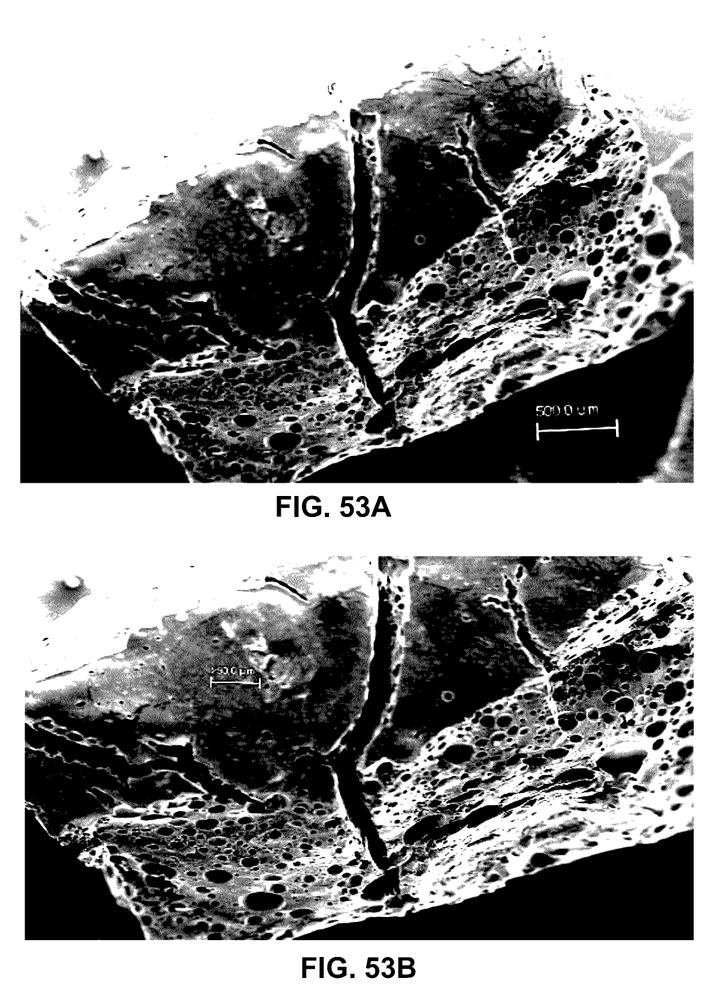

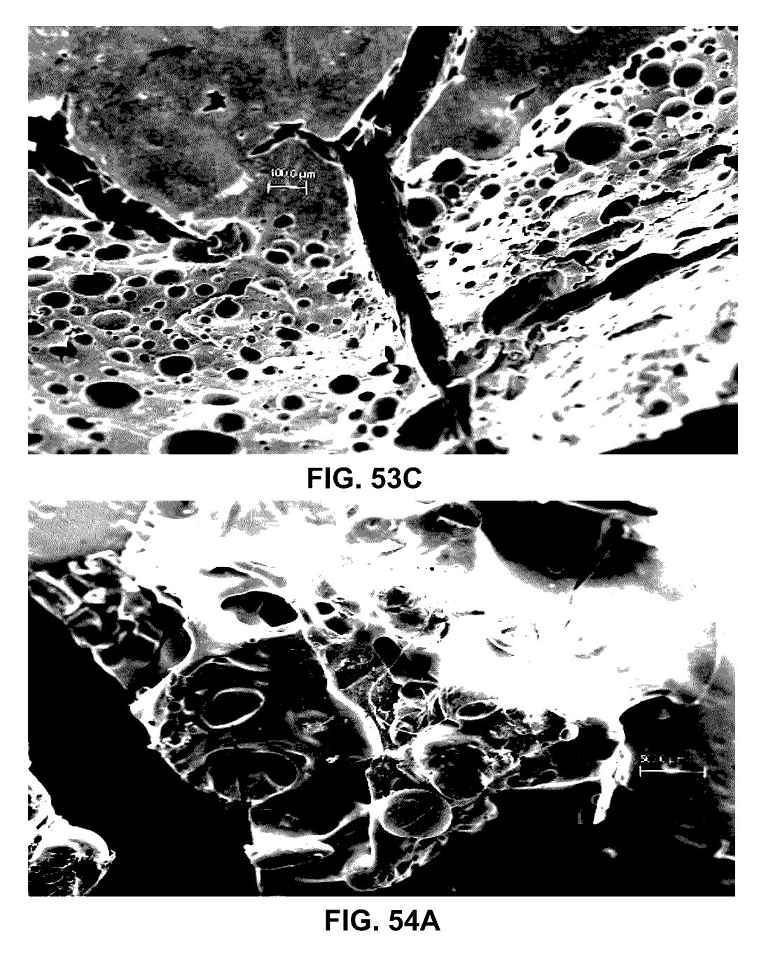

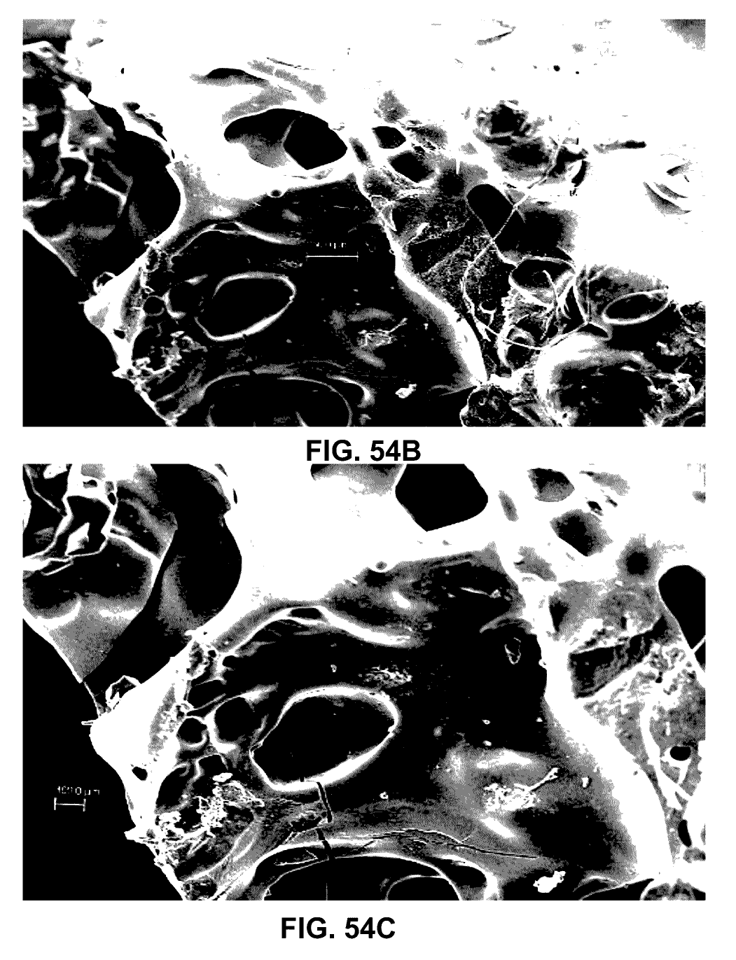

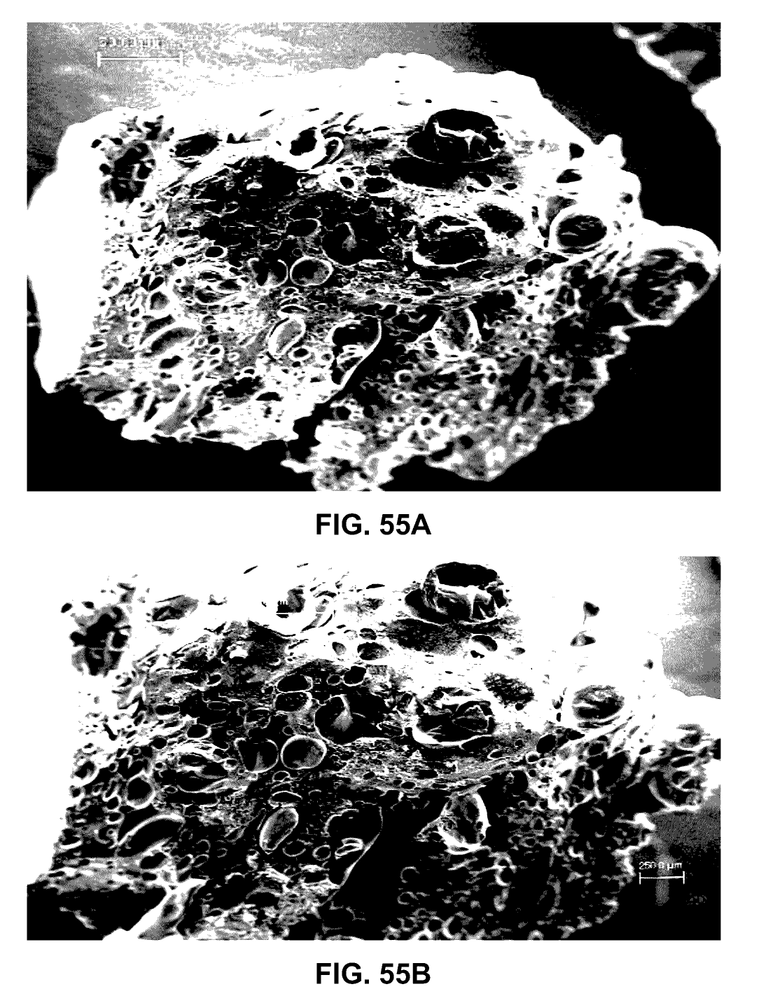

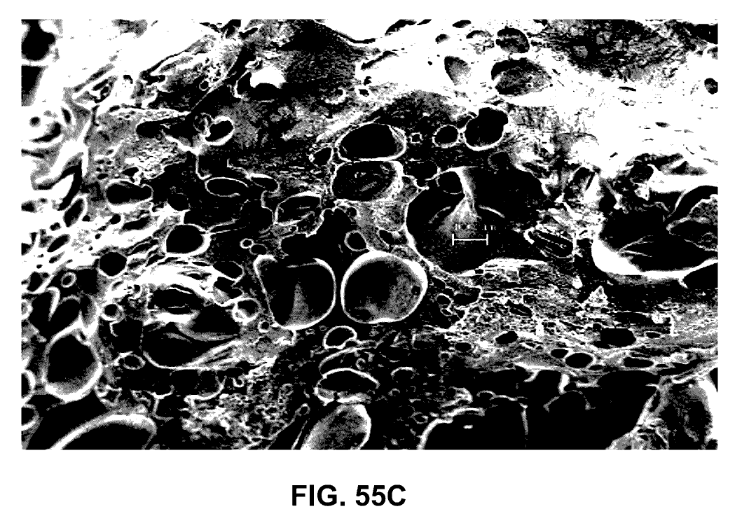

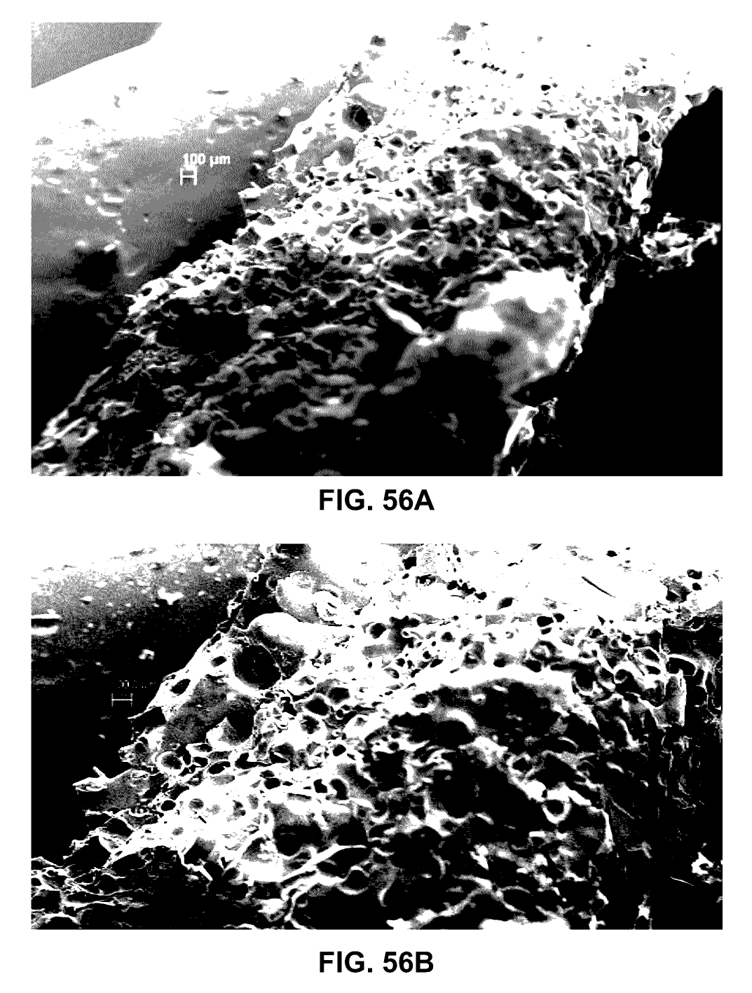

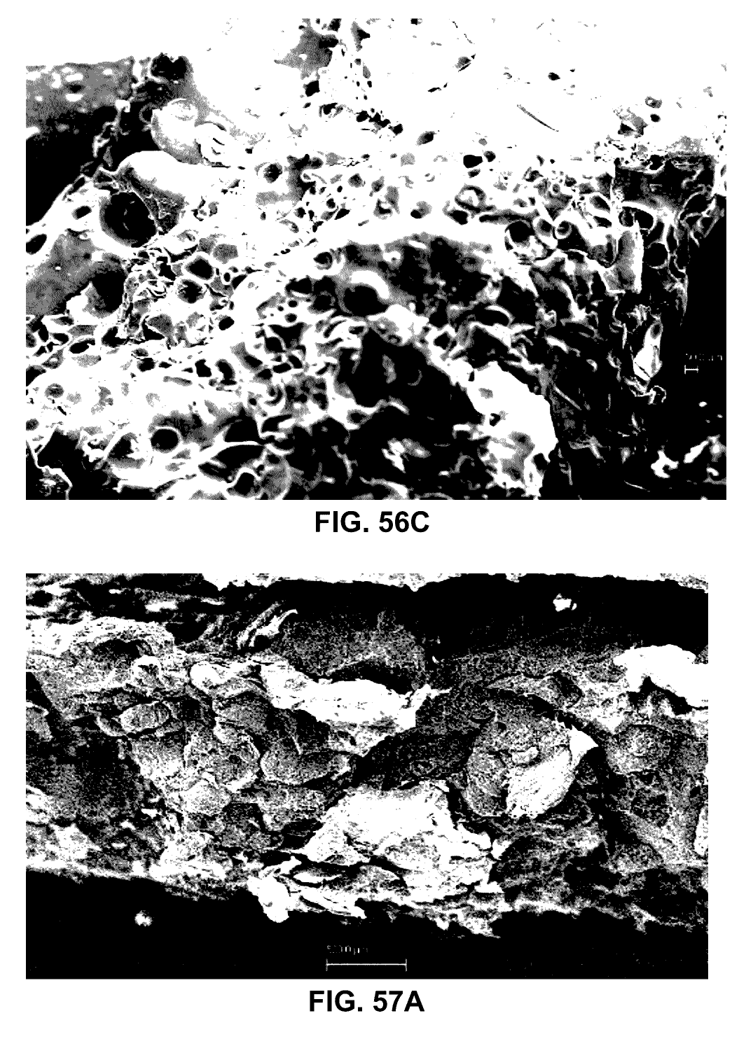

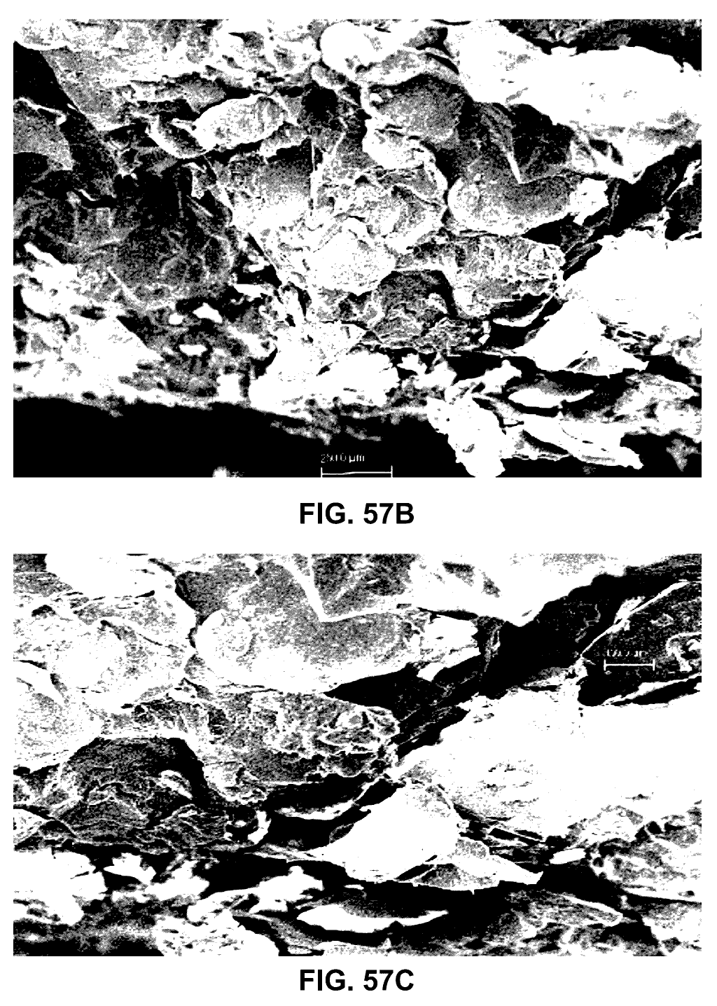

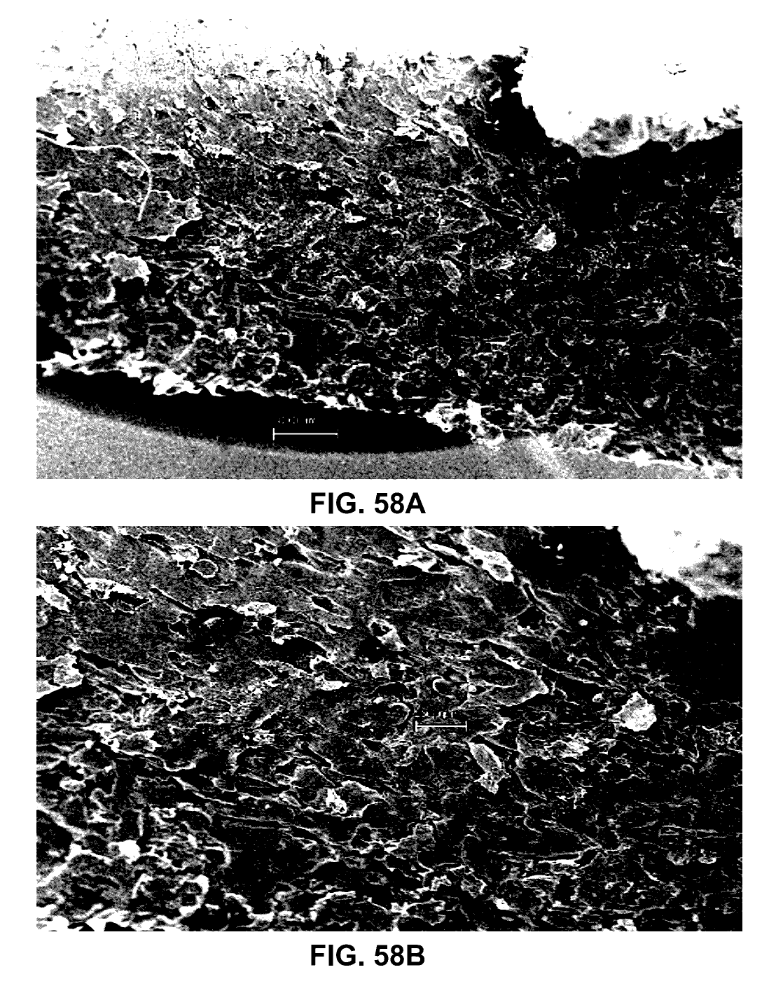

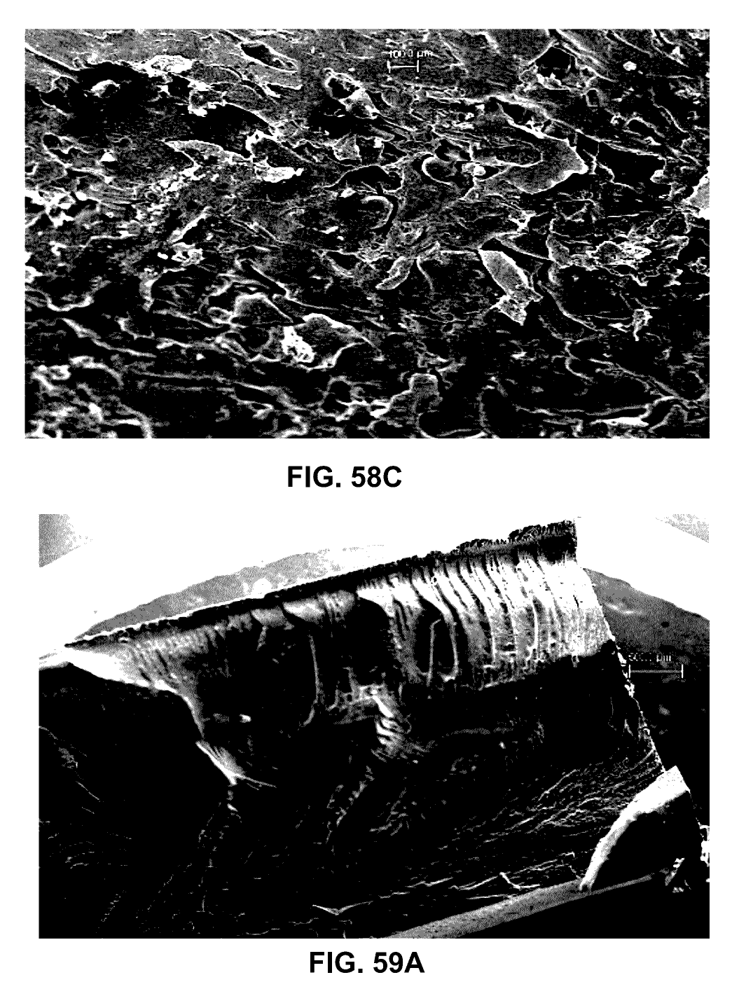

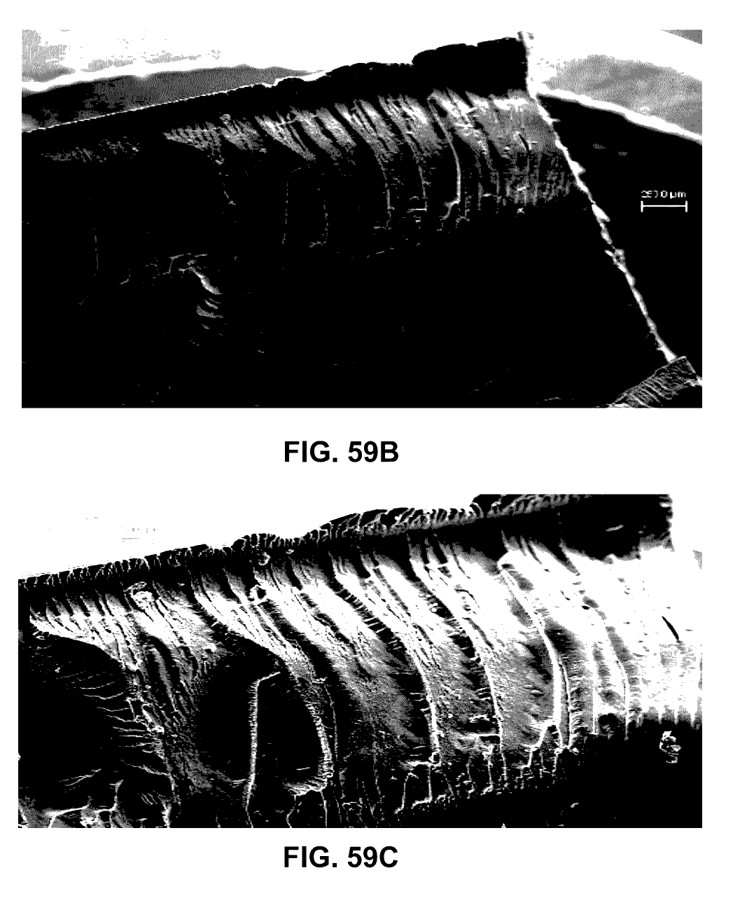

When SEM analysis was performed on the zein bioplastic and thermoplastic samples, it was observed that the addition of LDPE into the blend can result in a smoother surface (FIGS. 51A-58C). This smoother surface can be broken up by scratches and pits, an indication of a non-clean break of the material when preparing the sample. This finding is supported when the materials were tested for biodegradation properties, as the more robust material (when compared to albumin) can use more time and stress to biodegrade. FIGS. 59A-59C show SEM images of LDPE plastics at 20× (FIG. 59A), 100× (FIG. 59B), and 500× (FIG. 59C).

Water Absorption Properties of Thermoplastic Blends.

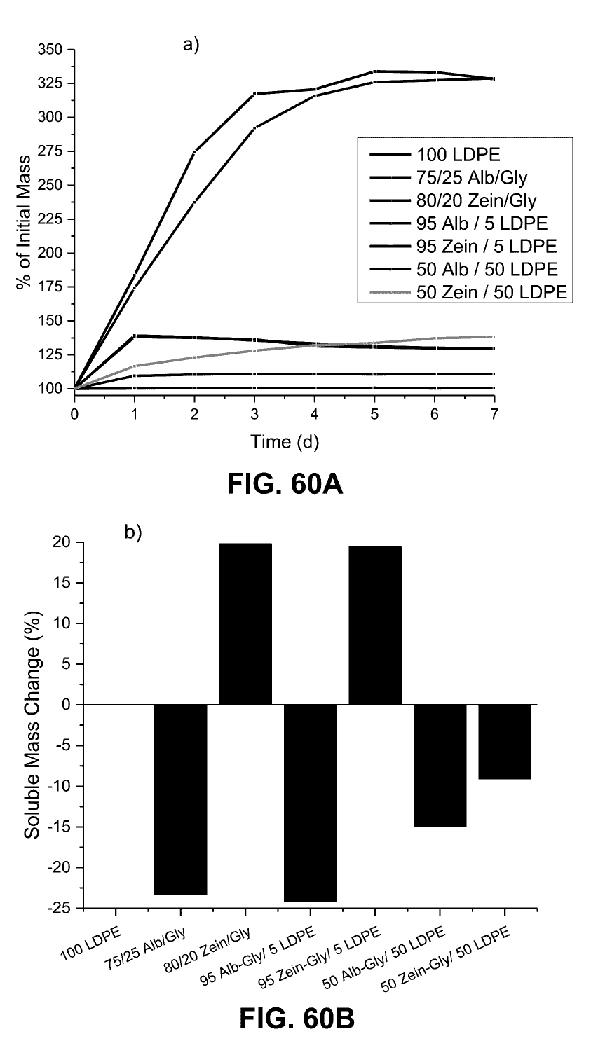

When subjected to submersion albumin-based plastics exhibit loss in mass due to solubilized matter and/or structure instability (as shown in FIG. 60A), while zein-based plastics exhibit an increase in mass gain (as shown in FIG. 60B). The zein plastics containing up to 5% of LDPE content end up with masses that are over 300% compared to their initial masses after seven days of water submersion, while albumin plastics will only have a mass that is 125% of their initial mass due to the amount of moisture uptake. Since the zein-based plastics possess a greater ability to absorb more water due to the addition of glycerol as a plasticizer to the zein, this will cause a substantial increase in the water absorption of the resulting plastic when compared to unplasticized zein protein¹⁰. Of note is the decrease of water absorption in thermoplastic blends that contain 50% LDPE or greater, as LDPE is not a material that will absorb water due to its hydrophobic nature¹¹.

When the samples are dried and weighed to measure the amount of soluble material that is lost, we find that albumin-based plastics are more susceptible to mass loss when submerged in water in comparison to the zein-based plastics. The albumin thermoplastic blends that contain 5% or less of LDPE loses 20% of their soluble mass, as albumin is a hydrophilic material that will interact with the water bath¹². Like any other protein, pure albumin will be susceptible to soluble mass loss in water, because of its affinity to fold and unfold in globular structures in water in order to interact with other molecules¹³. In contrast, the zein thermoplastic blends with lower LDPE content do not lose soluble mass when submerged in water, since there is a positive mass change after drying most likely due to the large amount of water absorbed by the plastics that remained after drying. When the amount of LDPE in the blends is increased to 50%, we find for that both the albumin and the zein plastics there is a less drastic change in the overall mass of the dried samples. Since LDPE is not soluble in water, the resulting plastic will be less susceptible to mass loss in the case of albumin plastics, and less able to absorb high amounts of water in the case of zein thermoplastic blends¹⁴.

Biodegradability Properties of Albumin Plastic Blends and Zein Plastic Blends.

With the pure albumin plastics that have been subjected to microbial attack through soil burial, it was observed that there is a drastic decrease in the amount of material recovered after 30 days (27.66%), with no material recoverable after 60 days. If 5% of LDPE was added to the albumin plastic there was a greater loss of mass (16.36% recoverable after 30 days) potentially due to an increase in susceptibility of albumin to biodegrade caused by lower protein-protein interactions within the plastic, but not all of the Alb-5LDPE samples were consumed after 60 days of soil burial (7.65% of initial mass). The thermoplastics lose mass since the albumin component of the plastic can be broken down and consumed by bacteria in the soil, while residual amounts of LDPE can be recovered after medium term burial. LDPE is not susceptible to biodegradation since very few strains of bacteria are able to process and consumed the material¹⁵. In comparison, zein plastics maintained a greater level of integrity after soil burial, as sample recovery for both pure zein bioplastics and zein plastics with 5% of LDPE is possible after both 30 and 60 days. For instance, after 30 days of burial there is 48.46% of pure zein plastics left and 73.42% of zein plastics with 5% LDPE, while after 60 days there is 4.34% of for pure zein plastics and 36.18% of zein plastics made with 5% LDPE. Zein possesses the advantage of microbial attack resistance that can be pointed to its hydrophobic properties¹⁶, as it does not react to water to the same extent of albumin, preventing bacteria from having a resource that would aid in growth¹⁶⁻¹⁷.

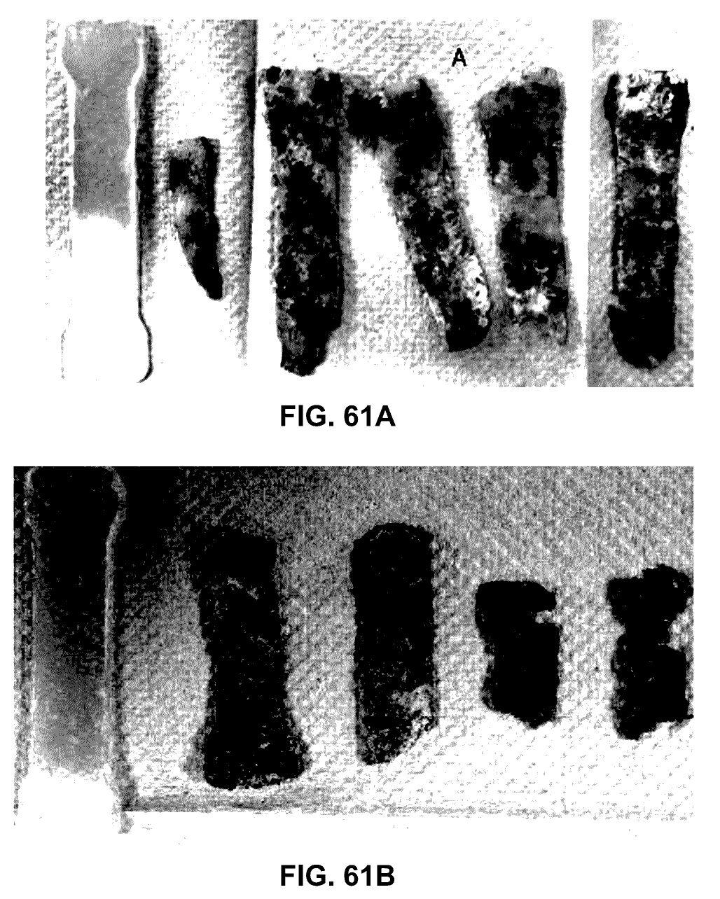

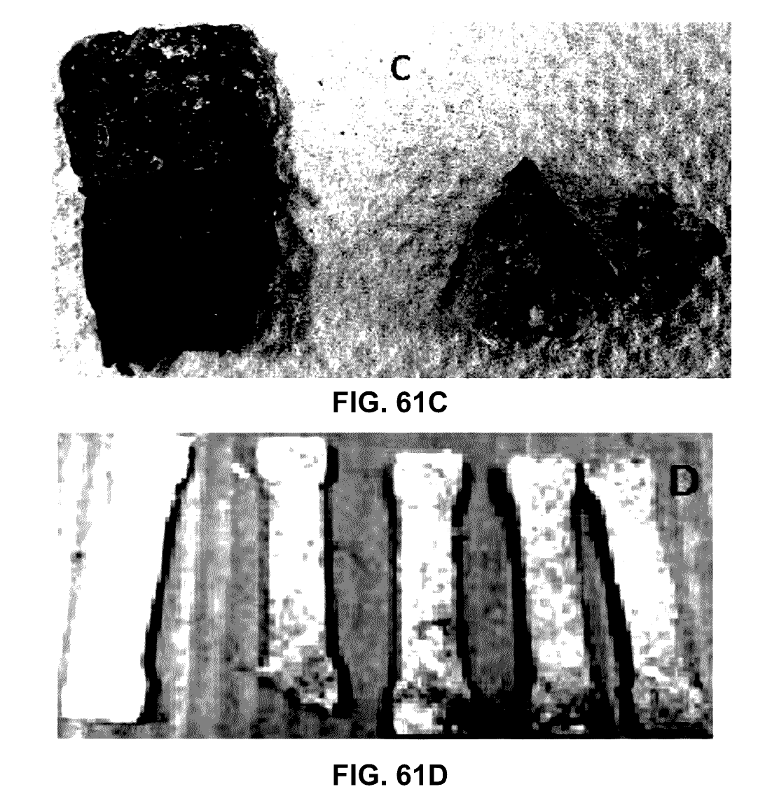

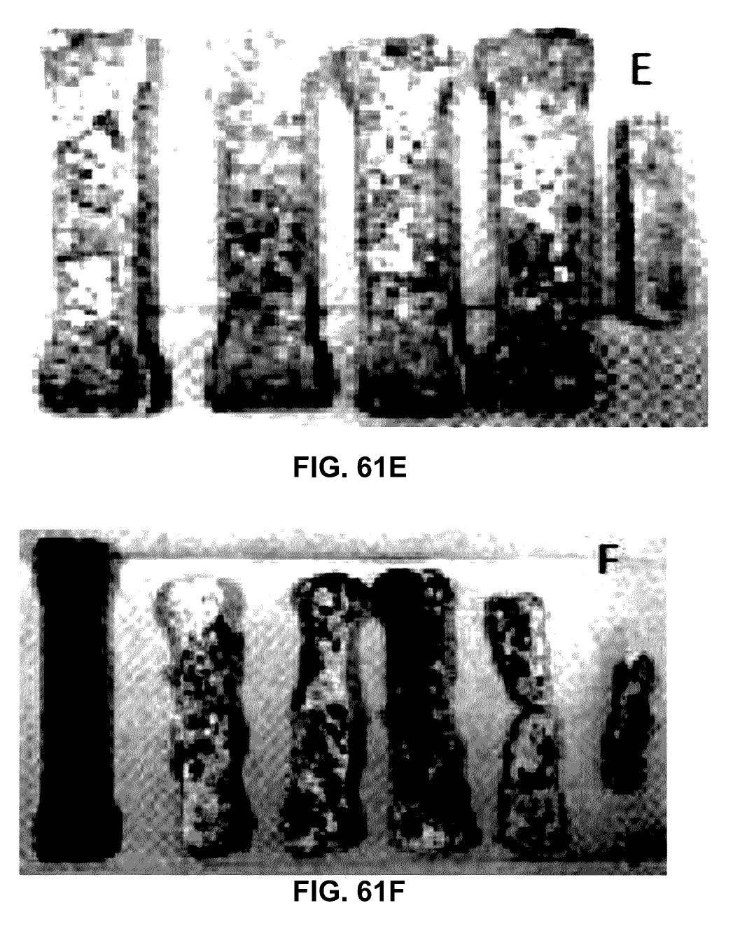

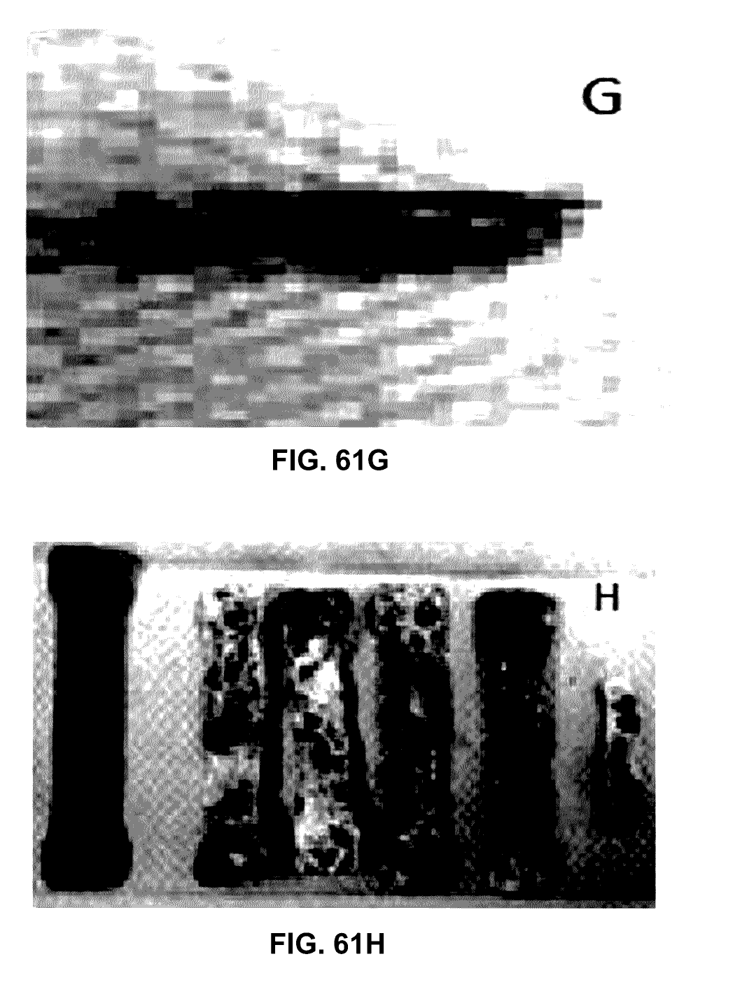

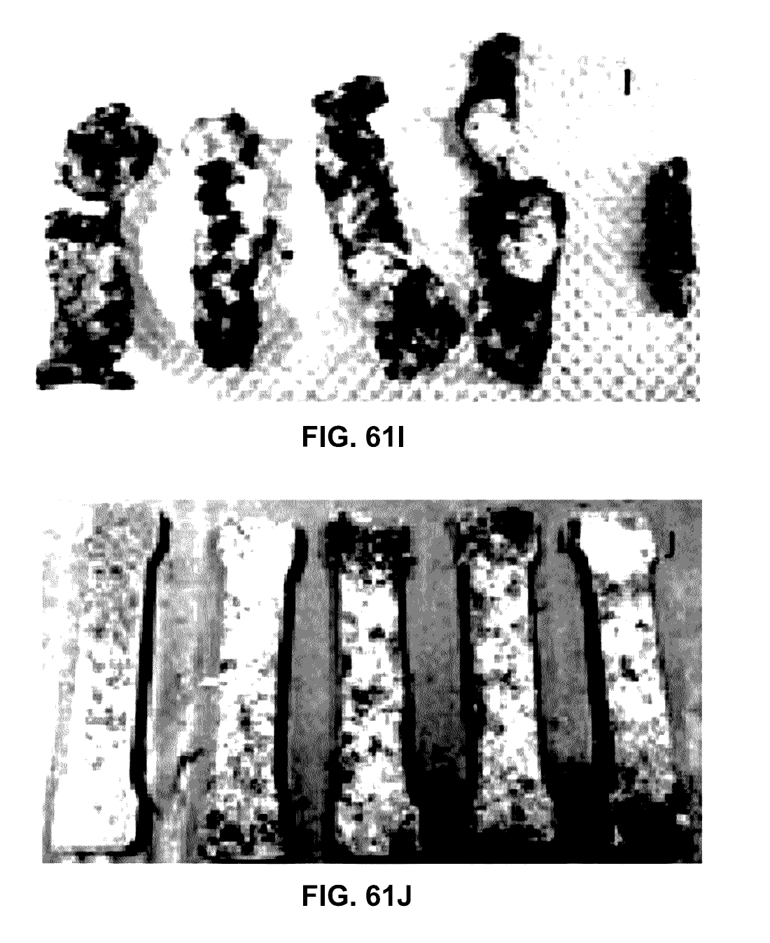

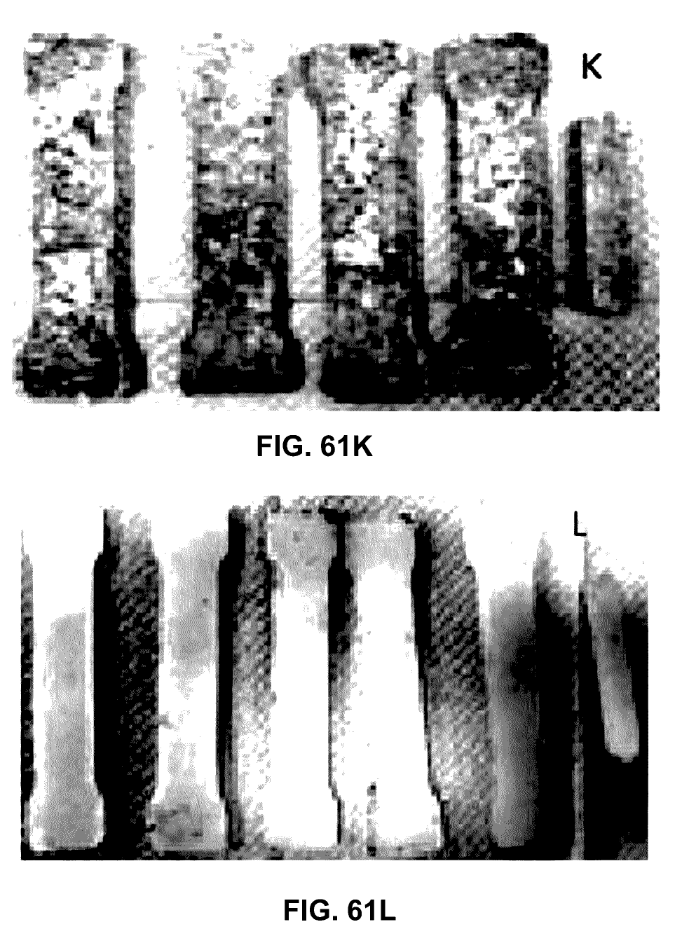

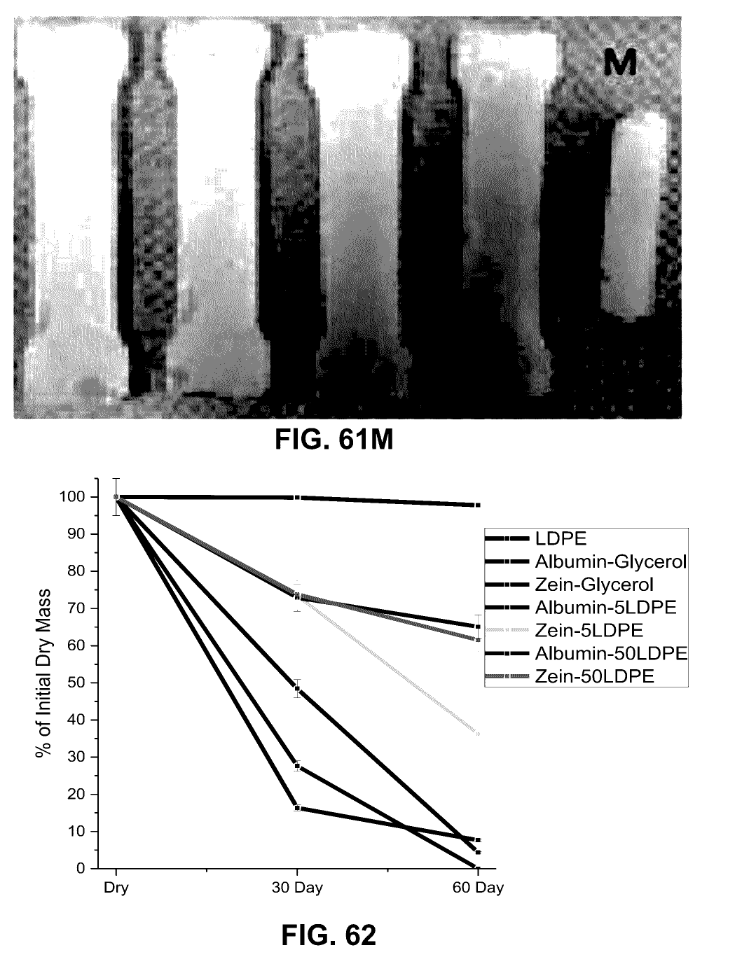

When plastics that contained of 50% of LDPE were made, there was a comparative lack of degradation after 60 days, as considerable amounts of mass remain for both albumin and zein plastics (65.08% and 61.50%, respectively). Since LDPE is not susceptible to degradation by microbial attack (97.79% of initial mass remains after 60 days), more protein-based plastic mass can be recovered from the soil with higher concentrations of LDPE use¹⁸. Results are further demonstrated in FIGS. 61A-61M and 62.

### CONCLUSIONS

When the water solubility of the albumin and zein-based thermoplastics is compared, it is observed that the addition of more LDPE into the thermoplastic blend can decrease the amount of soluble mass lost when in water, with albumin plastics more susceptible to mass loss when compared to zein-based thermoplastics. The susceptibility of albumin-based thermoplastics for mass loss was also observed when subjected to soil-burial conditions, as the material will degrade more rapidly when compared to zein-based plastics.

We claim:

1. A bioplastic composition comprising:
an amount of a protein, wherein the protein is selected from the group consisting of: soy, albumin, zein, whey, and combinations thereof; and
an amount of a plasticizer.

2. The bioplastic composition of claim 1, wherein the plasticizer is selected from the group consisting of: water, glycerol, natural rubber latex, and combinations thereof.

3. The bioplastic composition of claim 1, further comprising an amount of an anti-infective compound.

4. The bioplastic composition of claim 3, wherein the anti-infective compound is selected from the group consisting of: an antibiotic, an amebicide, an anthelmintic, an antifungal, an antimalarial, an antiviral, and combinations thereof.

5. The bioplastic composition of claim 3, further comprising an amount of a low-density polyethylene.

6. The bioplastic composition of claim 5, wherein the amount of the low-density polyethylene ranges from about 5% to about 80% by weight of the bioplastic composition.

7. The bioplastic composition of claim 3, wherein the amount of the anti-infective compound ranges from about 5% by weight to about 15% by weight of the bioplastic composition.

8. The bioplastic composition of claim 1, further comprising an amount of a low-density polyethylene.

9. The bioplastic composition of claim 8, wherein the amount of the low-density polyethylene ranges from about 5% to about 80% by weight of the bioplastic composition.

10. The bioplastic composition of claim 1, wherein the amount of the protein ranges from about 5% by weight of the bioplastic composition to about 95% by weight of the bioplastic composition.

11. The bioplastic composition of claim 10, wherein the amount of the plasticizer ranges from about 5% by weight of the bioplastic composition to about 95% by weight of the bioplastic composition.

12. The bioplastic composition of claim 1, wherein the amount of the plasticizer ranges from about 5% by weight of the bioplastic composition to about 95% by weight of the bioplastic composition.

13. A container comprising:
a wall portion, wherein the wall portion comprises a bioplastic composition that comprises an amount of a protein and an amount of a plasticizer, wherein the protein is selected from the group consisting of: soy, albumin, zein, whey, and combinations thereof.

14. The container of claim 13, wherein the amount of the plasticizer in the bioplastic composition ranges from about 5% to about 95% by weight of the bioplastic composition and wherein the plasticizer is selected from the group consisting of: water, glycerol, and natural rubber latex.

15. The container of claim 13, the bioplastic composition further comprising an amount of an anti-infective compound, wherein the amount of the anti-infective compound ranges from about 5% to about 15% by weight of the bioplastic composition.

16. The container of claim 13, the bioplastic composition further comprising an amount of low-density polyethylene, wherein the amount of the low-density polyethylene ranges from about 5% by weight of the bioplastic composition to about 95% by weight of the bioplastic composition.

17. The container of claim 13, wherein the amount of protein in the bioplastic composition ranges from about 5% to about 95% by weight of the bioplastic composition.

18. A method of making a bioplastic, the method comprising:
mixing a protein and a plasticizer to form a bioplastic mixture,
wherein the protein is included at an amount ranging from about 5% to about 95% by weight of the bioplastic and wherein the protein is selected from the group consisting of: soy, albumin, zein, whey, and combinations thereof,
wherein the plasticizer is included at an amount ranging from about 5% to about 95% of the bioplastic composition and wherein the plasticizer is selected from the group consisting of: water, glycerol, or natural rubber latex; and
heating the bioplastic mixture to form the bioplastic.

19. The method of claim 18, further comprising mixing an anti-infective compound with the protein and the plasticizer, wherein the anti-infective compound is included at amount ranging from about 5% to about 15% by weight of the bioplastic mixture.

20. The method of claim 18, further comprising mixing a low-density polyethylene with the protein and the plasticizer, wherein the low-density polyethylene is included at an amount ranging from about 5% to about 95% by weight of the bioplastic mixture.
